(19) United States
(12) Patent Application Publication
(10) Pub. No.: US 2016/0238532 A1
(43) Pub. Date: Aug. 18, 2016

(54) MULTI-PHOTON SYSTEMS AND METHODS

(71) Applicant: INVENIO IMAGING INC., Menlo Park, CA (US)

(72) Inventors: Christian Wilhelm FREUDIGER, San Carlos, CA (US); Jay Kenneth TRAUTMAN, Los Altos, CA (US)

(21) Appl. No.: 14/899,536

(22) PCT Filed: Jun. 20, 2014
(86) PCT No.: PCT/US14/43519

§ 371 Date: Dec. 17, 2015

Related U.S. Application Data
(60) Provisional application No. 61/838,109, filed on Jun. 21, 2013.
(60) Provisional application No. 61/908,548, filed on Nov. 25, 2013.
(60) Provisional application No. 61/908,669, filed on Nov. 25, 2013.

(51) Int. Cl. G01N 21/64; G01N 21/65

(52) U.S. Cl. CPC G01N 21/6458; G01N 21/6402; G01N 21/65; G01N 2021/6484; G01N 2021/655; G01N 2201/06113; G01N 2201/0826

(57) ABSTRACT

The present disclosure provides systems and methods for performing multi-photon imaging using a fiber laser. Systems and methods herein may be used for performing imaging using multi-photon excitation (e.g., using two-photon excitation or multi-color two-photon excited fluorescence). Aspects of the disclosure are applicable to a variety of multi-photon methods without being limited to CRS or multi-photon fluorescence excitation. A multi-wavelength fiber laser system and its use in multi-photon methods are provided.

### CROSS-REFERENCE

This application claims priority to U.S. Provisional Patent Application Ser. No. 61/838,109, filed Jun. 21, 2013, U.S. Provisional Patent Application Ser. No. 61/908,548, filed Nov. 25, 2013, and U.S. Provisional Patent Application Ser. No. 61/908,669, filed Nov. 25, 2013, each of which is entirely incorporated herein by reference.

### STATEMENT AS TO FEDERALLY SPONSORED RESEARCH

This invention was made with the support of the United States government under SBIR grant number IIP-1214848 from the National Science Foundation.

### BACKGROUND

Multi-photon microscopy (MPM) (U.S. Pat. No. 5,034,613 to Denk et al.) is an indispensable tool for biomedical research, whereby excitation is mediated by multiple, typically two, photons rather than a single photon, the advantage being that the excitation is largely confined to the focal plane. This is different from confocal microscopy, in which a larger focal volume is excited by a single-photon transition and the out-of-focus light is suppressed by a focal pinhole. MPM avoids out-of-focus photodamage and bleaching. It also provides particular advantages for in vivo and deep tissue imaging applications (Nat Methods. 2, 12: 932-40 (December 2005)), where linear tissue scattering degrades image contrast in confocal microscopy. In addition to imaging applications, photo-activation and photo-uncaging are advantageously performed with multi-photon excitation.

As a nonlinear optical technique, MPM benefits from excitation with pulsed lasers that have high peak power at moderate average power: Samples are typically damaged by heating, which scales with average power. Femtosecond lasers, typically operating with ˜150 fs pulse duration at 80 MHz repetition rate, are widely used as they produce high-contrast images at low average power (typically a few mW). Picosecond lasers have also proven useful.

Raman scattering can be highly specific and allows for label-free imaging of various samples including human tissue without adding dyes or stains. However, the spontaneous Raman scattering signal is weak and long averaging times are required to obtain high signal-to-noise ratio (SNR) images. Further, weak Raman signal can be overwhelmed by auto-fluorescence.

Coherent Raman scattering, an MPM technique, includes the Raman process and involves scattering of an excitation photon by a molecule while exciting a molecular vibration. Each type of bond has a specific stiffness (e.g., C═C is stiffer than C—C) and associated mass (e.g., C—C is heavier than C—H) and thus a specific vibrational frequency. The dispersed Raman scattering spectrum is determined by the molecular vibrations of the sample and thus derived from the chemical composition. Raman scattering has provided various forms of spectroscopy, including coherent anti-Stokes Raman scattering (CARS). Another form of Raman scattering includes stimulated Raman scattering (SRS). SRS is excited under the same illumination conditions as CARS, but differs in the detection. CARS can be similar to fluorescence in that emission is detected at a wavelength different from the excitation beams. SRS can be similar to absorption in that the absorption of one of the excitation beams (stimulated Raman loss) is measured in the presence of the second beam. While highly sensitive, SRS detection can include extracting the relatively small signal from the laser background with a high-frequency phase-sensitive detection scheme (lock-in detection). SRS provides unique capability for chemical specificity as excitation spectra are identical to those of spontaneous Raman and phase-matching is automatic.

Fluorophores and dyes used in MPM have absorption spectra covering the near ultraviolet (UV) through the near infrared (IR). Titanium:Sapphire (Ti:Sa) lasers, with a tuning range from ˜750-950 nm, have been broadly adopted. In recent years the range has been extended from 690 nm to 1040 nm by using high power pump lasers (up to 18 W). Another trend is the use of optical parametric oscillators (OPOs) to extend the range even further into the near-IR (Nat Protocols, 6, 10: 1500-20 (2011)). The development of fluorophores follows this trend. On the other hand, photo-activation and photo-uncaging is typically performed on the short wavelength end of the range. OPOs are also typically used for CRS techniques.

Major drawbacks of Ti:Sa lasers and OPOs are high costs, large footprints, and the need for optical tables. Less expensive gain media, such as semiconductors cannot, however, generate the required pulse parameters because of their short excited state lifetimes. Fiber lasers, typically based on gain fibers doped with rare-earth ionic species such as Tm³⁺ (Thulium), Er³⁺ (Erbium), Pr³⁺ (Praseodymium), Ho³⁺ (Holmium), and Yb³⁺ (Ytterbium) provide an alternative. Fiber-optic components are inexpensive, robust, and can be combined into complex systems. However the gain-bandwidth of each of these media is significantly smaller than that of Ti:Sa and peak and average power cannot as easily be scaled as in free-space lasers. Lower power and limited tunability have hindered wider adoption of fiber lasers in MPM.

Further, laser systems or laser setups today typically are capable of addressing a single application and a major effort is required when reconfiguring them for other applications.

### SUMMARY

Recognized herein is a need for novel high performance sources. Further recognized herein is a need for inexpensive, compact, turnkey light sources. For example, improved Coherent Raman scattering (CRS) (e.g., coherent anti-Stokes Raman scattering (CARS) and stimulated Raman scattering (SRS)) systems and methods for biological and chemical analytical applications are needed. In particular, there is a need for label-free based detection systems and methods capable of performing analysis with adequate time and signal resolution. Further, CARS and SRS systems that can operate with other imaging modalities, including multimodal imaging, are needed. In general, light sources for multi-photon methods (e.g., multi-photon microscopy (MPM)) with a broad tuning range are needed so that the user is not restricted in the choice of excitable species. An ideal light source for multi-photon methods may have a broad tuning range so that the user is not restricted in the choice of excitable species. Provided herein is a flexible platform for implementing multi-photon methods, photo-activation, photo-uncaging and/or polymerization. In some cases, the systems herein can advantageously enable multi-photon methods that utilize multiple discrete lines rather than broadly tunable input beams. For example, the systems may be adapted to sweep wavelengths in an arbitrary manner while maintaining pulse synchronization.

The disclosure provides systems and methods to enable various multi-photon methods (also referred to as “imaging” herein). Such methods may include microscopy (e.g., MPM), spectroscopy and/or tomography techniques employing, for example, CRS (e.g., CARS and/or SRS), Raman Induced Kerr Effect (RIKE), second harmonic generation (SHG), third harmonic generation (THG), sum frequency generation (SFG), difference frequency generation (DFG), two-photon absorption (TPA), multi-photon absorption, transient absorption (TA), ground state depletion (GD), stimulated emission (SE), multi-photon excitation (e.g., multi-photon fluorescence excitation such as, for example, two-photon excited fluorescence (TPEF) or two-color two-photon excited fluorescence (TCTPEF)), or any combination thereof. In some examples, the systems and methods herein may be used for performing imaging using CRS (e.g., using CARS or SRS). In some examples, the systems and methods herein may be used for performing imaging using multi-photon excitation (e.g., using two-photon excitation or multi-color two-photon excited fluorescence). Aspects of the disclosure are applicable to a variety of multi-photon methods without being limited to CRS or multi-photon fluorescence excitation.

A multi-wavelength fiber laser system and its use in multi-photon methods are provided. Examples of amplifier geometries and wavelength ranges (e.g., multi-photon excitation wavelength ranges) are given. The disclosure further enables use of multi-photon methods (e.g., CARS, SRS, etc.) with conventional microscope systems including a beam-scanning unit that may include optical amplifiers and/or frequency conversion systems.

An aspect of the disclosure relates to a multi-photon excitation system, comprising a first fiber system, seeded by a first input train of pulses, generating a first output train of pulses at a first center wavelength λ₁, and a second fiber system, seeded by a second input train of pulses, generating a second output train of pulses at a second center wavelength λ2, wherein: (a) the first and the second output trains of pulses are temporally synchronized, (b) λ₁≠λ₂, and (c) multi-photon excitation is due to absorption of at least one photon of the first output train of pulses and at least one photon of the second output train of pulses. The system further comprises a focusing optic that focuses the first and the second output trains of pulses into a common focal volume.

The multi-photon excitation system can be a two-photon excitation system, wherein 2/(1/λ₁+1/λ₂) can be within a first two-photon excitation wavelength range of a first excitable species.

In some cases, at least one of the first fiber system and the second fiber system is a fiber amplifier system, thereby forming at least one of a first fiber amplifier system and a second fiber amplifier system. In some cases, at least one of the first fiber amplifier system and the second fiber amplifier system further comprises a harmonic generation unit. In some cases, at least one of the first fiber system and the second fiber system is a harmonic generation unit.

In some cases, the first fiber amplifier system is an erbium-doped fiber amplifier and the first center wavelength is in a range from 1530 nm to 1620 nm, and the second fiber amplifier system is an ytterbium-doped fiber amplifier and the second center wavelength is in a range from 1000 nm to 1080 nm. In some cases, the first fiber amplifier system is an erbium-doped fiber amplifier and the first center wavelength is in a range from 765 nm to 810 nm, and the second fiber amplifier system is an ytterbium-doped fiber amplifier and the second center wavelength is in a range from 1000 nm to 1080 nm. In some cases, the first fiber amplifier system is an erbium-doped fiber amplifier and the first center wavelength is in a range from 1530 nm to 1620 nm, and the second fiber system includes a second harmonic unit and the second center wavelength is in a range from 765 nm to 810 nm. In some cases, the first fiber amplifier system is an erbium-doped fiber amplifier and the first center wavelength is in a range from 1530 nm to 1620 nm, and the second fiber amplifier system is a thulium-doped fiber amplifier and the second center wavelength is in a range from 925 nm to 1050 nm. In some cases, the first fiber amplifier system is an erbium-doped fiber amplifier and the first center wavelength is in a range from 765 nm to 810 nm, and the second fiber amplifier system is a thulium-doped fiber amplifier and the second center wavelength is in a range from 925 nm to 1050 nm.

The first two-photon excitation wavelength range can include a two-photon excitation wavelength between 1209 nm and 1296 nm. The first two-photon excitation wavelength range can include a two-photon excitation wavelength between 867 nm and 926 nm. The first two-photon excitation wavelength range can include a two-photon excitation wavelength between 1020 nm and 1080 nm. The first two-photon excitation wavelength range can include a two-photon excitation wavelength between 1144 nm and 1377 nm. The first two-photon excitation wavelength range can include a two-photon excitation wavelength between 828 nm and 1024 nm.

In some cases, soliton self-frequency shift (SSFS) is employed to further extend the range of the first fiber amplifier system to a range from 1500 nm to 2000 nm. In some cases, soliton self-frequency shift (SSFS) is employed to further extend the range of the first fiber amplifier system to a range from 750 nm to 1000 nm. In some cases, soliton self-frequency shift (SSFS) is employed to further extend the range of the first fiber amplifier system to a range from 1500 nm to 2000 nm and of the of the second fiber amplifier system to a range from 750 nm to 1000 nm.

In some cases, soliton self-frequency shift (SSFS) is employed, wherein the first two-photon excitation wavelength range includes a two-photon excitation wavelength between 1200 nm and 1403 nm. In some cases, soliton self-frequency shift (SSFS) is employed, wherein the first two-photon excitation wavelength range includes a two-photon excitation wavelength between 857 nm and 1038 nm. In some cases, soliton self-frequency shift (SSFS) is employed, wherein the first two-photon excitation wavelength range includes a two-photon excitation wavelength between 1000 nm and 1333 nm.

Timing jitter of the temporal synchronization can be less than 20% of the pulse duration of the longer of the pulses from the first train of pulses and the second train of pulses. The pulse duration of the longer of the pulses from the first train of pulses and the second train of pulses can be less than 500 fs.

Average powers of the first output train of pulses and of the second output train of pulses can range from 10 mW to 1 W. Pulse durations of the first output train of pulses and of the second output train of pulses can range from 25 fs to 250 ps. Repetition rates of the first output train of pulses and of the second output train of pulses can range from 100 kHz to 1000 MHz.

In some cases, λ₁ or λ₂ is within a second two-photon excitation wavelength range of a second excitable species. λ₁ can be within the second two-photon excitation wavelength range, and λ₂ can be within a third two-photon excitation wavelength range of a third excitable species.

In some cases, the system further comprises a third fiber system seeded by a third input train of pulses with a third output train of pulses at a third center wavelength λ₃. In some cases, the harmonic generation unit is for outputting a third output train of pulses at a third center wavelength λ₃.

In some cases, the system further comprises a filter for blocking λ₁ and λ₂ and for passing a multi-photon excited fluorescence signal generated by at least one of the first excitable species, the second excitable species and the third excitable species in the common focal volume, and a photodetector for detecting the multi-photon excited fluorescence signal.

In some cases, the system further comprises a filter for blocking λ₁ and λ₂ and for passing a multi-photon excited fluorescence signal generated by at least one of the first excitable species, the second excitable species and the third excitable species in the common focal volume, and at least two photodetectors for detecting the multi-photon excited fluorescence signal, wherein each photodetector is sensitive to a specific spectral region of the multi-photon excited fluorescence signal.

In some cases, the system further comprises a first modulator for modulating an intensity of the first output train of pulses at a first modulation frequency f₁, a second modulator for modulating an intensity of the second output train of pulses at a second modulation frequency f₂, a filter for blocking λ₁ and λ₂ and for passing a multi-photon excited fluorescence signal generated by at least one of the first excitable species, the second excitable species and the third excitable species into the common focal volume, a photodetector for detecting the multi-photon excited fluorescence signal, and processing electronics for analyzing the multi-photon excited fluorescence signal detected by the photodetector at at least one of frequencies f₁, f₂, |f₁−f₂|, or f₁+f₂.

In some cases, the system further comprises at least one pulse picker for picking pulses of at least one of the first input train of pulses, the first output train of pulses, the second input train of pulses, and the second output train of pulses; a filter for blocking λ₁ and λ₂ and for passing a multi-photon excited fluorescence signal generated by at least one of the first excitable species, the second excitable species and the third excitable species in the common focal volume; at least one photodetector for detecting the multi-photon excited fluorescence signal; and processing electronics for analyzing the multi-photon excited fluorescence signal detected by the photodetector in synchronization with the at least one pulse picker.

The focusing optic can be achromatic for spectral regions around each of λ₁ and λ₂. The focusing optic can have a chromatic focal shifts that are compensated by matching divergence of the first output train of pulses and the second output train of pulses to generate a common focal volume in a spectral region around λ₁ and λ₂. The focusing optic can be achromatic in a spectral region around λ₁ and λ₂. The focusing optic can have achromatic focal shifts that are compensated by matching divergence of the first output train of pulses and the second output train of pulses to generate a common focal volume in a spectral region around λ₁ and λ₂.

In some cases, beam sizes of the first output train of pulses and/or the second output train of pulses are matched to provide a common focal volume of identical size independent of λ₁ and λ₂.

The multi-photon excitation system can be a three-photon excitation system, wherein 3/(2/λ₁+1/λ₂) or 3/(1/λ₁+2/λ₂) can be within a three-photon excitation wavelength range of an excitable species. In some cases, the multi-photon excitation system is a three-photon excitation system, wherein the system further comprises a third fiber system seeded by a third input train of pulses generating a third output train of pulses at a second center wavelength λ₃, wherein 3/(1/λ₁+1/λ₂+1/λ₃) is within a three-photon excitation wavelength range of an excitable species, and wherein the focusing optic focuses the first, the second and the third output trains of pulses into the common focal volume.

The first fiber system and the second fiber system can be fiber lasers. The focusing optic can focus the first and second output trains of pulses into a common focal volume comprising a biological or chemical sample.

Another aspect of the disclosure is directed to a multi-photon imaging system comprising a pulsed seed laser system; a beam-scanning system; and a fiber delivery system for delivering light from the pulsed seed laser system to the beam-scanning system, wherein at least one wavelength of the light from the pulsed seed laser system has a power at an input of the fiber delivery system that is less than a power at an input of the beam-scanning system, and wherein a laser duty factor of the light at the input of the beam-scanning system is larger than 100.

In some cases, the system further comprises at least one fiber amplifier system at an output of the fiber delivery system for amplifying a power of the pulsed seed laser system to provide the power used at the input of the beam-scanning system. In some cases, the fiber delivery system comprises at least one fiber amplifier system. In some cases, the system further comprises at least one non-linear conversion medium at an output of the fiber delivery system, or as part of the fiber delivery system, for generating a wavelength and the power at the input of the beam-scanning system. In some cases, the pulsed seed laser system comprises at least one fiber pre-amplifier system.

In some cases, the system further comprises at least one pump source to optically pump the at least one fiber amplifier system. In some cases, the seed laser source is a pulsed synchronized dual-wavelength laser source comprising outputs at two or more wavelengths. In some cases, the at least one fiber amplifier system comprises a component having at least one of the following dopants: erbium, ytterbium, neodymium, holmium or thulium.

The at least one fiber amplifier system can be provided as part of a microscope. The output of the fiber delivery system can be operatively coupled to a microscope. The beam-scanning system can be provided as part of a microscope.

In some cases, light from the at least one pump source is coupled in a core of the same optical fiber of the fiber delivery system as the seed light of the pulsed seed laser system. In some cases, light from the at least one pump source is coupled in an inner cladding of the same optical fiber of the fiber delivery system as the seed light of the pulsed seed laser system, and the at least one fiber amplifier system is a cladding-pumped fiber amplifier system. In some cases, light from the at least one pump source is delivered in a second fiber delivery system.

In some cases, at least two of the two or more wavelengths are propagated through at least two separate fibers of the fiber delivery system and combined either before or after the at least one fiber amplifier system. In some cases, at least two of the two or more wavelengths are combined into a single fiber of the fiber delivery system and the at least one fiber amplifier system comprises two different doped gain fibers in a collinear geometry.

In some cases, a ratio of pulse durations of a pair of the outputs at the two or more wavelengths is between 1 and 3. In some cases, the outputs at the two or more wavelengths are synchronized using optical synchronization, electronic feedback or feed forward synchronization. In some cases, timing jitter for the temporal synchronization is less than 20% of the pulse duration of the longer pulses of the outputs at the two or more wavelengths at the input of the beam-scanning system.

The system can be configured for imaging using at least one of coherent anti-Stokes Raman scattering (CARS), stimulated Raman scattering (SRS), two-photon excited fluorescence (TPEF), two-color two-photon excited fluorescence (TCTPEF), second harmonic generation (SHG), sum frequency generation (SFG), third harmonic generation (THG), two-color two-photon absorption and transient absorption (TPA).

In some cases, the average power at the input of the fiber delivery system is less than 1 mW and the average power at the input of the beam-scanning system is more than 1 mW. In some cases, the average power at the input of the fiber delivery system is less than 10 mW and the average power at the input of the beam-scanning system is more than 10 mW. In some cases, the average power of at the input of the fiber delivery system is less than 100 mW and the average power at the input of the beam-scanning system is more than 100 mW. In some cases, the power at the input of the fiber delivery system is low enough to generate a nonlinear phase phase delay Φ_{NL} smaller than 5 over the length of the delivery system.

At least one wavelength of the light from the seed laser system can have a pulse duration between 25 femtoseconds and 250 picoseconds. The power at the input of the fiber delivery system and the power at the input of the beam-scanning system can be average powers. The power at the input of the fiber delivery system and the power at the input of the beam-scanning system can be peak powers.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings or figures (also “FIG.” and “FIGs.” herein), of which:

FIG. 1 shows an example of spectral coverage for TPEF and TCTPEF using fundamental and doubled outputs for a dual erbium- and ytterbium-doped laser system. Multiple classes of chromophores can be excited using combinations of the two synchronized beams and respective frequency-doubled outputs.

FIGS. 2A-2D show examples of different modes of performing multi-photon excitation of a fluorophore.

FIG. 3 shows an example dual-wavelength multi-photon imaging system.

FIG. 4 schematically illustrates a fiber laser based multi-photon imaging system with synchronized output pulse trains.

FIG. 5A is an example of a system that includes fiber amplifier systems.

FIG. 5B is an example of a system that includes a fiber amplifier unit and an SHG unit.

FIG. 5C is an example of a system that includes fiber amplifier systems and a second harmonic generation (SHG) unit in one of the arms.

FIGS. 6A-6B schematically illustrate examples of delivering an excitation laser light to an imaging system.

FIGS. 7A-7C schematically illustrate examples of the optically synchronized dual wavelength laser sources.

FIGS. 8A-8B schematically illustrate two examples of electronically synchronized dual-wavelength laser sources.

FIGS. 9A-9C schematically illustrate examples of parametric dual-wavelength laser sources.

FIG. 10A schematically illustrates an example of providing a first and a second input train of pulses that are temporally synchronized by frequency shifting or by broadening an output of an oscillator.

FIG. 10B schematically illustrates an example of providing a first and a second input train of pulses that are temporally synchronized by optical synchronization of two oscillators with a common mode-locker.

FIG. 10C schematically illustrates an example of providing a first and a second input train of pulses that are temporally synchronized by electrical synchronization of two oscillators via feedback.

FIG. 10D schematically illustrates an example of providing a first and a second input train of pulses that are temporally synchronized by electrical synchronization of an oscillator and a pulse on-demand source.

FIGS. 11A-11I schematically illustrate eight variations of novel delivery systems of the present disclosure.

FIG. 12 shows a schematic of an example of a dual-wavelength all-fiber laser source for CRS.

FIGS. 13A-13C provide characterizations of an example system provided herein.

FIG. 14 shows example CARS spectroscopic imaging.

FIG. 15A is an example of a system in which a first fiber system and a second fiber system are arranged in a collinear fashion.

FIG. 15B is an example of a system in which a second input train of pulses is derived from a first input train of pulses.

FIG. 15C is an example of a system in which a delay system is included either in a first or a second output train of pulses to temporally overlap the synchronized pulses in a common focal volume.

FIG. 15D is an example of a system in which a delay system is included either in a first or a second input train of pulses to temporally overlap the synchronized pulses in a common focal volume.

FIGS. 16A-16B show examples of tuning ranges of fiber gain media ytterbium and erbium of 1010-1080 nm and 1530-1620 nm, respectively.

FIG. 17A shows examples of fluorescent molecules that can be excited with a synchronized erbium and ytterbium system based on typical tuning ranges of common fiber gain media.

FIG. 17B shows examples of fluorescent molecules that can be excited with a synchronized erbium and thulium system based on typical tuning ranges of common fiber gain media.

FIG. 18A is an example of a system that includes an erbium- and an ytterbium-doped fiber amplifier system.

FIG. 18B is an example of a system that includes a frequency doubled erbium-doped fiber amplifier system and an ytterbium-doped fiber amplifier system.

FIG. 18C is an example of a system that includes an erbium-doped fiber amplifier system of which a portion of the output is frequency doubled to provide the second output.

FIG. 18D is an example of a system that includes an erbium-doped fiber amplifier system of which the output is split into a long- and short-wavelength arm and consequently frequency doubled.

FIG. 18E is an example of a system that includes an erbium- and a frequency-doubled thulium-doped fiber amplifier system.

FIG. 18F is an example of a system that includes a frequency doubled erbium-doped fiber amplifier system and a frequency-doubled thulium doped fiber amplifier system.

FIG. 19A shows a schematic of an implementation of a multi-photon imaging system by combining elements of FIG. 10A, FIG. 18B, and FIG. 11B into a single system.

FIG. 19B shows a prototype multi-photon imaging system based on the laser system in FIG. 19A.

FIG. 19C shows spectrum (top) and pulse duration (bottom) of Yb-arm as a function of output power. Minimal spectral broadening is observed.

FIG. 20 provides multi-photon fluorescence images of pollen grains acquired with the system shown in FIGS. 19A-19B.

FIG. 21A schematically illustrates simultaneous multi-color multi-photon microscopy with three-beams generated from three independent fiber systems.

FIG. 21B schematically illustrates simultaneous multi-color multi-photon microscopy with three-beams generated from a first amplifier system with harmonic generation unit for collinear dual-wavelength output and a second fiber amplifier system.

FIG. 21C schematically illustrates simultaneous multi-color multi-photon microscopy with three-beams generated from a first amplifier system with harmonic generation unit for non-collinear dual-wavelength output and a second fiber amplifier system.

FIG. 22 shows an example excitation scheme for simultaneous multi-species multi-photon microscopy.

FIG. 23A schematically illustrates simultaneous multi-color multi-photon microscopy using emission spectroscopy with multiple detectors sensitive to specific spectral regions of fluorescence emission.

FIG. 23B schematically illustrates simultaneous multi-color multi-photon microscopy using excitation spectroscopy by modulating first and second output pulse trains at different RF frequencies and detecting fluorescent response at fundamental and mixed frequencies with processing electronics.

FIG. 24 shows a detailed wiring diagram for a consolidated electronics design to (1) control and monitor laser and diagnostic instrumentation, (2) drive beam-scanners and (3) read detectors.

FIG. 25 shows a computer system or controller that is programmed or otherwise configured to regulate various operational parameters of the systems disclosed herein.

FIG. 26 shows an example of characterization of timing jitter for optical synchronization. The inset shows cross-correlation of pump and Stokes pulses measured by sum-frequency generation (SFG) in a BBO crystal.

FIGS. 27A-27B provide examples of excitable species.

### DETAILED DESCRIPTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed. It shall be understood that different aspects of the invention can be appreciated individually, collectively, or in combination with each other.

### Multi-Photon Methods

The disclosure provides systems and methods for microscopy and spectroscopy and tomography techniques that depend on spatial and temporal overlap of multiple optical pulses also “pulse trains” herein) at different wavelengths on a target. Such techniques or methods are collectively referred to herein as multi-photon methods (also “imaging” herein). As used herein, any aspects of the disclosure described in relation to microscopy may equally apply to spectroscopy or tomography at least in some configurations. In some cases, such techniques can include nonlinear optical techniques (e.g., coherent anti-Stokes Raman scattering (CARS) or stimulated Raman scattering (SRS), multi-photon excitation, second harmonic generation or other sum/difference frequency generation, etc.). In some cases, the techniques can include multi-photon techniques (e.g., multi-photon excitation, etc.). In some cases, the techniques can include pump-probe techniques used for probing reflection, transmission, absorption, and other characteristics of a sample (e.g., by measuring a temporal response of the sample after the pump beam reaches the sample while the delay time of the probe beam is adjusted). Further examples of techniques benefiting from fiber laser-based systems and methods herein include, but are not limited to, for example, terahertz imaging and sensing (e.g., difference frequency mixing of two lasers at wavelengths that are very close together) and optical coherence tomography (OCT). In some cases, the systems and methods herein can be configured to provide hyperspectral imaging.

Systems and methods herein can be used to enable various multi-photon methods. For example, laser system configurations of the present disclosure can be used for any detection methods described herein, including multi-photon microscopy (MPM) methods. Detection methods that can be used with the methods and systems described herein include nonlinear optical detection methods. In some examples, the systems and methods described herein can be used with detection methods such as, for example, coherent Raman scattering (CRS) (e.g., CARS, SRS), Raman Induced Kerr Effect (RIKE), second harmonic generation (SHG), third harmonic generation (THG), sum frequency generation (SFG), difference frequency generation (DFG), two-photon absorption (TPA), multi-photon absorption, transient absorption (TA), ground state depletion (GD), stimulated emission (SE), and so on. Detection methods described herein can be used in microscopy imaging applications. Any aspects of the disclosure described in relation to, for example, CRS may apply to other multi-photon methods at least in some configurations, including microscopy configurations. Further examples include using the laser system configurations herein for multi-photon excitation, such as, for example, multi-photon fluorescence excitation (e.g., two-photon excited fluorescence (TPEF), or two-color two-photon excited fluorescence (TCTPEF)). Any aspects of the disclosure described in relation to multi-photon fluorescence excitation may equally apply to other multi-photon methods at least in some configurations. Yet other examples include, but are not limited to, photo-activation and/or photo-uncaging.

Techniques such as GD, TA and SE can rely on modified transmission properties of the sample induced by a first beam (e.g., pump beam) and probed by a second beam (e.g., probe beam). In contrast, TPA can rely on the combined absorption of two photons by the sample that results in exciting the molecules into an excited electronic state. Chemical contrast can be achieved by tuning the sum energy of the two photons into the energy of the electronic excited state. Femtosecond (fs) pulsewidth lasers can be used for maximal signal, but excitation with picoseconds (ps) pulsewidth lasers is also possible. In the SE process, one beam excites molecules in the sample into an excited state, and when these molecules interact with the other beam, they emit light into that beam with matched polarization and phase, increasing the brightness of that beam. In GD, one beam removes molecules from the ground state by promoting them to an excited state, so that fewer molecules are in the ground state and thus the absorption of the other beam is reduced. In order to modify the populations of molecules in the sample, the beams are typically chosen to match the one or two-photon electronic absorption resonances of the molecule in the ground or excited state. Femtosecond (fs) pulsewidth lasers may in some cases be used to maximize signal. The probe pulse can also be delayed to maximize the signal.

In some embodiments, Raman-induced Kerr effect (RIKE) is utilized for detection using the methods and systems described herein. In RIKE, the polarization of at least a portion of a spectrum of the first train of pulses is rotated by the sample in response to the second train of pulses if the difference frequency matches a Raman-active vibration. It can be detected by placing cross-polarizers in front of the detector system, e.g. in response to the first train of pulses. The transmission can be zeroed when no sample is present. Such a filter can help reduce the strength of the local oscillator compared to SRS and improve detection sensitivity. Linear birefringence can, however, be a limitation for employing the contrast to heterogeneous samples. A related technique is optical-heterodyne (OHD) RIKE, in which a portion of the first train of pulses is adjusted to leak through the polarizers such that it serves as a local oscillator and boosts the signal over the electronic noise floor of the detectors. By adjusting the optical phase of the leak-through, different temporal portions of the Raman response can be probes. Such OHD is typically combined with a high-frequency detection scheme also used in SRS.

A common feature of many of these techniques is that a small intensity gain/loss of one laser beam is measured as a result of its interaction with a second beam and the sample. To achieve high sensitivity, a high-frequency modulation/detection scheme can be used. This process can be carried out by modulating the second beam at a known modulation frequency and extracting the modulation transfer onto the first beam with electronics that sensitively detect the modulation frequency. As such, a stable signal amplification of the small signal can be achieved. By choosing the modulation frequency to be distinct from the characteristic frequencies of laser noise of the excitation lasers, this laser noise can be suppressed.

One or more of these methods can be implemented in a multi-modal system. For example, one or more of CRS, SHG, TPA, TPA, TA, GD and SE techniques can be used in conjunction with various TPEF techniques in a multi-modal system. These techniques or methods can have different requirements on the laser system, but each may use pulsed lasers (e.g., excitation with pulsed lasers) that have high peak power at moderate average power. For example, TCPEF, SFG and TPA share the common feature of two-color laser input/excitation with a pulsed laser used in CARS and SRS. Pulse durations can be optimized by, for example, using one or more desired narrowband filters before the amplifiers. In some examples, repetition rate can be lowered to achieve the same peak power for picosecond lasers as compared to femtosecond lasers (e.g., lasers operating at 80 MHz repetition rate). The laser platforms described herein can be modified accordingly for imaging techniques, such as multi-photon microscopy and multi-modal imaging. Due in part to differences in optical contrast of the various multi-photon methods, the present disclosure includes laser systems with the capability of performing multiple multi-photon methods. In some cases, multi-modality can be used to supplement image information from one imaging modality with that of other imaging modalities (e.g., without or with minimal reconfiguration of the system).

Imaging applications using the systems and methods herein include imaging associated with various in vitro or in vivo assays, such as, for example, in vitro cellular assays or in vivo animal models (e.g., whole animals or animal organs). Imaging may be performed on a variety of biological or chemical samples (also “test samples” herein), including, for example, arrays of biological molecules immobilized on substrates, cells adhered to substrates or growing on culture media, blood smears, tissue samples, biopsy samples, skin samples, microparticles and beads, polymer surfaces, and the like. As used herein, the terms “sample” or “test sample” include simple or complex organisms, animals, humans, or portions thereof.

In some implementations, the present disclosure provides systems and methods employing CRS (e.g., CARS and/or SRS). For example, the present disclosure includes systems and methods for performing imaging (e.g., CRS microscopy) using, for example, CARS and/or SRS. In some examples, systems and methods for using CRS (e.g., CARS and/or SRS) with conventional microscope systems are provided.

CRS can be used for a variety of applications. In certain aspects, CRS allows, for example, non-destructive chemical analysis of the sample based on analysis of the vibrations of the chemical bonds. Raman scattering microscopy allows imaging of lipids, protein, sugars and DNA inside a single living cells, and determination of the degree of unsaturation and transition temperatures of lipids. For example, general lipid content can be measured using CRS based on the signal from the CH₂ vibration at 2845 cm⁻¹. Protein and DNA content can be measured from the CH₃ vibrations at 2945 cm⁻¹ and 2960 cm⁻¹, respectively. Content of unsaturated lipids can be measured specifically based on the CH vibration at 3015 cm⁻¹, and the ratio of CH-to-CH₂ vibrations can used to measure the degree of saturation. Aromatic compounds can be determined based on the aromatic CH vibration at 3060 cm⁻¹. Additional examples of measured or estimated values of Raman shifts for various structural groups are listed in TABLE 1.

TABLE 1
Examples of Raman shifts data for different chemical groups

| Approximate wavenumber | |
|---|---|
| range (cm⁻¹) | Group |
| 1610-1740 | Carboxylic acid |
| 1625-1680 | C═C |
| 1630-1665 | C═N |
| 1710-1725 | Aldehyde |
| 1710-1745 | Ester |
| 1730-1750 | Aliphatic ester |
| 2530-2610 | Thiol |
| 2680-2740 | Aldehyde |
| 2750-2800 | n-CH3 |
| 2770-2830 | CH2 |
| 2780-2830 | Aldehyde |
| 2790-2850 | O—CH3 |
| 2810-2960 | C—CH3 |
| 2870-3100 | Aromatic C—H |
| 2880-3530 | OH |
| 2900-2940 | CH2 |
| 2980-3020 | CH═CH |
| 3010-3080 | ═CH2 |
| 3150-3480 | Amide |
| 3150-3480 | Amine |
| 3200-3400 | Phenol |
| 3210-3250 | Alcohol |
| 3250-3300 | Alkyne |

More specific spectroscopic analysis of vibrational fingerprints allows determination of the thermal state of lipids (e.g., liquid vs. gel phase), degree of esterification and determination of specific chemical species such as cholesterol and omega-3 fatty acids. In SRS microscopy, stimulated Raman gain or loss of the pump or Stokes beam is measured, respectively. Chemical contrast can be achieved by tuning the frequency difference of the two beams to a molecular vibrational frequency of the sample. Excitation can be performed with a near-infrared laser (far from electronic absorption resonances) for maximal sample penetration. In some cases, the excitation pulsewidth can be on the order of picoseconds (ps), so as to provide adequate spectral resolution.

In some cases, CRS (e.g., CARS and/or SRS) may be implemented in accordance with the systems and methods herein to, for example, access the stretch region of —C-D bonds. To access this stretch region, frequency differences between the two excitation beams can be used to cover, for example, a range from about 1950 cm⁻¹ to about 2300 cm⁻¹. In one example, an all-fiber laser system based on optical synchronization of frequency-doubled erbium (Er) and frequency-doubled thulium/holmium (Tm/Ho) fiber amplifiers can be used.

In some cases, CRS (e.g., CARS and/or SRS) may be implemented in accordance with the systems and methods herein to, for example, access the stretch region of —C═O amide bonds. To access this stretch region, frequency differences between the two excitation beams can be used to cover, for example, a range from about 1250 cm⁻¹ to about 1750 cm⁻¹. In one example, an all-fiber laser system based on optical synchronization of ytterbium (Yb) and frequency-doubled thulium/holmium (Tm/Ho) fiber amplifiers can be used.

In some implementations, the systems and methods of the disclosure may be used for multi-photon excitation. In some examples, an important application can be multi-photon excited fluorescence microscopy, where molecular species are excited from ground to excited states by the co-action of at least two photons and fluorescence emission is detected. In some cases, by scanning the excitation beams through a sample, a three-dimensional image of the excited species can be generated. Molecular species not intrinsically fluorescent (or weakly fluorescent) can be imaged by attaching a specific label to the target molecule, e.g., by binding or genetically encoding. This has become an important technique in basic and applied biology research and medical applications are under development. In some examples, the systems and methods of the disclosure can relate to photo-activation, photo-uncaging or multi-photon polymerization, where no fluorescence emission is detected.

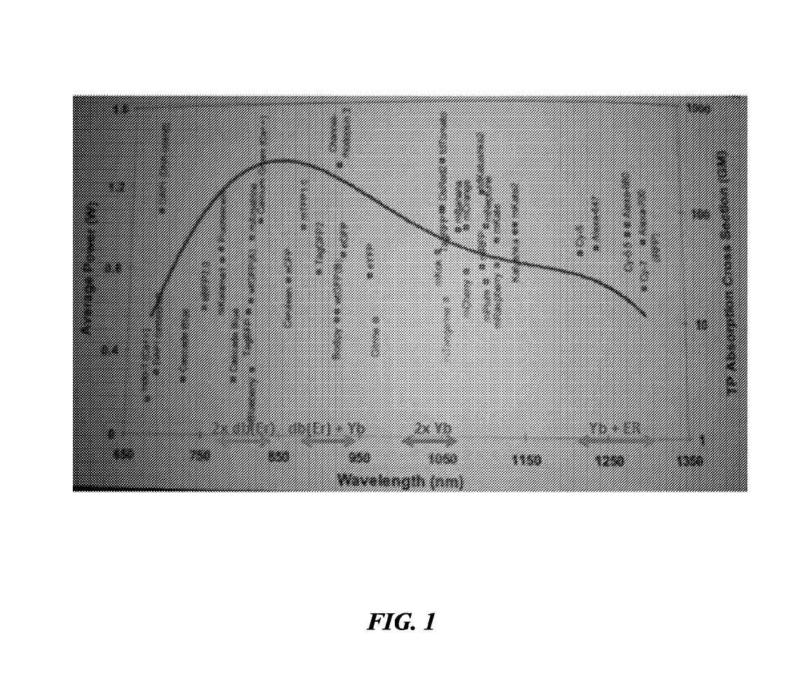

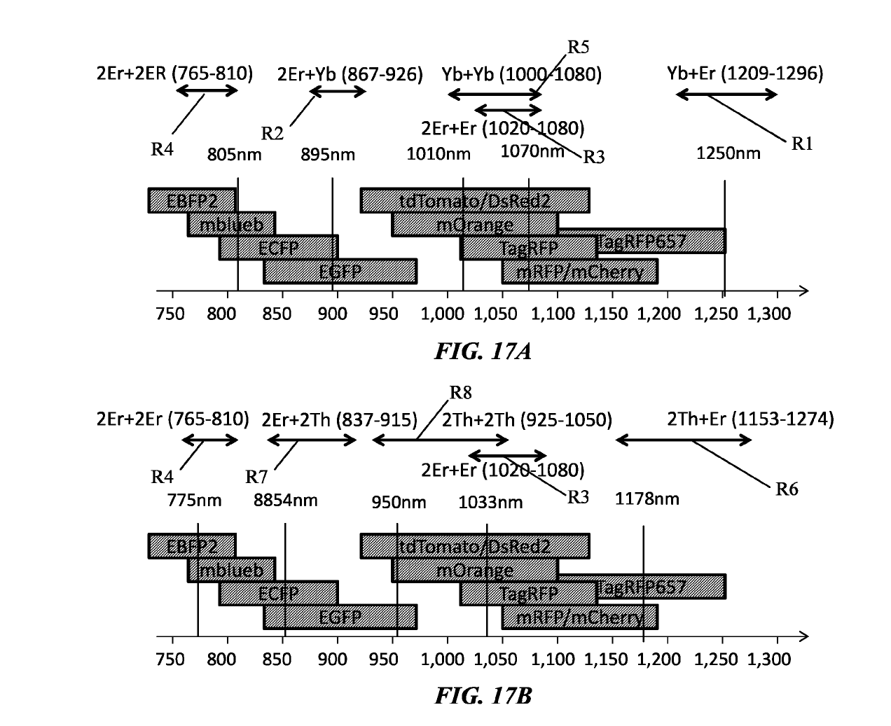

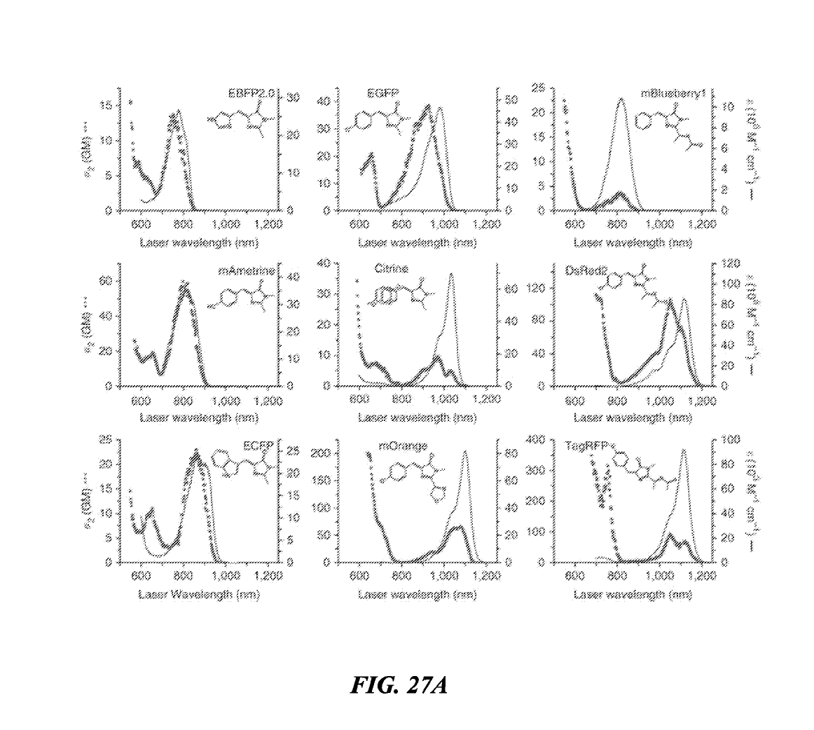

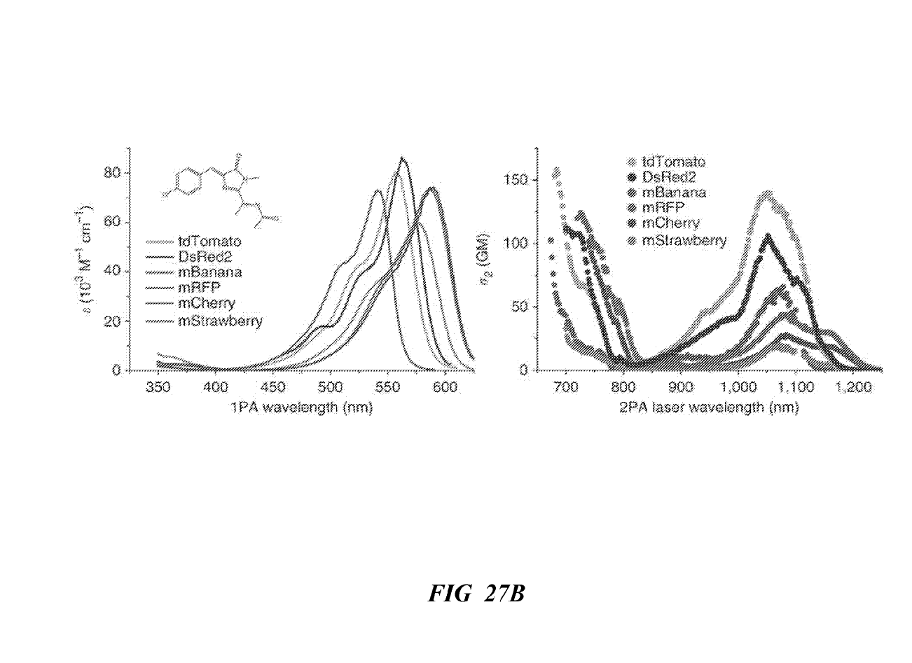

Species excited by multi-photon absorption can include chromophores and fluorophores, which can be genetically encodable, dyes and stains, or intrinsic to the sample (auto-fluorescence), collectively referred to herein as excitable species. For example, the systems of the present disclosure can be tuned to probe a wide variety of fluorescent dyes over a broad spectral range. The systems of the disclosure can be used to provide multi-photon excitation in an excitation wavelength range (e.g., a two-photon excitation wavelength range, a three-photon excitation wavelength range) of one or more excitable species (e.g., see FIG. 1 and FIGS. 17A-17B). Examples of excitable species include, but are not limited to, fluorescein, 4′,6-diamidino-2-phenylindole (DAPI), cascade blue, monomeric blue fluorescent protein (mTagBFP), calcium green, green fluorescent protein (GFP), enhanced green fluorescent protein (EGFP), green fluorescent protein—enhanced blue variant (EBFP2), enhanced cyan fluorescent protein (ECFP), Cy-5, Cy-7, Alexa-647, Alexa 680, and the like. Additional examples of excitable species (e.g., dyes) are listed in TABLE 2. Further illustrative examples of excitable species (e.g., fluorophores) are provided in “Two-photon absorption properties of fluorescent proteins,” Nature Methods 8, 393-399 (2011), hereby incorporated by reference herein in its entirety. Examples of these excitable species are shown in FIGS. 27A-27B.

TABLE 2
Example dyes

| | TPE | | | |
|---|---|---|---|---|
| Probe | Excitation | Application | References | Cat # |
| Alexa Fluor | 720 nm or 830 | Imaging F-actin | J Biol Chem (2004) | A12379 |
| 488 phalloidin | nm | organization in | 279: 37544-37550 | |
| | | pancreatic acinar cells | | |
| Alexa Fluor | 810 nm | Ca²⁺-insensitive, | Neuron (2002) 33: | A10438, A10442 |
| 594 hydrazide | | neuronal tracer * | 439-452; | |
| | | | www.stke.org/cgi/content/ | |
| | | | full/sigtrans; 2004/219/pl5 | |
| Amplex Red | 750 nm or 800 | Detection of reactive | J Neurosci (2003) | A12222, A22177 |
| reagent | nm | oxygen species (ROS) | 23: 2212-2217 | |
| | | associated with | | |
| | | amyloid plaques | | |
| CFSE, | 820 nm | Tracking T and B | Science (2002) | C1157, C2927 |
| CMTMR | | lymphocytes and | 296: 1869-1873; | |
| | | dendritic cell motility | Proc Natl Acad Sci USA | |
| | | patterns in intact | (2004) 101: 998-1003 | |
| | | mouse lymph nodes † | | |
| CM-H₂DCFDA | 740 nm | Detection of localized | J Biol Chem (2003) | C6827 |
| | | reactive oxygen | 278: 44735-44744 | |
| | | species release in | | |
| | | cardiomyocytes ‡ | | |
| DAPI, Hoechst | 740 nm | Imaging DNA in | Micron (2001) 32: 679-684; | D1306, D3571, |
| 33342 | | nuclei and isolated | Histochem Cell Biol (2000) | D21490, H1399, |
| | | chromosomes | 114: 337-345 | H3570, H21492 |
| DiD | 817 nm | Intravital imaging of | Proc Natl Acad Sci USA | D307, D7757 |
| | | mouse erythrocytes | (2005) 102: 16807-16812 | |
| FM 1-43 | 840 nm | Monitoring synaptic | Biotechniques (2006) | T3163, T35356 |
| | | vesicle recycling in rat | 40: 343-349 | |
| | | brain slices | | |
| Fluo-5F § | 810 nm | Imaging Ca²⁺ | Neuron (2002) 33: 439-452; | F14221, F14222 |
| | | concentration | www.stke.org/cgi/content/ | |
| | | dynamics in dendrites | full/sigtrans; 2004/219/pl5 | |
| | | and dendritic spines | | |
| Fura-2 | 780 nm | Detection of GABA- | J Physiol (2001) | F1200, F1201, |
| | | mediated Ca²⁺ | 536: 429-437 | F1221, F1225, |
| | | transients in rat | | F6799, F14185 |
| | | cerebellar Purkinje | | |
| | | neurons | | |
| Lucifer yellow | 850 nm | Identification of gap | J Neurosci (2003) | L453, L682, |
| CH | | junctions in rat brain | 23: 9254-9262 | L1177 |
| | | slices | | |
| Laurdan | 800 nm | Detection of ordered | Proc Natl Acad Sci USA | D250 |
| | | membrane lipid | (2003) 100: 15554-15559; | |
| | | domains | J Cell Biol (2006) | |
| | | | 174: 725-734 | |
| Monochloro- | 780 nm | Imaging glutathione | J Biol Chem (2006) | M1381MP |
| bimane | | levels in rat brain | 281: 17420-17431 | |
| | | slices and intact mouse | | |
| | | brain | | |
| MQAE | 750 nm | Fluorescence lifetime | J Neurosci (2004) | E3101 |
| | | imaging (FLIM) of | 24: 7931-7938 | |
| | | intracellular Cl⁻ | | |
| | | concentrations in | | |
| | | olfactory sensory | | |
| | | neurons | | |
| Oregon Green | 880 nm | Imaging | Proc Natl Acad Sci USA | O6806, O6807 |
| 488 BAPTA-1 | | spatiotemporal | (2005) 102: 14063-14068 | |
| | | relationships of Ca²⁺ | | |
| | | signals among cell | | |
| | | populations in rat brain | | |
| | | cortex | | |
| Qdot 525, Qdot | 750 nm | Multiplexed | Am J Physiol (2006) | Q11441MP, |
| 585, Qdot 655 | | immunohistochemical | 290: R114-R123 | Q10111MP, |
| nanocrystals | | analysis of arterial | | Q11621MP, |
| | | walls ** | | Q11421MP |
| SBFI | 760 nm | Imaging of | Biophys J (2004) | S1262, S1263, |
| | | intracelluar Na⁺ | 87: 1360-1368 | S1264 |
| | | gradients in rat | | |
| | | cardiomyocytes | | |
| TMRE | 740 nm | Mitochondrial | J Biol Chem (2003) | T669 |
| | | membrane potential | 278: 44735-44744; | |
| | | sensor ‡ | Circulation (2006) | |
| | | | 114: 1497-1503 | |
| X-rhod-1 | 900 nm | Simultaneous imaging | J Neurosci (2004) | X14210 |
| | | of GFP-PHD | 24: 9513-9520 | |
| | | translocation and Ca²⁺ | | |
| | | dynamics in cerebellar | | |
| | | purkinje cells | | |

* Used in combination with fluo-4, fluo-5F or fluo-4FF to obtain ratio signals that are insensitive to small changes in resting Ca²⁺ and are independent of subcellular compartment volume.
† Multiplexed (single excitation/dual channel emission) combination of CFSE and CMTMR.
§ Techniques also applicable to fluo-4 and fluo-4FF indicators.
‡ Multiplexed (single excitation/dual channel emission) combination of TMRE and CM-H₂DCFDA.
** Multiplexed (single excitation/dual channel emission) combination of Qdot 585 and Qdot 655 nanocrystals.
PHD = pleckstrin homology domain.

FIG. 1 is an example of spectral coverage for TPEF and TCTPEF using fundamental and doubled erbium and ytterbium outputs, or a dual erbium- and ytterbium-doped laser system. Up to 3 classes of chromophores can be specifically excited with two synchronized beams (e.g., doubled erbium and ytterbium) and up to 6 classes can be excited with combinations of the three beams.

The systems and methods herein may be used for excitation using two, three or more photons. In some cases, two or more of the photons can have the same wavelength. In other cases, two or more of the photons can have different wavelengths. For example, all of the photons can have identical wavelengths, or all of the photons can have different wavelengths. Combinations of number of photons and number of different wavelengths (also “colors” herein) of these photons provide different modes of performing multi-photon excitation of a fluorophore.

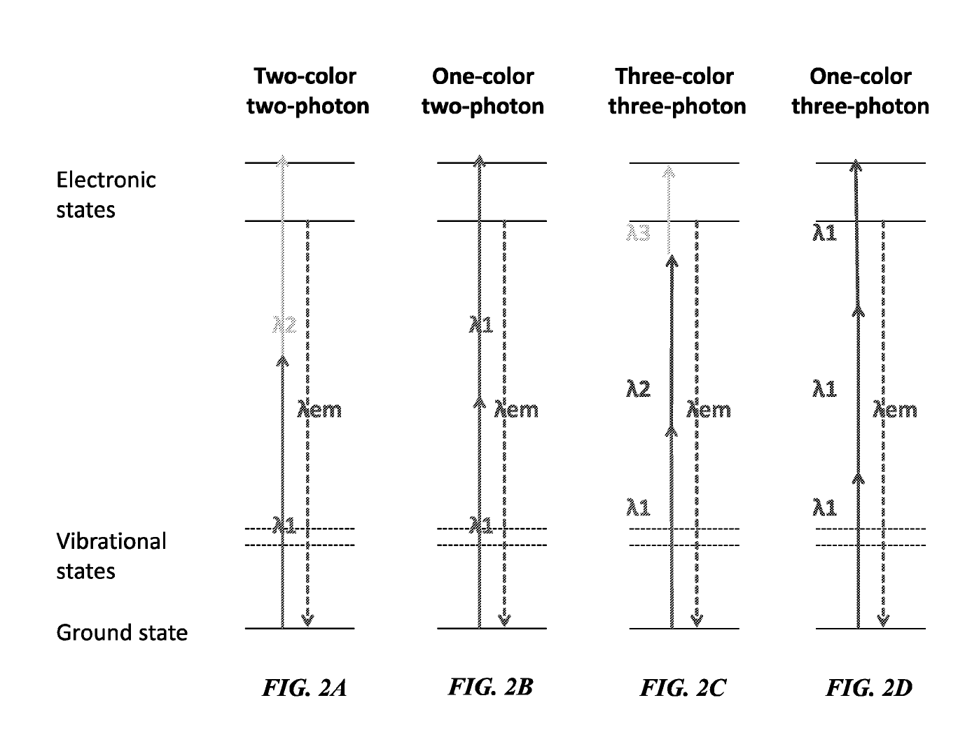

FIG. 2A is an example of a mode using two photons, wherein each photon has a different color (also “two-color two-photon” mode herein). The two colors can have wavelengths λ₁ and λ₂. A special case of the two-color two-photon mode where the colors are the same (λ₁=λ₂) is shown in FIG. 2B (also “one-color two-photon” mode herein).

FIG. 2C is an example of a mode using three photons, wherein each photon has a different color (also “three-color three-photon” mode herein). The three colors can have wavelengths λ₁, λ₂ and λ₃. A special case of the three-color three-photon mode where the colors are the same (λ₁=λ₂=λ₃) is shown in FIG. 2D (also “one-color three-photon” mode herein). In other example modes, two of the three photons can be of the same color while the remaining photon is of a different color (λ₁=λ₂≠λ₃). This configuration can be referred to as “two color three photon” mode (not shown). In some cases, larger numbers of photons (e.g., 4 or more) can be used, thereby increasing the number of different combinations or modes possible.

Excitation of a molecular species can occur within a given wavelength range, defined as the range of the wavelength λ within which the molecular population is effectively excited from the ground state to an excited state (e.g., an excited electronic state) by virtue of simultaneous absorption of a given amount of photons (e.g., two, three or more). The photons can be supplied by the laser systems of the disclosure within an effective excitation wavelength λ_{eff} that can be determined for various system configurations.

In some implementations, the laser systems described herein can be used for two-photon excitation of a molecular species with a two-photon excitation wavelength range, defined as the range of the wavelength λ within which the molecular population is effectively excited from the ground state to an excited state by virtue of simultaneous absorption of two photons. For example, the systems can enable two-color two-photon excitation with an effective two-photon excitation wavelength λ_{eff}=2/(1/λ₁+1/λ₂), or one-color two-photon excitation with an effective two-photon excitation wavelength λ_{eff}=λ₁=λ₂.

In some implementations, the laser systems described herein can be used for three-photon excitation of a molecular species with a three-photon excitation wavelength range, defined as the range of the wavelength λ within which the molecular population is effectively excited from the ground state to an excited state by virtue of simultaneous absorption of three photons. For example, the systems can enable three-color three-photon excitation with an effective three-photon excitation wavelength λ_{eff}=3/(1/λ₁+1/λ₂+1/λ₃), two-color three-photon excitation with an effective three-photon excitation wavelength λ_{eff}=3/(2/λ₁+1/λ₂) or λ_{eff}=3/(1/λ₁+2/λ₂), or one-color three-photon excitation with an effective three-photon excitation wavelength λ_{eff}=λ₁=λ₂=λ₃.

In some implementations, the laser systems described herein can be used for multi-photon excitation of a molecular species with a multi-photon excitation wavelength range, defined as the range of the wavelength λ within which the molecular population is effectively excited from the ground state to an excited state by virtue of simultaneous absorption of M photons. In some examples, the systems can enable multi-color multi-photon excitation with an effective multi-photon excitation wavelength λ_{eff}=M/(1/λ₁+1/λ₂+ . . . +1/λ_{M}). For example, the imaging systems can be three-photon excitation systems. Such systems can comprise three fiber systems (e.g., seeded by three input trains of pulses), each generating three output train of pulses at a center wavelengths λ₁, λ₂ and λ₃, respectively, such that 341/λ₁+1/λ₂+1/λ₃) is within a three-photon excitation wavelength range of an excitable species. The focusing optic can focus the first, second and third output trains of pulses into the common focal volume. The three (or more in some implementations) trains of pulses can be temporally synchronized.

In other implementations, the laser systems described herein can be used for multi-photon microscopy techniques where other wavelengths or wavelength parameters are used. For example, the systems can be configured to provide a given difference frequency (e.g., 1/κ₁−1/λ₂) that matches a targeted vibrational or other characteristic frequency of the sample.

### Multi-Wavelength Fiber Laser System

Multi-photon methods (e.g., imaging techniques) of the disclosure can be implemented using fiber laser systems (also “multi-photon imaging systems,” “imaging systems,” “multi-photon systems” or “multi-photon platforms” herein). Various configurations of the fiber laser based multi-photon imaging systems of the disclosure may achieve laser output pulse trains at various wavelengths (also “output beams” herein). In some examples, real-time multi-photon spectroscopy can be implemented. A variety of different configurations can be used to provide systems for carrying out the imaging modalities described herein (e.g., CRS and multi-photon excitation).

In some implementations, the imaging systems of the disclosure can comprise a laser system operably coupled to a microscope system (also “microscope” and “microscopy system” herein). In some configurations, the lasers may be output into free-space and delivered to the microscope in free-space. In other configurations, a fiber delivery system can be used for coupling the laser system to the microscope. In some cases, it may be advantageous to use polarization-maintaining (PM) fiber to preserve polarization state. In some cases, it may also be advantageous to use large mode area (LMA), higher order mode (HOM), and/or photonic crystal (PCF) fibers to minimize nonlinear pulse evolution during delivery. Dispersion of the fibers can be chosen to achieve close to transform-limited pulse durations in the focus. Alternatively, free-space chirping systems (e.g., pulse compressor) can be used. Combining the output pulse trains can be achieved either in, before, or after delivery. It may also be advantageous to incorporate some parts of the fiber systems as part of the microscope and deliver low-power seed pulses to the microscope.

The microscope can comprise a beam scanning system and/or a detection system (e.g., comprising one, two, or more detectors). In some implementations, the systems and methods herein can be used with conventional microscope systems (e.g., including a beam-scanning unit). For example, an integrated microscope or an upgrade or retrofit unit to an existing microscope (e.g., to include the laser system, detectors, etc.) or a hand-held scanner can be used.

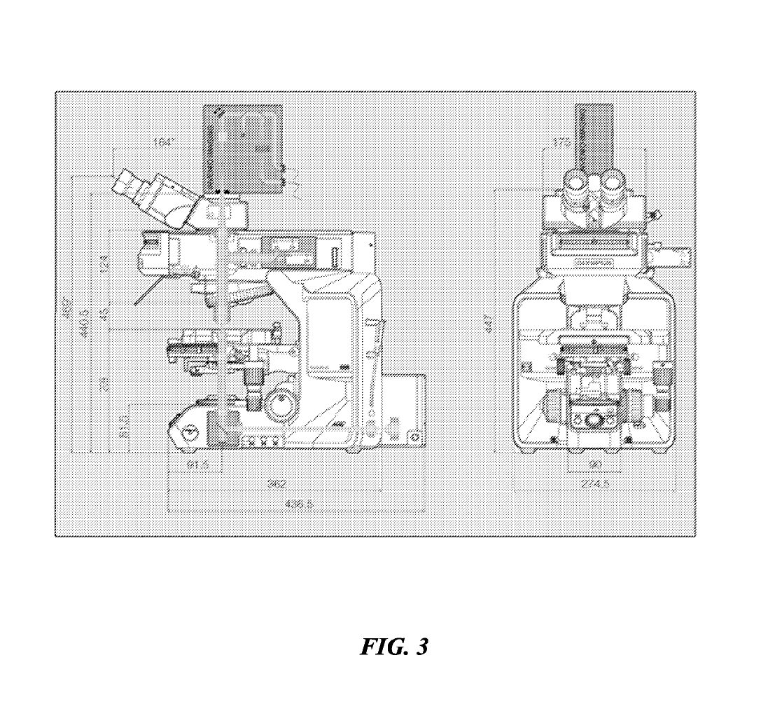

As provided further herein, the present disclosure provides systems and methods for integrating the various microscopy/spectroscopy techniques herein with a microscope. For example, multi-photon platforms such as, for example, CRS (e.g., CARS and/or SRS) may be integrated with a microscope. FIG. 3 shows an example CRS imaging system. The fiber laser source may be integrated with a microscope stand manufactured by an OEM provider (e.g., Olympus).

In some examples, the laser system, the microscopy system and/or the imaging system can be partially or fully controlled and/or monitored using computer software. Further, computer-implemented data acquisition (e.g., sampling using a data acquisition (DAQ) card on a computer system) may be used. In some examples, supply, control and monitoring electronics for the laser and/or microscope systems can be employed. For example, electronics can be used to control/monitor the laser system and diagnostic instrumentation, to drive beam-scanners and/or to read detectors.

In some implementations, detection may be performed within a narrowband spectral range using single-element or single-channel detectors. In some implementations, data are acquired over a broadband spectral range using multi-element or multi-channel detectors. Single-channel or single-element detectors include, but are not limited to photodiodes, avalanche photodiodes, and photomultipliers. Multi-channel or multi-element detectors include, but are not limited to photodiode arrays, photomultiplier arrays, CMOS sensors, and CCD sensors and cameras.

Ultra-short laser pulse-trains are typically characterized by the pulse duration τ and repetition rate R. As optical pulses are not square pulses, the pulse duration normally refers to their FWHM. The laser duty factor D=1/(τ·R) is a unit-less number that is proportional to the ratio of the laser peak power over the laser average power, wherein the proportionality constant depends on the exact temporal profile.

The first and second input pulse trains (e.g., used for the pump and Stokes beams) may originate from one or more separate pulse trains (e.g., pulse trains generated by one or more fiber oscillators and/or pulse generators). In some implementations, the temporally synchronized first and second input trains of pulses can be generated by splitting a pulse train, and the first and/or second fiber systems can include a step of wavelength conversion. In other implementations, the temporally synchronized first and second input trains can be generated by dividing a broadband pulse train by wavelength. Examples of methods and systems for generating the temporally synchronized first and second input trains are described elsewhere herein.

In one example, the first and second input trains of pulses that are temporally synchronized are provided by frequency shifting or by broadening an output of an oscillator. The first input train of pulses is generated from a fiber oscillator and the second input pulse train is generated by frequency broadening/shifting a portion of the first input pulse train to a new wavelength. Such frequency shifting can be achieved, for example, with a super-continuum (SC) unit including a photonic crystal fiber (PCF) or a highly nonlinear fiber (HNLF). In some cases, this configuration can provide stringent optical synchronization. In some cases, fixed or tunable filters can be used to select a specific wavelength with a specific bandwidth.

In another example, the first and second input trains of pulses that are temporally synchronized are provided by optical synchronization of two oscillators with a common mode-locker. The first and second input trains of pulses are generated from two fiber oscillators that share a common mode-locker to achieve the temporal synchronization. Examples of mode-lockers include semiconductor saturable absorbers (SESAMs) and saturable absorbers based on carbon nanotubes (CNT-SA), which can have a broad absorption wavelength range.

In another example, the first and second input trains of pulses that are temporally synchronized are provided by electrical synchronization of two oscillators via feedback. The first and second input trains of pulses are generated from two independent fiber oscillators and temporal synchronization is achieved via feedback (e.g., cavity length feedback). In some cases, this approach can eliminate the need for a delay stage as the delay can be compensated electronically. The first and second input trains of pulses can by monitored by one or more photo-diodes (PDs), the signal from which provides the input to the feedback electronics. In some cases, such electronic synchronization can be environmentally sensitive.

In yet another example, the first and second input trains of pulses that are temporally synchronized are provided by electronic synchronization of an oscillator and a pulse on-demand source. The first input train of pulses is generated from a fiber oscillator and the second input train of pulses is generated from a pulse on-demand laser source in response to an electrical signal derived from the first oscillator (also “feed-forward” herein). As an example, the second input train of pulses may be generated from a continuous-wave (CW) laser source by at least one high-speed modulator that is in response to a photodiode measuring the first pulse train. Such second laser can be a time-lens laser. In another example, first and second input trains of pulses are generated by on-demand lasers sources in response to an electronic signal.

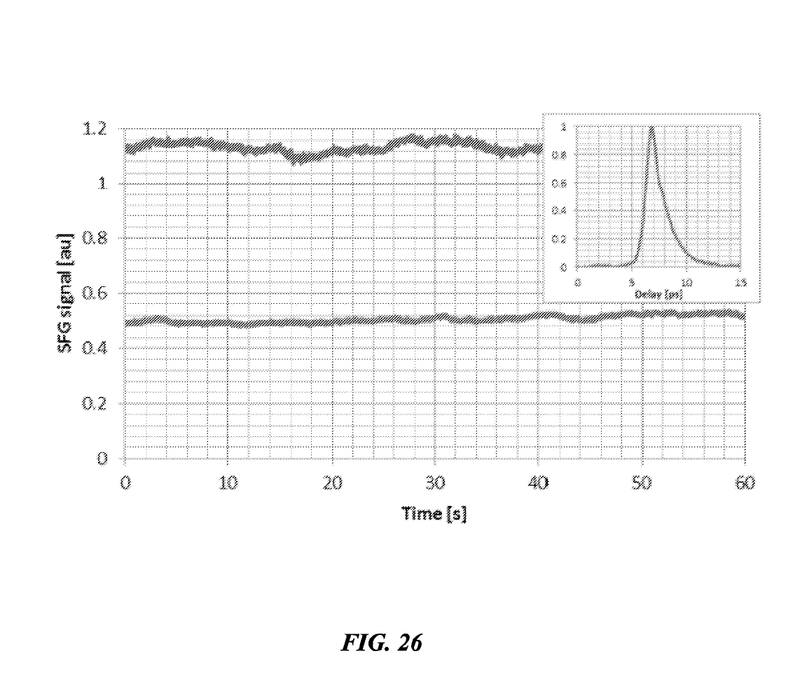

FIG. 26 shows an example of characterization of timing jitter for optical synchronization. A modified version of the laser system based on the optical synchronization of a frequency doubled erbium amplifier and a tunable ytterbium amplifier using a broadband super-continuum derived from a mode-locked erbium fiber laser generated a first train of pulses at a wavelength of 779 nm with 0.9 nm bandwidth and 0.9 ps pulse duration and a second train of pulses tunable from 10150 nm to 1050 nm with 0.65 nm bandwidth and 1.9 ps pulse duration. To characterize the timing jitter of the synchronization scheme, the pulses were overlapped in free space with a dichroic mirror and the time delay adjusted with a mechanical delay stage. This configuration allows measuring the cross-correlation of the pump and Stokes beams by recording the sum frequency generation (SFG) signal in a thin BBO crystal as a function of delay (FIG. 26, inset). To determine the timing jitter, 1-minute time traces of SFG signal at the half-maximum of the cross-correlation at 100 S/s were recorded (FIG. 26). The slope at half maximum is ˜0.93/ps. Intensity noise at the peak (top trace) and half max (bottom, trace) of the cross-correlation is 100 S/s. Only the top traces are affected by timing jitter. The standard deviation was determined and the slope of the cross-correlation at the half maximum was used to convert from intensity noise to timing jitter. The thus determined timing jitter was 14 fs, which is much smaller than the pulse durations. This approach only provides an upper limit estimate for the timing jitter, as laser intensity noise can be falsely interpreted as timing jitter and the actual timing jitter may be even lower.

Various systems and methods disclosed herein comprise laser, optical, and detection system designs that are adaptable to variations in design parameters, including, but not limited to laser, optical, and detection system parameters, such as laser pulse repetition rate, laser pulse duration, narrowband laser pulse wavelength, narrowband laser pulse bandwidth, broadband laser pulse wavelength, broadband laser pulse bandwidth, average and maximum laser output power, laser pulse synchronization or timing jitter, detection wavelength range, detection resolution, and data acquisition rate.

The systems and methods disclosed herein may be configured with various laser pulse repetition rates for one or more trains of laser pulses. Lower repetition rates may be advantageous in terms of increasing peak output powers. In one example, the laser pulse repetition rate is between 1 MHz and 1000 MHz. In some examples, the laser pulse repetition rate is at least about 1 MHz, 5 MHz, at least about 10 MHz, at least about 15 MHz, at least about 20 MHz, at least about 25 MHz, at least about 30 MHz, at least about 35 MHz, at least about 40 MHz, at least about 45 MHz, at least about 50 MHz, at least about 55 MHz, at least about 60 MHz, at least about 65 MHz, at least about 70 MHz, at least about 75 MHz, at least about 80 MHz, at least about 90 MHz, at least about 100 MHz, at least about 125 MHz, at least about 150 MHz, at least about 175 MHz, at least about 200 MHz, at least about 300 MHz, at least about 400 MHz, at least about 500 MHz, at least about 775 MHz, or at least about 1000 MHz. In yet other examples, the laser pulse repetition rate is at most about 1000 MHz, at most about 750 MHz, at most about 500 MHz, at most about 400 MHz, at least about 300 MHz, at most about 200 MHz, at most about 175 MHz, at most about 150 MHz, at most about 125 MHz, at most about 100 MHz, at most about 90 MHz, at most about 85 MHz, 80 MHz, at most about 75 MHz, at most about 70 MHz, at most about 65 MHz, at most about 60 MHz, at most about 55 MHz, at most about 50 MHz, at most about 45 MHz, at most about 40 MHz, at most about 35 MHz, at most about 30 MHz, at most about 25 MHz, at most about 20 MHz, at most about 15 MHz, at most about 10 MHz, or at most about 5 MHz. In one example, the laser pulse repetition rate is about 8 MHz. The laser pulse repetition rate may fall within any range bounded by any of these values (e.g., from about 10% to about 90% of 80 MHz).

The systems and methods disclosed herein may be configured with different laser pulse durations for one or more trains of laser pulses, which may alternatively be specified in terms of the corresponding full width at half maximum (FWHM) for the one or more trains of laser pulses. In one example, the laser pulse durations are between 100 femtoseconds (fs) and 100 picoseconds (ps). In another example, the laser pulse durations are between 25 fs and 250 ps. In other examples, the laser pulse durations are at least about 25 fs, at least about 50 fs, at least about 75 fs, at least about 100 fs, at least about 200 fs, at least about 300 fs, at least about 400 fs, at least about 500 fs, at least about 600 fs, at least about 700 fs, at least about 800 fs, at least about 900 fs, at least about 1 picosecond (ps), at least about 5 ps, at least about 10 ps, at least about 20 ps, at least about 30 ps, at least about 40 ps, at least about 50 ps, at least about 60 ps, at least about 70 ps, at least about 80 ps, at least about 90 ps, at least about 100 ps, at least about 150 ps, at least about 200 ps, at least about 250 ps, or at least about 300 ps. In yet other examples, the laser pulse durations are at most about 300 ps, at most about 250 ps, at most about 200 ps, at most about 150 ps, at most about 100 ps, at most about 90 ps, at most about 80 ps, at most about 70 ps, at most about 60 ps, at most about 50 ps, at most about 40 ps, at most about 30 ps, at most about 20 ps, at most about 10 ps, at most about 5 ps, at most about 1 ps, at most about 900 fs, at most about 800 fs, at most about 700 fs, at most about 600 fs, at most about 500 fs, at most about 400 fs, at most about 300 fs, at most about 200 fs, at most about 100 fs, at most about 75 fs, at most about 50 fs, or at most about 25 fs. In one example, the laser pulse durations are between about 2 and 10 ps. In another example (e.g., using multi-photon excitation), the laser pulse duration is between about 400 fs and 500 fs. In some implementations (e.g., using multiplex CRS), a broadband laser pulse can be about 5 times shorter, about 4 times shorter, about 3 times shorter, or about 2 times shorter than a narrowband laser pulse to ensure approximately uniform sampling of all spectral components despite the temporal profile of the laser pulses. Laser pulse duration may fall within any range bounded by any of these values (e.g., from about 0.001% to about 90% of 100 ps).

The systems and methods disclosed herein may be configured to fiber laser systems having different laser duty factors. Use of lower laser duty factors may be advantageous in terms of achieving higher peak pulse powers. In one example, the system is configured to use laser duty factors between about 100 and 1,000,000. In other examples, the laser duty factor is at least about 100, at least about 500, at least about 750, at least about 1,000, at least about 1,500, at least about 1,900, at least about 2,000, at least about 2,100, at least about 5,000, at least about 10,000, at least about 25,000, at least about 50,000, at least about 75,000, at least about 80,000, at least about 85,000, at least about 100,000, at least about 250,000, at least about 500,000, at least about 750,000, or at least about 1,000,000. In yet other examples, the laser duty factor is at most about 1,000,000, at most about 750,000, at most about 500,000, at most about 250,000, at most about 100,000, at most about 85,000, at most about 80,000, at most about 75,000, at most about 50,000, at most about 25,000, at most about 10,000, at most about 5,000, at most about 2,100, at most about 2,000, at most about 1,900, at most about 1,500, at most about 1,000, at most about 750, at most about 500, or at most about 100. In one example, the laser duty factor is about 1,000. The laser duty factor may fall within any range bounded by any of these values (e.g., from about 120 to about 1,200).

The systems and methods disclosed herein may be configured with different average or maximum laser output powers for one or more trains of laser pulses delivered to the sample. Higher average and maximum laser output powers may be advantageous in terms of increasing sensitivity and signal-to-noise ratio of spectral measurements. In one example, average laser output powers are between about 10 mW and about 500 mW. In another example, average laser output powers are between about 10 mW and about 1 W. In other examples, average laser output powers are at least about 5 mW, at least about 10 mW, at least about 20 mW, at least about 30 mW, at least about 40 mW, at least about 50 mW, at least about 60 mW, at least about 70 mW, at least about 80 mW, at least about 90 mW, at least about 100 mW, at least about 110 mW, at least about 120 mW, at least about 130 mW, at least about 140 mW, at least about 150 mW, at least about 160 mW, at least about 170 mW, at least about 180 mW, at least about 190 mW, at least about 200 mW, at least about 225 mW, at least about 250 mW, at least about 275 mW, at least about 300 mW, at least about 350 mW, at least about 400 mW, at least about 450 mW, at least about 500 mW, at least about 600 mW, at least about 700 mW, at least about 800 mW, at least about 900 mW, at least about 1 W, or at least about 1.5 W. In yet other examples, the average laser power is at most about 1.5 W, at most about 1 W, at most about 900 mW, at most about 800 mW, at most about 700 mW, at most about 600 mW, at most about 500 mW, at most about 450 mW, at most about 400 mW, at most about 350 mW, at most about 300 mW, at most about 275 mW, at most about 250 mW, at most about 225 mW, at most about 200 mW, at most about 190 mW, at most about 180 mW, at most about 170 mW, at most about 160 mW, at most about 150 mW, at most about 140 mW, at most about 130 mW, at most about 120 mW, at most about 110 mW, at most about 100 mW, at most about 90 mW, at most about 80 mW, at most about 70 mW, at most about 60 mW, at most about 50 mW, at most about 40 mW, at most about 30 mW, at most about 20 mW, at most about 10 mW, or at most about 5 mW. In one example, average laser output powers delivered to the sample are between about 5 mW and about 200 mW. Average laser output power may fall within any range bounded by any of these values (e.g., from about 7 mW to about 175 mW).

The systems and methods disclosed herein may be configured with varying degrees of laser pulse synchronization or levels of timing jitter. More closely synchronized laser pulses may be advantageous in terms of achieving improved signal-to-noise ratios and faster data acquisition times in spectral measurements. In one example, laser pulse synchronization or timing jitter is between about 10 fs and 100 fs. In other examples, laser pulse synchronization or timing jitter is at most about 50 ps, at most about 40 ps, at most about 30 ps, at most about 20 ps, at most about 10 ps, at most about 1 ps, at most about 900 fs, at most about 800 fs, at most about 700 fs, at most about 600 fs, at most about 500 fs, at most about 400 fs, at most about 300 fs, at most about 200 fs, at most about 100 fs, at most about 90 fs, at most about 80 fs, at most about 70 fs, at most about 60 fs, at most about 50 fs, at most about 45 fs, at most about 40 fs, at most about 35 fs, at most about 30 fs, at most about 25 fs, at most about 20 fs, at most about 15 fs, or at most about 10 fs. In one example, laser synchronization is less than 40 fs. Laser synchronization or timing jitter may fall within any range bounded by any of these values (e.g., from about 25 fs to about 45 fs). In some examples, laser pulse synchronization or timing jitter is at most about 90%, 80%, 70%, 60%, 50%, 40%, 30%, 20%, 10%, or less of the pulse duration.

The systems and methods disclosed herein may be configured to use objective lenses having different values of numerical aperture (NA). Use of objective lenses of higher NA in some aspects may be advantageous in improving spatial resolution or reducing depth-of-field. Use of objective lenses of lower NA in some aspects may be advantageous in increasing the field-of-view. In one example, the system is configured to use objective lenses with NA values between about 0.05 and about 1.4. In other examples, the NA is at least about 0.05, at least about 0.1, at least about 0.2, at least about 0.3, at least about 0.4, at least about 0.5, at least about 0.6, at least about 0.7, at least about 0.8, at least about 0.9, at least about 1.0, at least about 1.1, at least about 1.2, at least about 1.3, or at least about 1.4. In yet other examples, the NA is at most about 1.4, at most about 1.3, at most about 1.2, at most about 1.1, at most about 1.0, at most about 0.9, at most about 0.8, at most about 0.7, at most about 0.6, at most about 0.5, at most about 0.4, at most about 0.3, at most about 0.2, at most about 0.1, or at most about 0.05. In one example, the objective lens NA is about 1.2. In another example, the objective lens NA is about 0.05, about 0.4, about 1.1, or about 1.4. The objective lens numerical aperture may fall within any range bounded by any of these values (e.g., from about 0.07 to about 1.35).

The systems and methods disclosed herein may be configured with various ranges of spectral detection, that is, the spectral range over which spectral data is collected. Broader spectral detection ranges may in some cases be advantageous in achieving better selectivity between spectra for different chemical species. In one example, the spectral detection range covers a span of between 100 cm⁻¹ and 3000 cm⁻¹. In other examples, the spectral detection range spans at least about 100 cm⁻¹, at least about 125 cm⁻¹, at least about 150 cm⁻¹, at least about 200 cm⁻¹, at least about 250 cm⁻¹, at least about 300 cm⁻¹, at least about 350 cm⁻¹, at least about 400 cm⁻¹, at least about 450 cm⁻¹, at least about 500 cm⁻¹, at least about 550 cm⁻¹, at least about 600 cm⁻¹, at least about 650 cm⁻¹, at least about 700 cm⁻¹, at least about 750 cm⁻¹, at least about 800 cm⁻¹, at least about 900 cm⁻¹, at least about 1000 cm⁻¹, at least about 1100 cm⁻¹, at least about 1200 cm⁻¹, at least about 1300 cm⁻¹, at least about 1400 cm⁻¹, at least about 1500 cm⁻¹, at least about 1750 cm⁻¹, at least about 2000 cm⁻¹, at least about 2250 cm⁻¹, at least about 2500 cm⁻¹, at least about 2750 cm⁻¹, or at least about 3000 cm⁻¹. In yet other examples, the spectral detection range spans at most about 3000 cm⁻¹, at most about 2750 cm⁻¹, at most about 2500 cm⁻¹, at most about 2250 cm⁻¹, at most about 2000 cm⁻¹, at most about 1750 cm⁻¹, at most about 1500 cm⁻¹, at most about 1400 cm⁻¹, at most about 1300 cm⁻¹, at most about 1200 cm⁻¹, at most about 1100 cm⁻¹, at most about 1000 cm⁻¹, at most about 900 cm⁻¹, at most about at 800 cm⁻¹, at most about 750 cm⁻¹, at most about 700 cm⁻¹, at most about 650 cm⁻¹, at most about 600 cm⁻¹, at most about 550 cm⁻¹, at most about cm⁻¹, at most about 450 cm⁻¹, at most about 400 cm⁻¹, at most about 350 cm⁻¹, at most about 300 cm⁻¹, at most about 250 cm⁻¹, at most about 200 cm⁻¹, or at most about 150 cm⁻¹. In one example, the spectral detection range spans about 250 cm⁻¹. The spectral detection range may fall anywhere within any range bounded by any of these values (e.g., from a range of about 200 cm⁻¹ to a range of about 760 cm⁻¹).

The systems and methods disclosed herein may be configured with various levels of spectral detection resolution. Narrower spectral detection resolution may be advantageous in achieving better selectivity between spectra for different chemical species. In one example, the spectral detection resolution is between 2.5 cm⁻¹ and 30 cm⁻¹. In other examples, the spectral detection resolution is at least about 2.5 cm⁻¹, 5 cm⁻¹, at least about 10 cm⁻¹, at least about 15 cm⁻¹, at least about 20 cm⁻¹, at least about 25 cm⁻¹, or at least about 30 cm⁻¹. In yet other examples, the spectral detection resolution is at most about 30 cm⁻¹, at most about 25 cm⁻¹, at most about 20 cm⁻¹, at most about 15 cm⁻¹, at most about 10 cm⁻¹, at most about 5 cm⁻¹, or at most about 2.5 cm⁻¹. In one example, the spectral detection resolution is about 10 cm⁻¹. The spectral detection resolution may fall anywhere within any range bounded by any of these values (e.g., from about 3 cm⁻¹ to about 18 cm⁻¹).

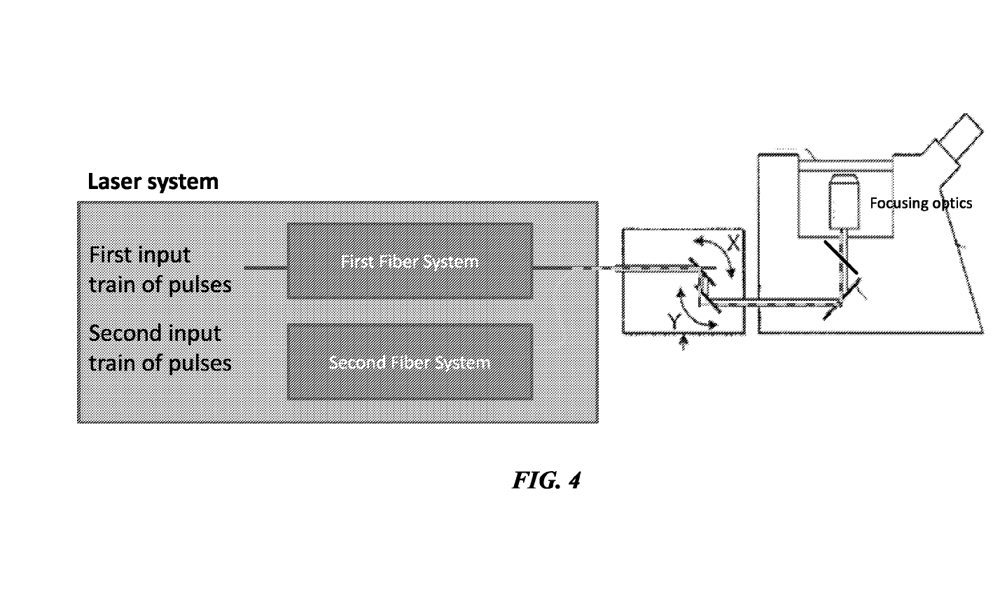

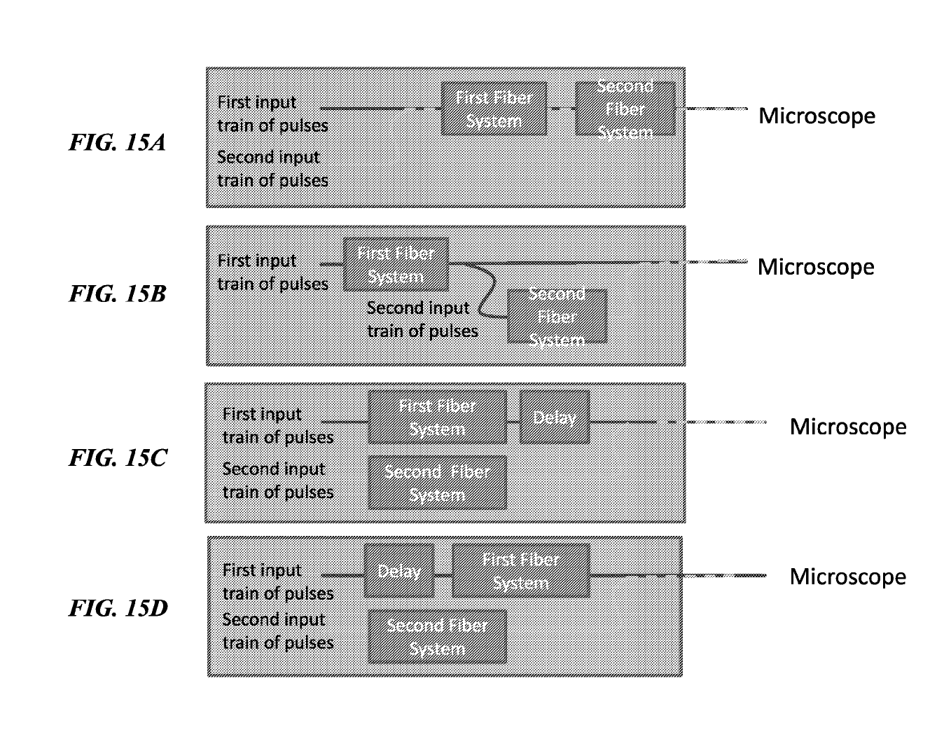

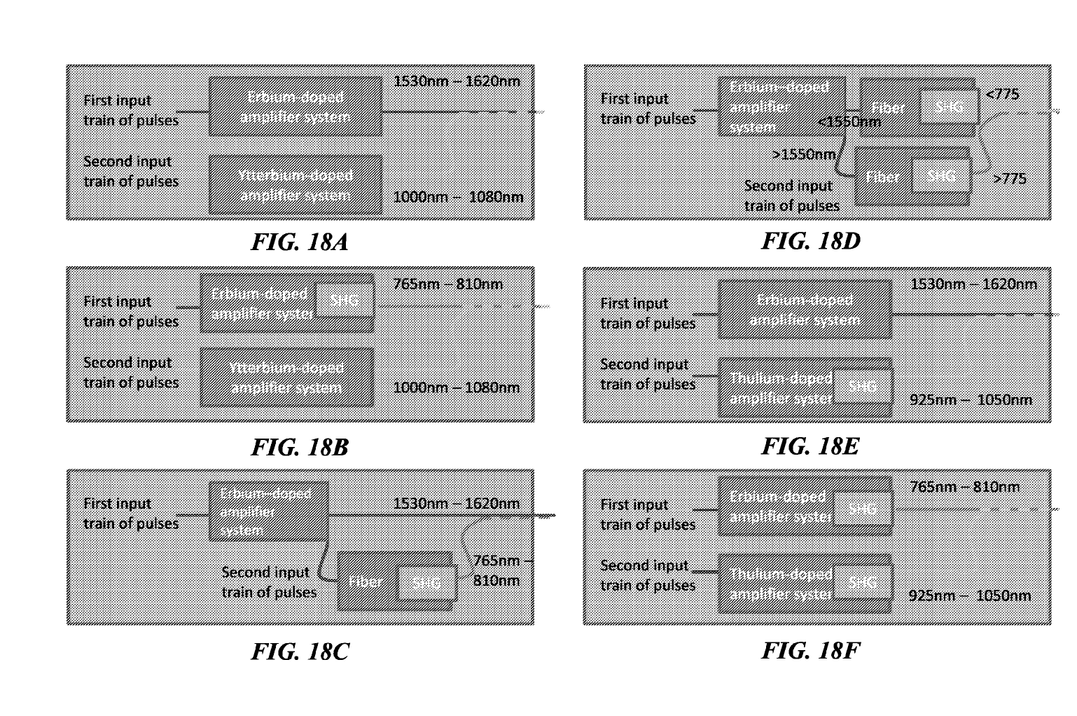

FIG. 4 schematically illustrates a fiber laser based multi-photon imaging system in which synchronized output pulse trains from a first fiber system and a second fiber system are focused into a common focal volume with focusing optics (e.g., in a microscope). In some examples, two, three or more output pulse trains can be synchronized. In some cases, the two, three or more output pulse trains can be further combined (e.g., to provide multi-photon excitation). The first fiber system can receive a first input train of pulses. The second fiber system can receive a second input train of pulses. In some examples (e.g., in FIG. 15A), each fiber system can receive one or more input trains of pulses. In some implementations, the multi-photon imaging system can be used for multi-wavelength excitation. In some examples, individual fiber systems can comprise fiber amplifier systems, harmonic generation units (e.g., a second harmonic generation (SHG) unit for frequency doubling), or combinations thereof implemented by internally combining such components or through combination of separate units. In some cases, any of the fiber systems on either arm of the laser system can be replaced by multiple fiber systems/harmonic generation units or augmented by one or more additional fiber systems/harmonic generation units (e.g., as shown in FIG. 18D). In some examples, the laser system can comprise dispersion management components (e.g., a chirped fiber Bragg grating (FBG), un-doped anomalous dispersion fiber, dispersion shifted photonic crystal fiber), large mode area (LMA) fibers, mode-field adapters (MFA), fixed or motorized filters, spectral calibration components, high speed tuning components, polarization maintaining fiber technology and/or other optical components.

The multi-photon methods herein can be performed with fiber laser sources. Fiber delivery can be used, for example, when the light-source is a fiber laser source, as it avoids misalignment compared to free-space delivery and has improved laser safety. In some cases, propagation of high peak power pulses in the fiber during fiber delivery can change the spectral fidelity of the input pulses or produce radiation that interferes with the measurement. For example, self-phase modulation (SPM) of the excitation pulses produces spectral degradation and associated noise, four-wave mixing (FWM) in the fiber can produce non-resonant signals, and cross-phase modulation (XPM) can cause polarization modulation of the excitation pulses. Large-mode area (LMA) fibers can be used to reduce the peak power and thus reduce SPM, XPM and FWM, but LMA fibers are bend-sensitive and are unable to adequately address the problem. To address this problem, the present disclosure provides implementations where low-power seed pulses are delivered to the microscope. Low-power seed pulses can be negligibly affected by these nonlinear effects. Sufficient power for sensitive, high-speed imaging can be provided by amplification, either as part of the delivery system or following the delivery system (e.g., elsewhere in the multi-photon imaging system, such as, for example, within the microscope).

Delivering high-power pulses to the laser system while avoiding degradation of the pulse properties due to nonlinear effects in the optical fibers such as self-phase modulation may be challenging. Generally, the nonlinear phase delay is defined as

$${Φ}_{NL} = \frac{2 π {n}_{2}}{A λ} \cdot \frac{E}{τ} \cdot \frac{L}{2} ,$$

where n₂ is the nonlinear refractive index, A is the model field area, λ is the wavelength, E is the pulse energy, τ is the pulse width and L is the length of the fiber system. In some cases, properties of a pulse may be considered to be preserved if Φ_{NL}<5. Typically, this limits the power of the light that can be delivered to an instrument. In some examples, the systems and methods herein can deliver imaging pulses having peak and/or average powers as described throughout the disclosure with a nonlinear phase delay of less than about 5, 4.5, 4, 3.5, 3, 2.5, 2, 1.5, 1, and the like. In an example, the power at an input of the fiber delivery system can be sufficiently low to generate a nonlinear phase delay Φ_{NL} smaller than 5 over the length of the delivery system. In some examples, the power of at an input of the fiber delivery system can be less than about 1 mW, 10 mW or 100 mW, and the power at an input of the beam-scanning system can be more than 1 mW, 10 mW or 100 mW, respectively.

In some examples, the present disclosure provides an imaging system having at least one seed laser system, a fiber delivery system and a beam-scanning system (also “beam-scanning unit” herein), in which at least one desired wavelength from the seed laser system has a lower power at an input of the fiber delivery system than is required at an input of the beam-scanning system. The beam-scanning unit can be provided as part of a microscope (also “microscope system” and “microscopy system” herein). In some examples, the imaging system can further include at least one fiber amplifier after the fiber delivery system for amplifying input pulses from the seed laser system. Furthermore, the imaging system can include at least one non-linear conversion medium after the fiber delivery system. The fiber delivery systems can include various fibers, such as a gain fiber.

In some examples, the systems can also include a pump source for an amplifier or a non-linear conversion system. In some cases, the pump source can be a component of the seed laser system, and the pump light can be co-propagated with the seed light in a common fiber delivery system. The pump source can be a component of the seed laser system, and the pump light and the seed laser light can have separate delivery fibers. The separate beams can be combined in an attachment to the imaging system (e.g., within the microscopy system) that is located after the fiber delivery system. In some cases, the imaging systems can include a pump source for an amplifier or a non-linear conversion system. In some cases, light from the pump source can be delivered in a second (e.g., separate) fiber delivery system.

In some examples, the imaging systems (e.g., the microscopy systems) can include a beam combining system for combining multiple wavelength laser systems within the beam-scanning system that is located after the fiber delivery system. The beam combining system can be configured such that the pulse trains are combined before the beams enter the delivery system and the combined pulse trains are amplified in a collinear amplifier geometry using two different gain materials. The amplification can occur in an attachment to the imaging system (e.g., within the microscopy system) located after the fiber delivery system.

For various multi-photon methods, the imaging systems can include a harmonic generation system (e.g., second harmonic generation, SHG) in the beam-scanning unit. The harmonic-generation system can be, for example, located after the fiber delivery system.

The imaging system can include a modulation component for modulating one of the beams for modulation transfer microscopy techniques. The modulation can be, for example, performed within the seed-laser system (e.g., before the amplifier system). The imaging system can also include optical balancing for noise suppression that is performed before the final amplifier.

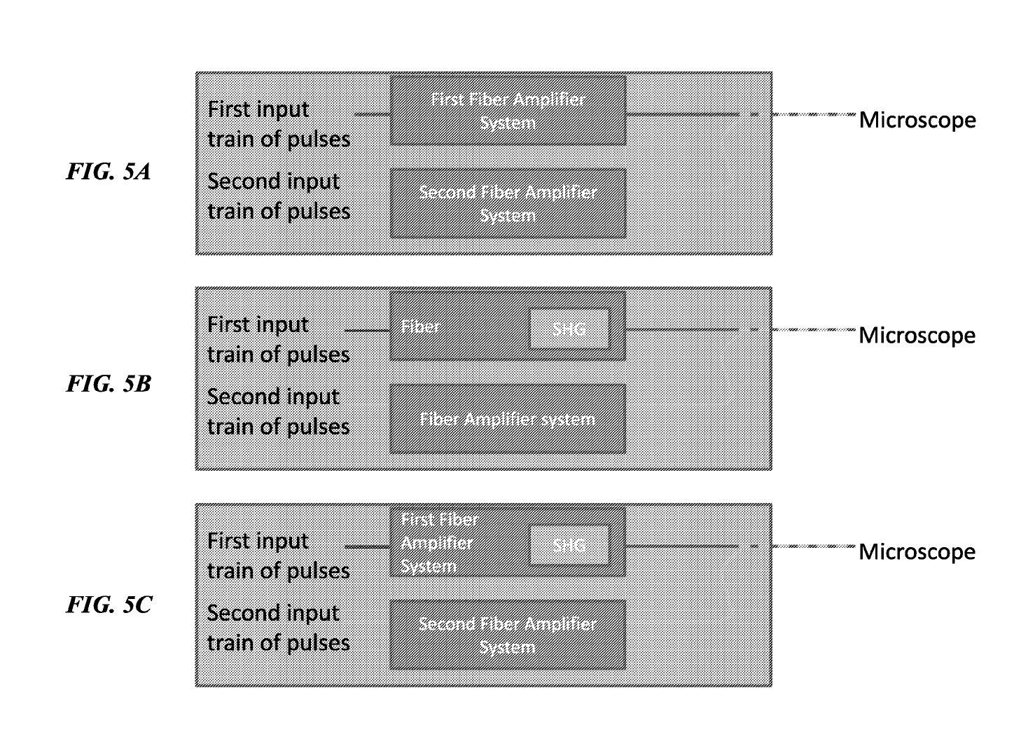

FIG. 5A is an example of a system with fiber amplifier systems. For instance, the system can have two fiber amplifier systems. Each fiber amplifier system can include a doped fiber gain medium that is optically pumped through a wavelength division multiplexer (WDM). Doping species can include erbium (Er), ytterbium (Yb), thulium (Tm), holmium (Ho), praseodymium (Pr), neodymium (Nd), and/or other rare-earth elements. In some cases, rare-earth doped fiber amplifiers may be used in conjunction with amplification technologies.

Co-pump, counter-pump, and/or double-pass geometries can be used. In some examples, one, two, three or more doped fiber gain media can be used. In some examples, mixed gain media can be used in a single fiber system (e.g., a thulium/holmium fiber amplifier can be used). In some cases, the fiber amplifier systems can be multi-stage amplification systems. Multi-stage amplification systems can include multiple gain fibers, filters, etc. In some examples, multi-stage amplification systems may improve pulse parameters. In some implementations, the fiber amplifiers may be part of fiber oscillator systems where the input pulse trains are from cavity feedback and the output pulse trains are coupled out with an output coupler.

With reference to FIG. 5B, in an alternative configuration, a first and/or a second fiber system can comprise a harmonic generation unit (e.g., a second harmonic generation (SHG) unit). For example, the first fiber system can comprise a harmonic generation unit, and the second fiber system can be a fiber amplifier system. The harmonic generation unit is used, for example, for frequency doubling at least a fraction of the spectrum of the input train of pulses. In some implementations, the harmonic generation unit can be a fiber-coupled waveguide. In other implementations, the fiber systems can include optics for coupling light from a fiber to a free-space crystal. The harmonic and/or the fundamental-frequency light can be coupled back into fiber or directed toward the focusing optics in free-space. For example, optical mirrors can be used for free-space delivery to the focusing optics in a microscope. In an example, periodically-poled lithium niobate (PPLN) crystals can provide high doubling conversion efficiencies.

In FIG. 5C, a first and/or a second fiber system can comprise a combination of a fiber amplifier system and a harmonic generation system. For instance, the system can include two fiber amplifier systems and a second harmonic generation (SHG) unit in one of the arms. As described elsewhere herein, systems/units having multiple functions may be implemented as a series of individual systems/units in some configurations. For example, the fiber amplifier system with the SHG unit can be implemented as a fiber amplifier system in series with an SHG unit, etc.

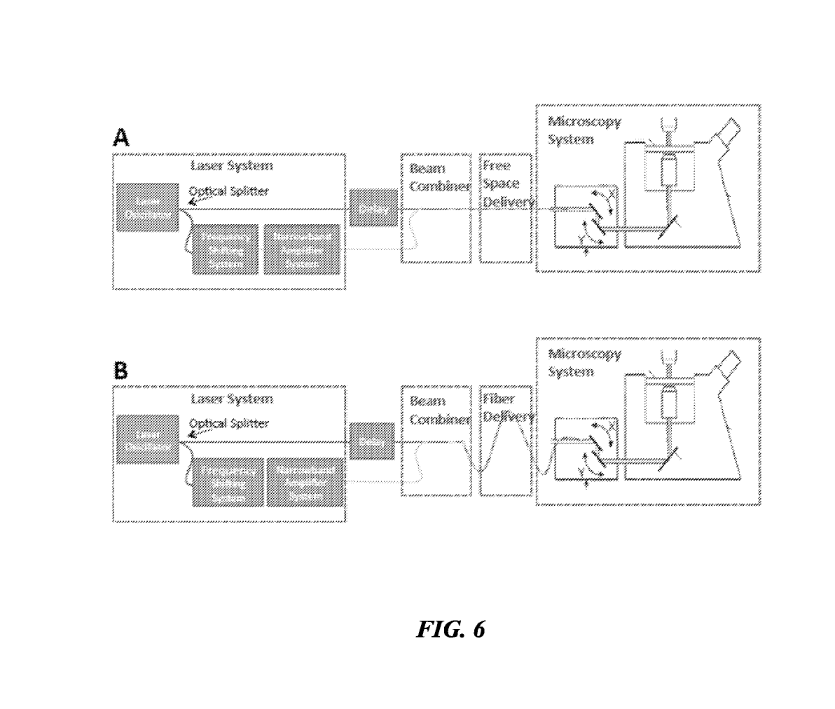

FIGS. 6A-6B are examples of systems comprising a laser system having an oscillator, an optical splitter, a frequency shifting system and a narrowband amplifier, a delay of the pulse trains with respect to one another, and a beam combiner. FIG. 6A schematically illustrates free space delivery to the scan unit of the imaging system (e.g., in the microscope) using, for example, optical mirrors. FIG. 6B schematically illustrates fiber delivery to the imaging system (e.g., to the microscope), which provides improved long-term stability and safety compared to the free-space delivery.

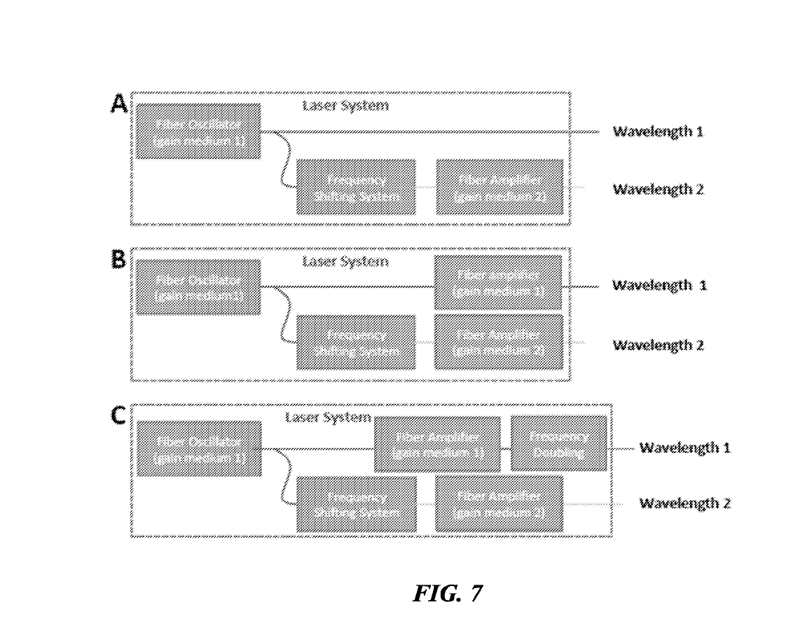

FIGS. 7A-7C provide examples of optically synchronized dual-wavelength laser sources. FIG. 7A schematically illustrates a fiber oscillator pulse train that is split, with a portion pumping a frequency shifting system, in which light is subsequently amplified. FIG. 7B schematically illustrates a fiber oscillator pulse train that is split, with a portion being amplified, and a portion pumping a frequency shifting system, in which light is subsequently amplified. FIG. 7C schematically illustrates an example in which the fiber oscillator pulse train is split, with a portion being amplified and then frequency doubled and a portion pumping a frequency shifting system. The light is subsequently amplified.

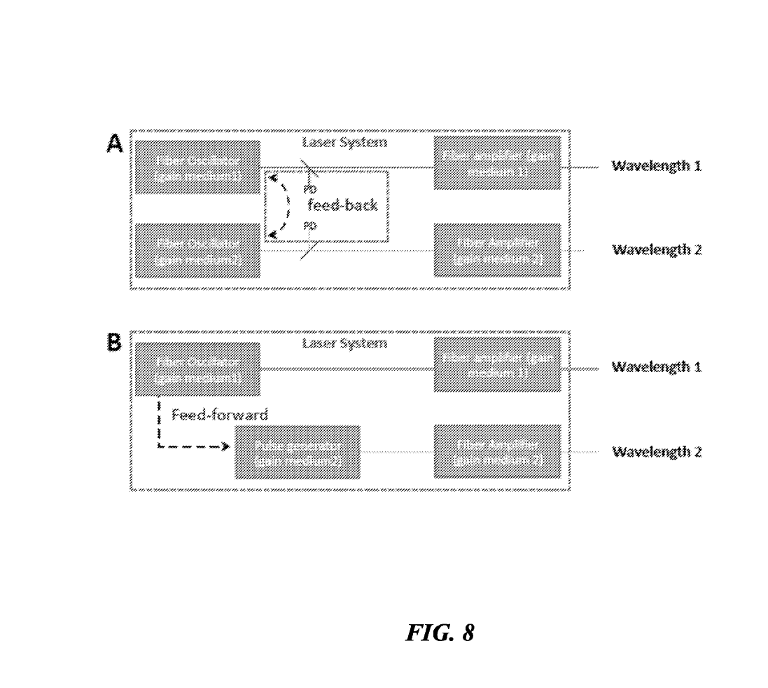

FIGS. 8A-8B provide examples of electronically synchronized dual-wavelength laser sources. As shown, FIG. 8A schematically illustrates a laser system including fiber oscillators, a feedback component, and separate fiber amplifiers to generate wavelengths 1 and 2. FIG. 8B schematically illustrates a system that includes a fiber oscillator coupled to one fiber amplifier and another fiber amplifier through a pulse generator to generate wavelengths 1 and 2, respectively.

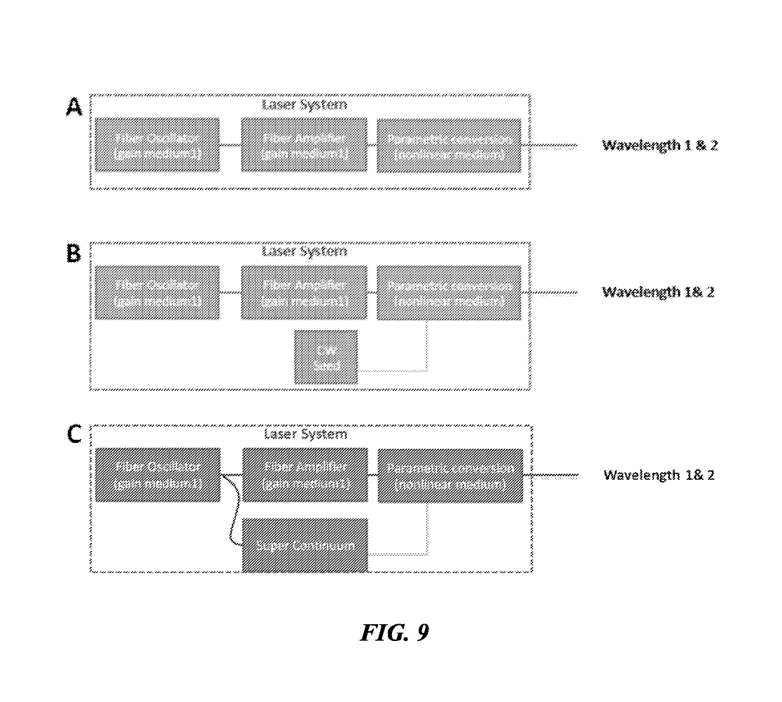

FIGS. 9A-9C schematically illustrate other configurations of parametric dual-wavelength laser sources, according to the present disclosure. For example, FIG. 9A provides a laser system including a fiber oscillator, a fiber amplifier, and a parametric conversion medium to produce wavelengths 1 and 2. FIG. 9B provides a laser system including a fiber oscillator, a fiber amplifier, and a parametric conversion medium coupled to a continuous wave seed laser to produce wavelengths 1 and 2. FIG. 9C provides a fiber oscillator coupled to a fiber amplifier and a supercontinuum component. The fiber amplifier and supercontinuum component can be coupled to a parametric conversion medium to produce wavelengths 1 and 2.

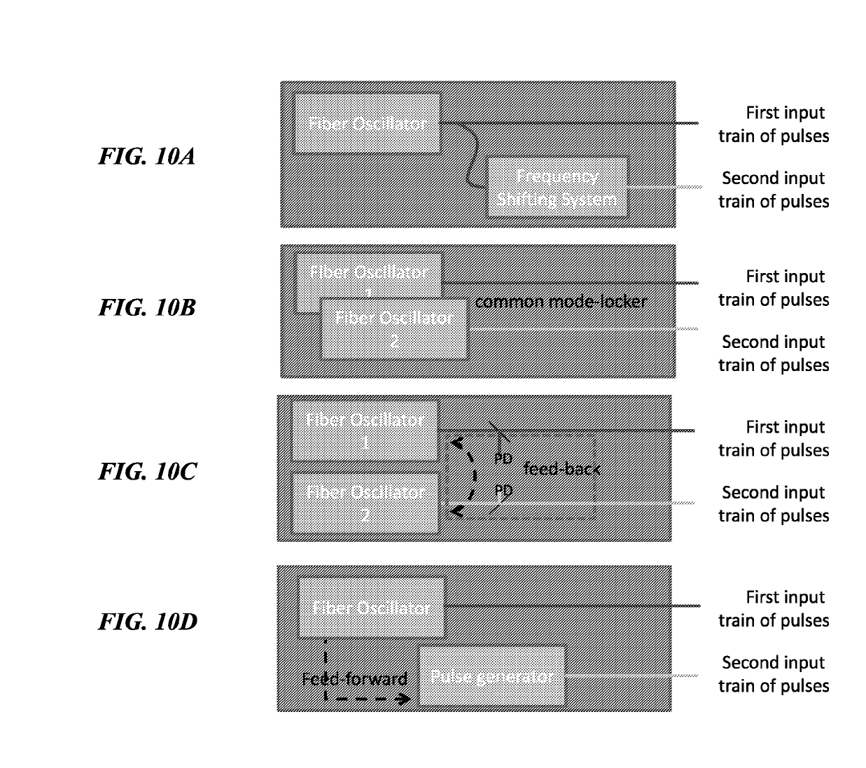

The first and second input pulse trains (also “seed” pulse trains herein) may originate from one or more separate pulse trains (e.g., pulse trains generated by one or more fiber oscillators and/or pulse generators). In some implementations, the temporally synchronized first and second input trains of pulses can be generated by splitting a pulse train, and the first and/or second fiber systems can include a step of wavelength conversion. In other implementations, the temporally synchronized first and second input trains can be generated by dividing a broadband pulse train by wavelength. Examples of means of generating the temporally synchronized first and second input trains are shown in FIGS. 10A-10D.

FIG. 10A schematically illustrates an example of providing a first and a second input train of pulses that are temporally synchronized by frequency shifting or by broadening an output of an oscillator. The first input train of pulses is generated from a fiber oscillator and the second input pulse train is generated by frequency broadening/shifting a portion of the first input pulse train to a new wavelength. Such frequency shifting can be achieved, for example, with a super-continuum (SC) unit including a photonic crystal fiber (PCF) or a highly nonlinear fiber (HNLF). In some cases, this configuration can provide stringent optical synchronization. In some cases, fixed or tunable filters can be used to select a specific wavelength with a specific bandwidth.

FIG. 10B schematically illustrates an example of providing a first and a second input train of pulses that are temporally synchronized by optical synchronization of two oscillators with a common mode-locker. The first and second input trains of pulses are generated from two fiber oscillators that share a common mode-locker to achieve the temporal synchronization. Examples of mode-lockers include semiconductor saturable absorbers (SESAMs) and saturable absorbers based on carbon nanotubes (CNT-SA), which can have a broad absorption wavelength range.

FIG. 10C schematically illustrates an example of providing a first and a second input train of pulses that are temporally synchronized by electrical synchronization of two oscillators via feedback. The first and second input trains of pulses are generated from two independent fiber oscillators and temporal synchronization is achieved via feedback (e.g., cavity length feedback). In some cases, this approach can eliminate the need for a delay stage as the delay can be compensated electronically. The first and second input trains of pulses can by monitored by one or more photo-diodes (PDs), the signal from which can provide input to the feedback electronics. In some cases, such electronic synchronization can be environmentally sensitive.

FIG. 10D schematically illustrates an example of providing a first and a second input train of pulses that are temporally synchronized by electronic synchronization of an oscillator and a pulse on-demand source. The first input train of pulses is generated from a fiber oscillator and the second input train of pulses is generated from a pulse on-demand laser source in response to an electrical signal derived from the first oscillator (also “feed-forward” herein). As an example, the second input train of pulses may be generated from a continuous-wave (CW) laser source by at least one high-speed modulator in response to a photodiode measuring the first pulse train. Such second laser can be a time-lens laser. In another example, first and second input trains of pulses are generated by on-demand laser sources in response to an electronic signal.

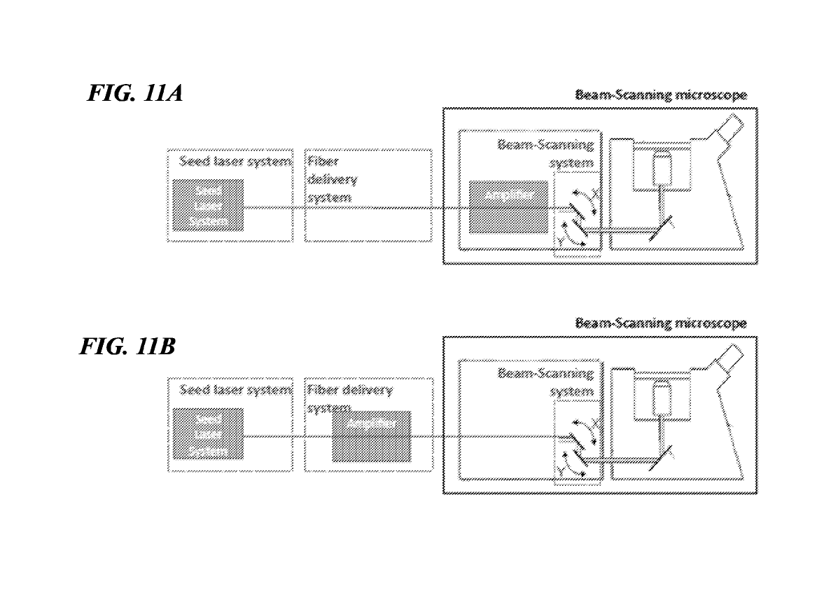

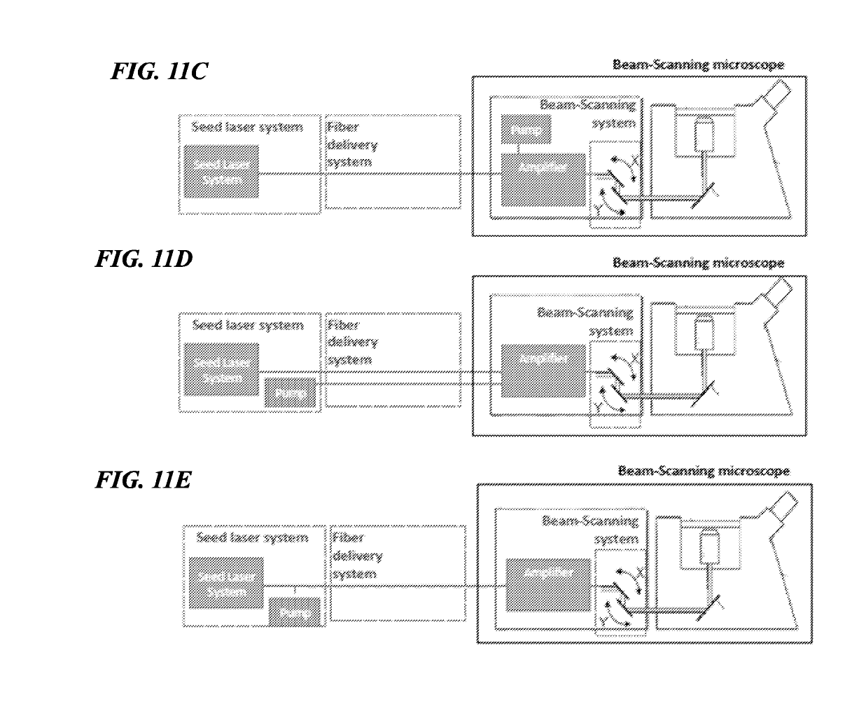

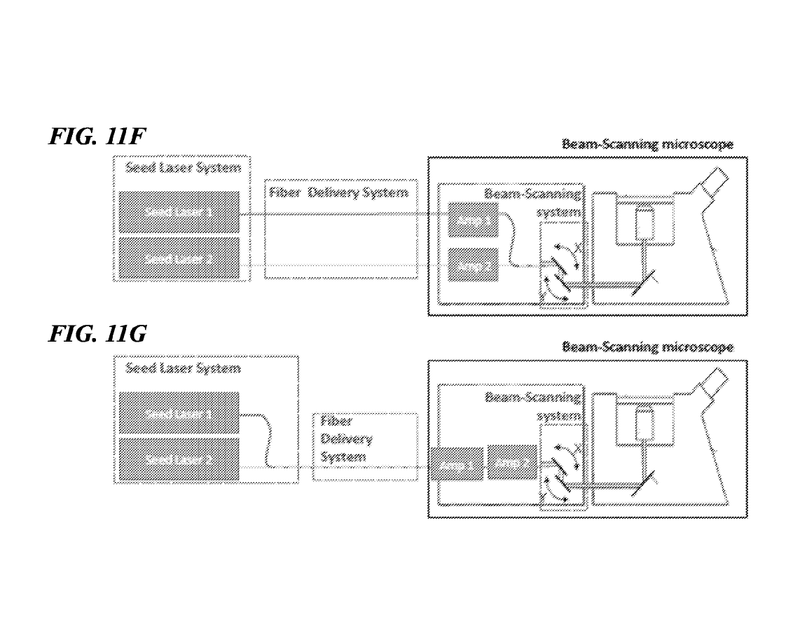

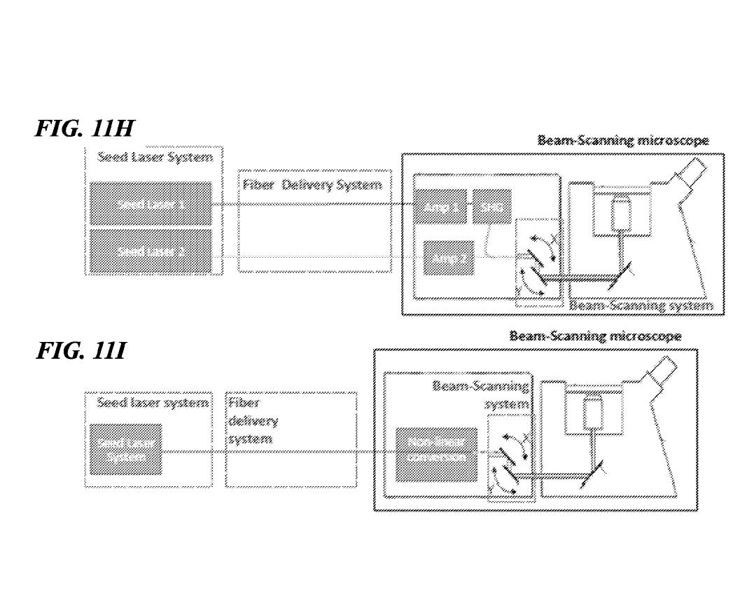

FIG. 11A schematically illustrates a seed laser system and an amplifier that are separated, with the amplifier following the fiber delivery system. FIG. 11B schematically illustrates a delivery system that includes a fiber amplifier system for increasing the optical power of the seed laser system. FIG. 11C schematically illustrates a seed laser system and an amplifier that are separated, with the amplifier and its pump laser in the imaging system. FIG. 11D schematically illustrates a seed laser system and an amplifier that are separated, with the amplifier in the imaging system (e.g., in the microscope), and the pump laser for the amplifier situated with the seed laser, the pump laser light being delivered to the amplifier with a fiber optic separate from the seed laser. FIG. 11E schematically illustrates a seed laser system and an amplifier that are separated, with the amplifier in the imaging system (e.g., in the microscope), and the pump laser for the amplifier situated with the seed laser, the pump laser light and seed laser light being delivered to the amplifier with a common fiber optic. FIG. 11F schematically illustrates a seed laser system having two synchronized lasers at two different wavelengths. The corresponding two amplifiers are separated, with the amplifiers following the fiber delivery system, and the pulse train from each seed laser separately delivered by a fiber optic to its corresponding amplifier. FIG. 11G schematically illustrates a seed laser system having two synchronized lasers at two different wavelengths, and the corresponding two amplifiers are separated, with the amplifiers after the fiber delivery system, and the pulse trains from the two seed lasers being combined and delivered by a common fiber optic to the amplifiers which are arranged in a co-linear geometry. FIG. 11H schematically illustrates a seed laser system having two synchronized lasers at two different wavelengths, and the corresponding two amplifiers are separated, with the amplifiers following the fiber delivery system. The pulse train from each seed laser can be separately delivered by a fiber optic to its corresponding amplifier, and the output of one of the amplifiers can be frequency doubled in a SHG unit situated after the delivery fibers. FIG. 11I schematically illustrates a seed laser system and a non-linear conversion unit that are separated, with the non-linear situated after the delivery fibers.

In some implementations, the fiber amplifier system may comprise at least (e.g., at a minimum) a section of doped gain fiber. In some cases, the fiber amplifier system does not comprise a source of pump light for pumping the section of gain fiber. In some cases, the fiber amplifier system does not comprise a means for combining the input (seed) and pump light, such as a wavelength division multiplexer (WDM) or pump-signal-combiner. In some cases, the fiber amplifier system does not comprise an optical isolator. In some cases, the fiber amplifier system does not comprise one or more of the source of pump light, the means for combining the input (seed) and pump light, and the optical isolator. The section of doped gain fiber can either be pumped though a core or through cladding of a double cladding fiber. The section of doped gain fiber can be pumped in a co-pumped, counter-pumped or bi-directional configuration. The fiber amplifier system may comprise multiple sections of the same or different types of doped gain fiber or un-doped fibers. In some cases, the fiber amplifier may comprise multiple stages, elements for wavelength filtering, polarization control, optical isolation, and/or change of propagation direction.

In some implementations, the multi-photon systems herein comprise at least one source of pump to optically pump the fiber amplifier system(s). In some cases, pump light can be coupled in the core of the same optical fiber of the fiber delivery system as seed light of the seed laser system. In some cases, pump light can be coupled in the inner cladding of the same optical fiber of the fiber delivery system as seed light of the seed laser system. The fiber amplifier system can be a cladding-pumped fiber amplifier system.

In some implementations, the systems can include an all-fiber laser system that can be used for, for example, CRS microscopy. The all-fiber laser system can be based on optical synchronization of, for example, erbium (Er) and ytterbium (Yb) fiber amplifiers. Because light is guided within the optical fiber, misalignment can be avoided or limited. System component(s) may be robust and low-priced (e.g., due to economy of scale of the telecommunications industry).

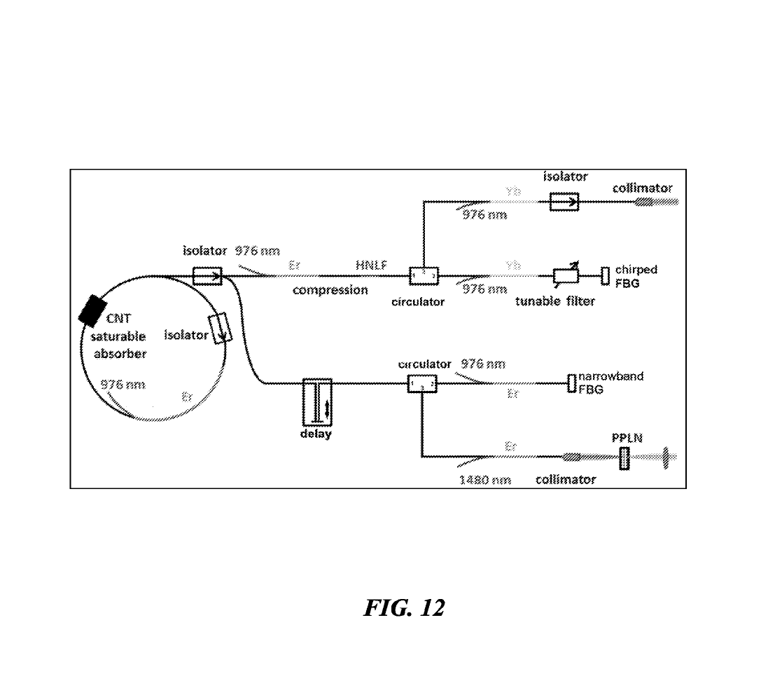

FIG. 12 shows a schematic of an example dual-wavelength all-fiber laser source for CRS. Output from an Er-doped fiber oscillator can be split into two arms to seed Er- and Yb-doped power amplifiers configured in a double-pass geometry. Optical synchronization can be provided by frequency shifting using super-continuum (SC) in a highly nonlinear fiber (HNLF). The Er-arm can be frequency doubled in a periodically polled lithium niobate (PPLN) crystal to provide a fixed frequency pump beam at 790 nm. A narrowband fiber Bragg grating (narrowband FBG) is used to limit the bandwidth of the pump beam. A tunable narrowband Stokes beam can be obtained from the Yb-arm with a motorized tunable in-line filter, where a chirped fiber Bragg grating (chirped FBG) can be used to compensate for dispersion.

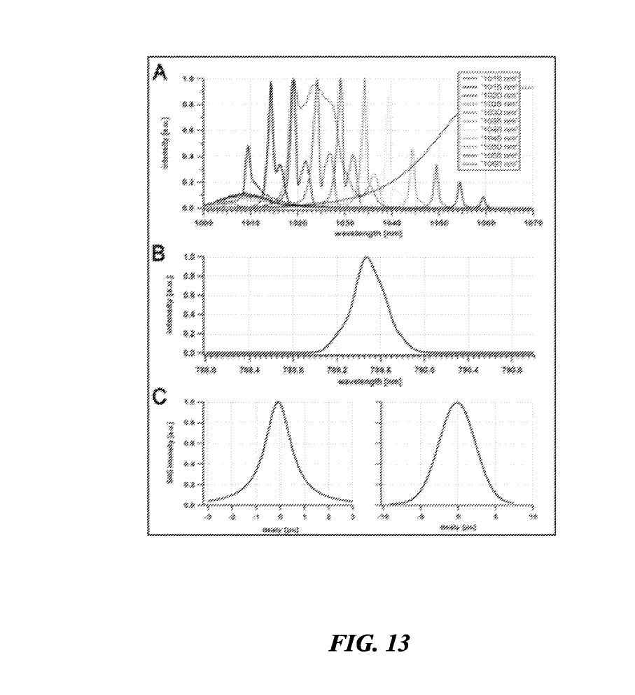

FIGS. 13A-13C provide characterizations of an example system provided herein. FIG. 13A shows a tuning range and spectral properties of the Stokes pulses. The tuning range is measured with an optical spectrum analyzer at various positions of the tunable filter. In a range from about 1010 nm to about 1065 nm, the drive current of the pump laser was tuned such that the amplified output was 100 mW. Overlaid are the Raman spectra of lipids (dashed black line) and water (solid black line) assuming a pump at 790 nm. FIG. 13B shows a spectrum of the frequency-doubled output at 77 mW. FIG. 13C shows auto-correlation of the 790 nm pump pulse and a 1035 nm Stokes pulse at 50 mW and 100 mW average power, respectively, for two different pre-amplifier geometries. Pulse durations were calculated by dividing the FWHM by root 2.

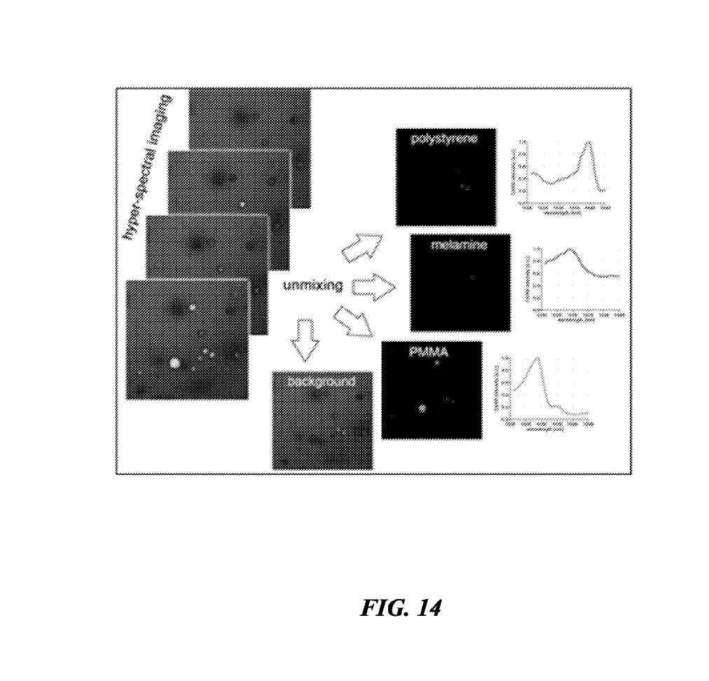

FIG. 14 shows example CARS spectroscopic imaging results acquired using multi-spectral CARS images of a test sample consisting of polystyrene, melamine, and polymethyl methacrylate (PMMA) beads embedded in agarose gel. The imaging results in FIG. 14 were acquired using the imaging system in FIG. 12. The images were acquired in 1 nm (˜10 cm⁻¹) steps from 1021 nm (2880 cm⁻¹) to 1045 nm (3100 cm⁻¹). Each individual image was acquired at 1 frame/s with 500×500 sampling. Intensity of the non-resonant background in agarose gel was normalized to be identical in each image frame, and spectral deconvolution by non-negative matrix factorization was applied to resolve different chemical species based on their distinct CARS spectra.

Further examples of system configurations are shown in FIGS. 14A-14D. In some implementations, input and/or output pulse trains may be combined. Further, a pulse train (e.g., an output pulse train) from one fiber system may be used as an input pulse train in another fiber system. One or more time delay units may be used on input and/or output pulse trains of one or more fiber systems.

FIG. 15A is an example of a system in which a first input train and a second input train of pulses can be combined. In this configuration, a first fiber system and a second fiber system are arranged sequentially rather than combining the first and second output train of pulses after the first and second fiber system.

In an example shown in FIG. 15B a second input pulse train can be split from inside a first fiber system or from a first output train of pulses (e.g., from the first fiber system). The second input pulse train can be received by a second fiber system. A second output pulse train can be provided by the second fiber system. The first and second output pulse trains can be combined (e.g., in a beam combiner). Combining can be achieved either in free-space (e.g., with a dichroic or polarization beam combiner) or with a fiber based device (e.g., a wavelength division multiplexer (WDM), which can be fused or filter based).

In some examples, the first and second input trains of pulses can be temporally synchronized such that the repetition rates of the first and second input trains of pulses are at a given (e.g., known) ratio and have a constant phase relationship. In one example, the first and second input trains of pulses have the same repetition rate and a fixed delay. In another example, the repetition rate of the first train is 2× or 1.5× that of the second train of pulses and the overall delay is fixed. In other examples, the ratios of the repetition rates of the first train and the second train are other ratios of integers. While the overall repetition rate may fluctuate due to phase noise (e.g., of a (fiber) oscillator), the first and second input pulse trains can remain synchronized and at a fixed delay with fluctuations that are shorter than the pulse duration.

In some implementations, the delay may be adjusted by a time delay unit for temporally overlapping the synchronized trains of pulses within the focal volume. The time delay unit can be, for example, a free-space or a fiber-coupled delay stage (e.g., motorized delay stage with a tuning precision of about 2.8 fs and maximum delay of about 350 ps), which adjusts the path length of one pulse train with respect to the other. The time delay unit can be placed, for example, within either arm of the system (e.g., in the arm comprising the first fiber system, in the arm comprising the second fiber system, or both) before (e.g., as shown in FIG. 15D) or after (e.g., as shown in FIG. 15C) the first/second fiber system. In some cases, slow drift of the fixed delay over time (e.g., due to thermal expansion of the two arms or spectral tuning in the presence of chromatic dispersion) can be compensated by feedback.

### Coherent Raman Scattering

In various implementations, microscope hardware and software can be configured and enabled for CRS imaging (e.g., microscopy). CRS microscopy allows label-free chemical imaging and enables applications in biology, material science and medicine. Despite imaging speeds that are orders of magnitude higher than conventional Raman, instrument cost and technical complexity have limited wide adoption of the technology.

To overcome current limitations, a CRS laser source based on fiber laser technology that has a greatly reduced cost compared to currently used solid-state systems can be used. Fiber lasers, which are more robust than free-space lasers, can be used successfully in CRS microscopy herein at an uncompromised signal-to-noise ratio compared to current solid-state systems.

As described herein, a fully integrated and easy to use CRS imaging system (e.g., FIG. 3) based on fiber laser sources of the present disclosure can be used. An integrated microscope or an upgrade unit to an existing microscope (e.g., to include the laser, beam-scanner, and/or detectors), or a hand-held scanner can be assembled. Such a hand-held scanner can utilize faster imaging to minimize motion blur and also may benefit from video-rate imaging. The integrated microscope (FIG. 3) can be created, in part, using commercial microscopes (e.g., Olympus). In some implementations, the microscope is designed as an upgrade unit to existing microscope stands (e.g., Olympus).

A fully integrated CRS system, such as a CRS microscope, based on a standard supplier microscope frame may be assembled. The fully integrated CRS system may include, for example, an all-PM version of the laser system, with improved spectral tuning capability. A laser-scanning unit based on galvo scan mirrors with fiber inputs and beam routing for frequency doubling, combining the laser outputs and beam sampling, may also be designed. In general, frequency multiplication/division, such as frequency doubling, can be achieved by harmonic generators, such as second harmonic generators, third harmonic generators, sum frequency generators, difference frequency generators, etc. Multi-modal CARS microcopy can be implemented through design of a two-channel non-descanned detection unit for epi CARS and other nonlinear signals (TPEF and/or SHG). A transmission SRS detector can be implemented as a second-generation technology. The scanning software can be based on, for example, an open-source microscopy platform (e.g., μ-Manager) and a simple-to-use graphical user interface (GUI) targeted to spectroscopic imaging as required by Raman customers may be built and fully integrated as a system. In one aspect, a fully integrated multi-modal CRS microscope based on a commercial microscope (e.g., an OEM Olympus microscope frame) can be constructed by combining the all-fiber laser source with a beam-routing/scanning unit. A laser scanning unit and the dual-channel epi detector module for back-scattered CARS and other multi-photon signals (e.g., TPEF and SHG or others) that can be detected simultaneously may be designed and built. The SRS transmission detector can be implemented as second generation technology.

In some examples, the integrated microscope can access the high-wavenumber region of Raman spectra (e.g., 2700-3200 cm⁻¹), which encompasses most of the validated applications. Another example of a microscope application includes upgrade options for other regions (e.g., deuterated bonds such as C-D, alkyne bands C≡C or fingerprint regions) based on the similar core fiber-laser technology but using other gain media.

In some implementations, two detection schemes can be utilized for CRS microscopy: CARS microscopy and SRS microscopy. SRS microscopy can provide improved sensitivity and spectroscopic specificity compared to the older CARS. In the integrated microscope example, a CARS system with added SRS capability can be constructed.

Specific imaging properties, such as numerical aperture (NA) and field of view (FOV), can be application specific. Different objective options, automation and other microscope features can be created with existing Raman microscope equipment (e.g., Olympus). Software can be based on an open-source platform (e.g., μ-Manager that currently supports most Olympus functions).

Multimodality can also be used to supplement image information from CRS label-free imaging with that of other imaging modalities, such as two-photon excited fluorescence (TPEF) and second harmonic generation (SHG), especially for biology research that routinely use TPEF. Simultaneous multi-color TPEF is also contemplated as an application with dual-wavelength sources.

In CRS, sensitivity and spectral resolution may critically depend on properties of the laser source. New sources can be integrated into a microscope, which builds on established technology (e.g., beam-scanning) and may include additional features (e.g., fast spectral tuning and SRS).

In contrast to spontaneous Raman scattering, with CRS the sample is excited with two laser beams, one of which can be tunable (e.g., to a precision of ˜0.1 nm) such that their difference frequency matches a targeted vibrational frequency Ω of the sample. Pulsed lasers with high peak power at moderate average power can be used to boost the nonlinear signal. A CRS light source can be made to provide two synchronized pulse trains with a timing jitter that can be lower than the pulse duration. An all-fiber dual-wavelength laser system can be used as described herein. The systems and methods described herein allow for imaging and characterization experiments to be performed on simple wooden tables in a room without tight temperature control, similar to conditions in a biology lab or hospital setting amongst other locations with space suitable to house necessary equipment. A dual-wavelength fiber laser system for CRS microscopy as shown in FIG. 12 can provide optical synchronization (rather than electrical synchronization which has high timing jitter) of two power amplifiers using a broadband super-continuum (SC).

The dual-wavelength fiber laser system for CRS microscopy can be engineered for precise tunability. To access the high-wavenumber region (e.g., 2800 cm⁻¹ to 3200 cm⁻¹) in this first-generation product, Erbium (Er)- and Ytterbium (Yb)-doped fiber amplifies can be synchronized. As most multi-photon microscope anti-reflection coatings are optimized in the Ti:Sapphire range (e.g., 750 nm-1000 nm), the Er-output can be frequency doubled at 1580 nm to produce a pump beam at 790 nm. Tunability of the Stokes beam from 1015 nm to 1055 nm with as little as 0.1 nm precision can be achieved by filtering the broadband SC before amplification with a precisely tunable filter. In one example, the autocorrelation widths can be 5.7 ps and 1.4 ps, which correspond to pulse durations of 4.0 ps and 1.0 ps, respectively. This is consistent with a 1.2 nm bandwidth of the Stokes pulses and corresponds to spectral resolution of 11 cm⁻¹, which is narrower than the typical Raman line width. Better matching of pump and Stokes pulse durations may be achieved with a different narrowband filter, which may further increase single-to-noise.

The dual-wavelength fiber laser system for CRS microscopy can be engineered for low timing jitter. The timing jitter can be less than 24 fs, using the intensity noise of the sum frequency signal at the half maximum of the optical cross-correlation. This jitter may be approximately 200× smaller than the FWHM of the cross-correlation (4.4 ps) and may be insignificant. Non-quantitatively, low timing jitter may be evident by the acquisition of the imaging data without intensity “striping” or long-term drift.

The dual-wavelength fiber laser system for CRS microscopy can be engineered to achieve high sensitivity for various species that can be detected. CRS narrowband amplifiers can be optimized to achieve pulse durations of 1-2 ps, a repetition rate of 50 MHz, and average powers of 50 mW and 100 mW for the pump and Stokes beams, respectively. According to the ANSI standard for medical devices, the maximum permissible exposure of skin is limited to 40 mW at 800 nm, independent of the specific pulse parameters: The microscope optics can have 30% throughput where 150 mW of average power can be sufficient. A laser can be created with 77 mW of 790 nm pump light and 145 mW of 1030 nm Stokes light. Additional appropriate power levels and wavelengths can be combined from respective values described throughout the specification.

High-speed chemical imaging can be achieved with the dual-wavelength fiber laser system for CRS microscopy. CRS imaging performance can be obtained with a device based on a simple board-mounted CARS microscope using galvo scanning mirrors controlled by a DAQ-card and LabVIEW scanning software. With this set-up, a signal-to-noise of 32 (data not shown here) for the imaging of a 0.75-micron polystyrene bead sample at an imaging speed of 1 frame/s with 500×500 sampling and 50 mW total in-focus power can be obtained. Use of the solid-state system (e.g., picoEmerald, APE Berlin) at the same average power for imaging can result in a lack of bead detection due to noise. Tripling the laser power to 110 mW of pump and 45 mW of Stokes in the laser focus may be performed to achieve similar quality images, which is consistent with the shorter pulse duration and lower repetition rate of the optimized light source. Such a setting can be especially suitable for a medical device.

Multi-spectral imaging of a four-component sample of polystyrene, PMMA and melamine beads embedded in agarose can be performed (FIG. 14). An xyλ image stack can be acquired by tuning the laser in steps of 1 nm per image frame from 1021 nm to 1045 nm. Chemometric methods such as non-negative matrix factorization can then be used to resolve individual chemical species based on the distinct CARS point-spectra (FIG. 14).

One possible limitation of the non-polarization maintaining (PM) implementation is long-term stability. Adjustment of the polarization state can be done every 30 min to maintain maximum signal. An all-PM system can be designed and built in accordance with various implementations described herein.

Reliable spectral tuning can be affected by time delay and polarization state changes at different wavelengths. This may be solved by a combination of a PM-design and dispersion management with a chirped fiber Bragg grating (FBG). Spectral imaging using the PM system can be achieved manually. The tunable filter can also be controlled from the DAQ card in synchronization with the imaging and may adjust the tuning speed to 10 kHz's for line-by-line spectral tuning, for example, to minimize spectral artifacts due to motion of in vivo samples.

At maximum power of, e.g., 100 mW (with 59 MHz repetition rate and 1 ps pulse duration) signs of spectral broadening due to self-phase modulation (SPM) may be observed for the Stokes pulses. Power amplifiers based on large-mode-area (LMA) gain fiber, which have 9× lower nonlinearities (30-micron vs. 10-micron core size) can be implemented as an offset strategy. The bandwidth of the filters and SHG crystal can be selected to match the pulse durations of pump and Stokes pulses.

A beam-routing/scanning unit for combination of the pump and Stokes beams in free-space is contemplated according to the various implementations herein. The system can be developed based on a PM-version of the tunable filter described above and may utilize additional improvements to increase tuning speed. Both CARS microscopy and SRS technology can be developed. Throughout the integration process (e.g., software & electronics), an example of the system can be based on off-the-shelf components and LabVIEW software to quickly explore the parameter space. In another example, a fully integrated version of the system is provided.

The all-PM version of the dual-wavelength laser system can be designed and fully characterized. FIG. 12 is an example schematic of a laser system of the present disclosure. In some cases (e.g., in PM versions), all components, including a PM core-aligning fusion splicer (e.g., Fujikura, FSM-100P) can be used. Variations of FIG. 12 are contemplated and include the use of double-pass geometry of the Yb-doped pre-amplifier, addition of a chirped fiber Bragg grating (FBG) to compensate for dispersion, and better matched filters to ensure the same pulse duration of pump and Stokes pulses.

In some implementations, the system is based on a mode-locked Er-doped fiber oscillator with a repetition rate of 50-MHz. For example, the system can be based on a PM-version of an OEM oscillator (e.g., Calmar Laser Inc., FPL-M2CFFPM). A robust oscillator can be built based on the CNT saturable absorber design. The output of the oscillator can be split into two arms, one arm feeding directly into the Er-doped pre- and power-amplifiers and being frequency doubled in a PPLN crystal to produce the narrowband 790 nm pump beam, the other arm being used to generate a broadband SC that extends to approximately 1000 nm and allowing optical synchronization of the Yb-doped amplifier to produce a tunable Stokes beam. The all-fiber implementation can include a stable SC that can be generated with only a few cm of HNLF. The pre-amplified input can be temporally compressed in un-doped anomalous dispersion fiber to produce high peak-power pulses. PM-HNLF (e.g., OFS, Inc.) can be purchased with the same parameters as the non-PM version.

The PM Er- and Yb-doped amplifiers can be designed and optimized for high spectral fidelity and minimal nonlinear broadening. The pulse conditioning can be performed in the low-power pre-amplifiers and increase the power only at the final amplification stage. The narrowband tunable filter and fixed-frequency FBG in the pre-amplifiers may determine the spectral resolution and tunability. Double-pass geometry can be implemented to increase the pre-amplified power to 10 mW (see above). This saturates the power-amplifiers but can be propagated from the laser to the microscope without SPM broadening. The power amplifiers can be incorporated in the beam-routing unit.

Different geometries for the power amplifiers can be implemented. In one aspect, single mode PM fibers and 1480 nm pumping of the Er-doped amplifier can be implemented using CRS spectroscopic imaging. In certain aspects, the spectral fidelity may be further increased by using large mode area (LMA) fibers, which reduces the power density and minimizes residual nonlinear pulse broadening. Use of different gain fibers e.g., PLMA-EYDF-25P/300-HE (e.g., Nufern) and e.g., YB1200-30/250DC-PM (e.g., Liekki) is contemplated herein. The mode-field diameters can be increased by 3× compared to Er80-8 and e.g., Yb2000-10/125DC (e.g., Liekki). The peak power density may consequently be decreased by about 9× and can result in much reduced SPM. PM mode-field adapters (MFA) can be used to connect the single-mode pre-amplifiers to the LMA power amplifiers, which have lower numerical aperture (NA). Third, cladding pumping can be explored as a means to scale the average power to Watt-level. While more average power may not be needed for bio-imaging, cladding pumping may be a less expensive implementation as a cheaper multi-mode pump laser can be used.

Options for beam routing can be developed and are discussed as part of the scanning unit section below. The time delay between pump and Stokes pulses can be adjusted as part of the laser system with a motorized fiber delay stage (e.g., OZ Optics, ODL-650), which can be spliced into the Er-arm before the power amplifier to reduce insertion loss and power handling requirements. The tuning precision can be 2.8 fs<<1 ps pulse duration. The maximum delay can be 350 ps, and the rough delay can be adjusted by splicing un-doped fiber in either of the two arms to a precision of a 5-10 cms, while monitoring the temporal overlap with a high-speed Si photodiode. The fine delay can be adjusted with the delay stage, while monitoring the cross-correlation.

Spectral tunability of the Stokes beam can be achieved with a motorized narrowband filter. To minimize risk, the system can be based on the PM version of the filter used as described above (e.g., Agiltron, FOTF). A driver that can be called from the scanning software and may allow automated frame-by-frame spectral imaging. Line-by-line spectral imaging may be achieved through high-speed tuning on the fly-back of the fast axis scan mirror, which can minimize spectral artifacts due to sample motion. This requires tuning speeds of >5 kHz, which may be available commercially (e.g., Micron Optics or LambdaQuest). Both polarization state and time delay are wavelength dependent due to dispersion. The all-PM design may eliminate polarization changes. To eliminate dispersion, the Yb-doped pre-amplifier in a double-pass geometry using a chirped fiber Bragg grating (FBG) may be used. A Faraday mirror can be used and allow to map out the exact dispersion of the design and specify a custom chirped FBG (e.g., O-ELand Inc.).

The laser system can be designed such that it can be fully controlled and monitored via software located at a computer system as described elsewhere herein. The laser system may provide independent control of the drive current of the CW pump lasers for each stage in the system (e.g., oscillator, SC unit, pre- and power amplifiers) and monitor the CW powers with internal photo-diodes (PD). The laser drive can be positioned on the main board and connected through a cable to the laser diode in the laser housing. Every stage can also have about a 5% pick-off at the input (e.g., by using integrated WDM-isolator-coupler components) that feeds into a fiber-coupled PD. The output of the PD can be split into DC and AC components to independently monitor the average and mode-locked intensities of the inputs, which can be used to warn the user of malfunctions. The temperature of the SHG can also be controlled.

The fiber laser system can be packaged to increase long-term stability. Fibers can be coiled and components fixed with clamps. All pulse conditioning can be performed at low power and the power amplifiers may be integrated in the beam-routing/scanning unit to avoid propagating the high-power output over long distances. The packaging can be designed to be modular and connected with SMA connectors of improve ease of service. For example, the prototype was milled from a single block of aluminum with dedicated areas to mount the CW pump laser and driver boards. Heating can affect stability, therefore the driver and laser system can be separated. After the laser is fully packaged and the laser is given some “burn-in”time, long-term stability testing can be performed over a period of 3 months. Stability can be recorded of the average power as well as the spectral calibration.

In some implementations, the present disclosure includes an all-PM dual-color CRS laser system with a fixed wavelength pump beam (˜790 nm) and tunable Stokes beam (1015 to 1050 nm) with a spectral bandwidth of <1.2 nm, timing jitter<100 fs, average power of 50 mW and 100 mW for pump and Stokes beams, 50 MHz repetition rate and matched, with nearly transform limited pulses. LMA fibers may further increase spectra fidelity. System monitoring, spectral calibration and time delay systems with 1 cm⁻¹ spectral and 10 fs temporal resolution as well as high speed tuning (10 kHz rate for a 5 nm step) and dispersion management (<100 fs time delay variation for a 35 nm tuning range) can be developed. Finally, the long-term stability of average power (>80% of the original power) and spectral calibration (5 cm⁻¹) of the packaged laser system over 3 months may be demonstrated. The system may or may not include high speed tuning as frame-by-frame spectral tuning is sufficient for most applications, dispersion management as the cross-correlation function can be used to develop a look-up-table prior to imaging. In addition, an alternative to a chirped FBG may be dispersion shifted photonic crystal fibers.

Beam combination to produce collinear pump and Stokes beams and beam sampling can be performed in the scanner unit. The combining of the pump and Stokes beams can be to use a wavelength division multiplexer (WDM), so that there can be a single fiber output from the laser system. There can be increased CRS signal generated in the combined fiber due to the long interaction length. While this is not a problem for CARS, as the anti-Stokes radiation from the fiber can be blocked with a 700 nm long pass filter at the fiber output, it can be problematic for SRS, as the signal is a polarization modulation that is detected with the lock-in detection scheme and is not easily blocked with a filter. Specially designed PCF fibers may be used as a solution. In certain aspects, the two beam can be delivered in separate fibers and combine them in free-space. The frequency doubling unit in the beam-routing/scanning unit can be included and which can remain in free space after its output (see, for example, FIG. 3). CRS may be performed with the un-doubled 1550 nm output, which can provide a simple path to an all-fiber CARS system. While 1550 nm imaging is not yet sufficiently validated, this can be considered when designing the beam-routing unit as it can be straightforward to remove the dichroic and doubling crystal from the dual beam design. The sampling arm for the GaAsP diode can also be included.

The beam-scanning unit can be designed to interface with the camera port of the Olympus microscope frame (see, e.g., FIG. 3). The tube lens can be part of the microscope frame and the position of the intermediary image plane with respect to the C-mount is provided by a microscope manufacturer as part of the OEM support (e.g., Olympus). Cameras can be placed in this plane. An IR coated achromatic flat-field scan lens may be selected to create a planar scanning field from the galvo scan mirrors (e.g., Cambridge Technology, Inc.). The scanning field can coincide with the intermediary image plane. The implementation may be based on closely spaced scan mirrors that are positioned such that the conjugate telecentric plane coincides with the center point of the two mirrors. Residual beam movement at the back-aperture of the objective can largely be negligible and this simple implementation is chosen by multiple vendors of beam-scanning microscopes.

In some implementations, the approximate dimensions of the optical train are chosen as follows: The focal length (FL) of the Olympus tube lens is 180 mm; the field of view (FOV) of the preferred CRS objective lens (e.g., Olympus, UPlanSApo 60XW) is 300 μm (i.e., the intermediary image plane has a dimension of 60×300 μm=18 mm); and the FL of the scan lens can determine the magnification of the beams size and may be chosen to be short to reduce the size of the scan mirrors and improve scan speed. The lower boundary of FL may be limited by beam-movement from the simplified scanning geometry (e.g., where approximately 60 mm is typical). In this geometry the optical scan angle α=±arctan (9 mm/60 mm)≈±8.5° (i.e., the mechanical scan angle β=α/2≈±4.3°)±4.3°. To fill the 7.2 mm back-aperture of the UPlanSApo 60XW lens, the input beam diameter 2.4 mm as determined by the fiber collimators (e.g., OZ Optics, HUCO). The tube lens and/or the CRS objective lens may be supplied with other FL and FOV values, for example, as determined according to a manufacturer's specifications. As most other objectives typically have larger back apertures, this geometry can underfill them resulting in reduced resolution. In this example, maximizing transmission and thus sensitivity for the 60× lens can be a design criterion.

Scan mirrors can be categorized as resonant or non-resonant. While resonant mirrors can be about 15× faster and can allow imaging speeds up to video rate (30 frames per second (fps)), their image quality can be compromised and high-speed data acquisition can be more challenging to implement. Given the signal to noise measured with the previously described system, video-rate imaging speeds may be supported, and may implement a system based on non-resonant scanners. For this, 4 mm scan mirrors (e.g., Cambridge Technology, 6210H) may be used and of note, the specifications predict an imaging speed of 1.3 s/frame with 512×512 sampling, unidirectional imaging and optimized cycloid waveforms. A fast-scanning feature based on bi-directional scanning with a sine waveform may also be implemented for the “Live” modus of the microscope software.

For spectral imaging, the fast axis may be scanned at 400 lines/s. The retrace time between 2 lines can be 20%, e.g., 0.5 ms. The data acquisition can be triggered accordingly. The sampling speed of the DAQ is 1 MS/s and may oversample the pixel dwell time (e.g., 80%·2.5 ms/512=4 μs for 512 pixels/line). The Stokes wavelength can be scanned on a line-by-line basis to reduce spectral artifacts due to motion. For example, one line can be scanned multiple times at different Raman shifts before the slow axis galvo is changed. This may require improving the tuning speed to greater than 1/0.·5 ms=2 kHz. The Raman shift between imaging frames may also be tuned as described above.

The detector unit for the epi CARS can be designed to fit a standard manufacturer frame based on the CAD models provided as part of the OEM support (e.g., Olympus). Non-descanned detectors can be implemented so as no confocal pinhole is required in nonlinear optical microscopy and may place the detectors in close proximity to the objective lens to optimize sensitivity. A 750 nm longpass dichroic (e.g., Chroma) can be used to separate the excitation from the emission beam. The housing may hold a 750 nm shortpass filter (e.g., Chroma) to block the residual excitation light. CARS signal (630-650 nm) can be separated from other nonlinear multimodal signals such as TPEF or SHG (400-600 nm) with a dichroic mirror and detected with two high-sensitivity photomultiplier tubes (PMT; e.g., Hamamatsu, H10723). Narrowband filters can be used to minimize cross-talk.

A transmission detector for SRS may be assembled. The transmitted pump and Stokes beams may be collected with a high-NA condenser and relayed onto a large area (1 cm×1 cm) PD using an additional lens in the detector unit. A 790 nm bandpass filter (e.g., Chroma) may be placed to block the modulated Stokes beam (see below). The unit may also include a 700 nm long-pass dichroic to reflect the visible light from the transmission lamp for bright field observation with the eye-pieces.

A beam-scanning system for the microscope frame (e.g., Olympus, BX53) that allows imaging at 1.3 s/frame with 512×512 sample and unidirectional scanning and includes elements for beam combining, frequency doubling and beam sampling can also be developed. In addition, a dual-channel non-descanned detector for epi CARS and other multimodal signals and a transmission detector for SRS can also be developed. System integration may require design of consolidated electronics to (1) control and monitor the laser and diagnostic instrumentation, (2) drive the beam-scanners and (3) read the detectors.

Various degrees of device integration may be possible. While fully custom electronics based on DSPs or FPGAs can provide much reduced cost of goods, for the first 10-20 systems it can be more advantageous to choose a more flexible architecture based on an off-the-shelf DAQ card. In another example of the example, the core of the instrument can be an OEM card (e.g., USB-6356-OEM, National Instruments) and AdvancedMEMS can provide a daughter board that interfaces directly through the generic 34- and 50-pin connectors. The DAQ can provide eight 16-bit analog input (AI) channels with 1.25 MS/s/ch simultaneous sampling to read the various detector channels, two 16-bit 3.33 MS/s analog outputs (AO) to drive the galvo scan mirrors, as well as 24 digital I/O lines (of which 8 are hardware-timed up to 1 MHz) for the communication with the daughter board. The daughter board can be designed and fully tested by AdvancedMEMS.

The system may include the following functionalities; digital control of the drive currents for the pump lasers with 1 mA precision and is 1.5 Å maximum (e.g., Wavelength Electronics, WLD3343-2L), digital readout of the power pump laser power from the integrated PDs, temperature feedback with digitally adjustable set point e.g., Wavelength Electronics, WHY5640) and the pump lasers are soldered on a separate circuit board inside the laser modules and will be connected to the drivers with cables. Further, digital readout of the PD at the input of each laser module (see above) for monitoring operation and advanced functions (see above). PD may be mounted on the same circuit board as the pump lasers. Each PD output may be split into AC and DC components with a bias-T (e.g., Minicircuits). The AC signals represent the mode-locked powers and may be measured with RF-power detectors (e.g., Texas Instruments). An option for synchronizing the laser repetition rate with the DAQ clock may be provided. Digital control of the laser parameters may include; (1) Stepper motor driver for the delay stage (e.g., OZ Optics, ODL-650); (2) Driver for the electro-optic modulator that may be derived from the 10 MHz DAQ clock and may provide digitally adjustable offset and amplitude (see above). If the DAQ clock is synchronized to the laser repetition rate, the modulation rate can automatically be synchronized to the laser as well; (3) Driver for the tunable filter optimized for a tuning speed up to 10 kHz; (4) Temperature controller for the oven for the PPLN crystal (e.g., Covesion). Digital read-out of the GaAsP diode for measuring the cross-correlation signals, feedthroughs for the AOs of the DAQ to the galvo mirror driver (e.g., CamTech, MicroMax 67300), digital control of the PMT and lock-in amplifier gain (see above); feedthroughs for the signal to the AIs of the DAQ may also be included.

A fully integrated supply, control and monitoring electronics for the laser and microscope system may be built. Software which creates a user friendly user interface can further improve an integrated microscope, as it can contain integrated spectral imaging capability, with the addition of chemometric analysis routines.

In order to provide flexibility for additional hardware options that may be required, the imaging software may be based on an open source microscopy platform (e.g., μ-Manager), although other types of software or software developers may be used to create the user interface. μ-Manager is a complete image acquisition and microscope control package, with built-in functionality for use in life science laboratories. It is also a software framework for implementing advanced and novel imaging procedures, extending functionality, customization and rapid development of specialized imaging applications. For example, μ-Manager can be structured in three independent layers: the graphical user interface (GUI), core services (e.g., MMCore) and device adapters. The foundation of the software may be the MMCore, which exposes a generalized command set of the automated microscope that can be accessed from many different programming environments and allows controlling and synchronizing various devices using plug-in adapter modules. As part of the software development, the device adapter for our instrument control electronics can be developed (see above) and an easy-to-use GUI including a spectral library and integrated chemometric analysis methods.

The software may be designed to support a variety of (1) scan modes (such as line-scanning (X), two- and three-dimensional imaging (XYZ), spectral imaging (XYλZ or XλYZ) and time-lapsed imaging XYλZt), (2) visualization features (such as look-up-tables and multi-dimensional image viewing), (3) analysis features (such as a spectral database to which newly acquired point spectra can be added, linear spectral unmixing, spectral fitting, phasor plotting, line profile and histogram analysis), (4) instrumentation calibration procedures (such as monitoring instrument function, optimizing modulation and temporal overlap, and maintaining spectral calibration).

An intuitive GUI for CRS spectral imaging based on the open source microscopy platform μ-Manager can be developed. This software can build on the established functionally of the MMCore of μ-Manager, which provides the fastest, most flexible and lowest risk approach to microscopy software. Device adaptors for major manufactured microscopes (e.g., Olympus), scanning mirrors and DAQ cards (e.g., National Instrument) already exist and can be used.

In some implementations, the systems and methods herein can include recording simultaneous recording one or more signals generated using the multi-photon methods herein. For example, CARS and SRS signals can be recorded simultaneously. CARS emission at the anti-Stokes wavelength may be separated from excitation beams in the system using, for example, a dichroic mirror. The system can include separate electronics and detectors for the CARS emission. SRS emission can be detected using, for example, different electronics and detectors in the system. In other implementations, only one signal generated using the multi-photon methods herein (e.g., CARS, SRS or RIKE) is detected.

In some implementations, the pump laser pulse can be narrowband while the probe or Stokes laser pulse is broadband, while in other implementations, the pump laser pulse can be broadband and the probe or Stokes laser pulse can be narrowband.

The systems and methods disclosed herein may be configured with different narrowband laser pulse wavelengths (e.g., which, in combination with the wavelength and bandwidth of the broadband laser pulse wavelength, determines the Raman coverage achieved). In one example, the narrowband laser pulse wavelength is between 1000 nm and 1500 nm. In other examples, the narrowband laser pulse wavelength is at least about 1000 nm, at least about 1100 nm, at least about 1200 nm, at least about 1300 nm, at least about 1400 nm, or at least about 1500 nm. In yet other examples, the narrowband laser pulse wavelength is at most about 1500 nm, at most about 1400 nm, at most about 1300 nm, at most about 1200 nm, at most about 1100 nm, or at most about 1000 nm. In one example, the narrowband laser pulse wavelength is between 1010 nm and 1080 nm. In yet another example, the narrowband laser pulse wavelength is about 1062 nm. The narrowband laser pulse wavelength may fall within any range bounded by any of these values (e.g., from about 1010 nm to about 1100 nm).

The systems and methods disclosed herein may be configured with different broadband laser pulse wavelengths (e.g., which, in combination with the bandwidth of the broadband laser pulse and the wavelength of the narrowband laser pulse, determines the Raman coverage achieved). In one example, the broadband laser pulse wavelength is between 750 nm and 1700 nm. In other examples, the broadband laser pulse wavelength is at least about 750, at least about 800 nm, at least about 900 nm, at least about 1000 nm, at least about 1100 nm, at least about 1200 nm, at least about 1300 nm, at least about 1400 nm, at least about 1500 nm, at least about 1600 nm, or at least about 1700 nm. In yet other examples, the broadband laser pulse wavelength is at most about 1700 nm, at most about 1600 nm, at most about 1500 nm, at most about 1400 nm, at most about 1300 nm, at most about 1200 nm, at most about 1100 nm, or at most about 1000 nm. In one example, the Stokes (probe) laser pulse wavelength is between 1520 nm and 1590 nm. In yet another example, the broadband laser pulse wavelength is about 1557 nm. The broadband laser pulse wavelength may fall within any range bounded by any of these values (e.g., from about 1550 nm to about 1560 nm).

The systems and methods disclosed herein may be configured with different narrowband laser pulse bandwidths (e.g., which, in combination with the broadband laser pulse wavelength and broadband laser pulse wavelength, determines the Raman coverage achieved). In one example, the narrowband laser pulse bandwidth is between 0.2 nm and 5 nm. In other examples, the narrowband laser pulse bandwidth is at least about 0.2 nm, at least about 0.3 nm, at least about 0.4 nm, at least about 0.5 nm, at least about 1 nm, at least about 2 nm, at least about 3 nm, at least about 4 nm, or at least about 5 nm. In yet other examples, the narrowband laser pulse bandwidth is at most about 5 nm, at most about 4 nm, at most about 3 nm, at most about 2 nm, at most about 1 nm, at most about 0.5 nm, at most about 0.4 nm, at most about 0.3 nm, or at most about 0.2 nm. In one example, the narrowband laser pulse bandwidth is between 0.3 nm and 0.8 nm. In yet another example, the broadband laser pulse bandwidth is about 0.5 nm. The narrowband laser pulse bandwidth may fall within any range bounded by any of these values (e.g., from about 0.25 nm to about 0.75 nm).

The systems and methods disclosed herein may be configured with different broadband laser pulse bandwidths (e.g., which, in combination with the broadband laser pulse wavelength and narrowband laser pulse wavelength, determines the Raman coverage achieved). In one example, the broadband laser pulse bandwidth is between 10 nm and 200 nm. In other examples, the broadband laser pulse bandwidth is at least about 10 nm, at least about 20 nm, at least about 30 nm, at least about 40 nm, at least about 50 nm, at least about 60 nm, at least about 70 nm, at least about 80 nm, at least about 90 nm, at least about 100 nm, at least about 110 nm, at least about 120 nm, at least about 130 nm, at least about 140 nm, at least about 150 nm, at least about 160 nm, at least about 170 nm, at least about 180 nm, at least about 190 nm, or at least about 200 nm. In yet other examples, the broadband laser pulse bandwidth is at most about 200 nm, at most about 190 nm, at most about 180 nm, at most about 170 nm, at most about 160 nm, at most about 150 nm, at most about 140 nm, at most about 130 nm, at most about 120 nm, at most about 110 nm, at most about 100, at most about 90 nm, at most about 80 nm, at most about 70 nm, at most about 60 nm, at most about 50 nm, at most about 40 nm, at most about 30 nm, at most about 20 nm, or at most about 10 nm. In one example, the broadband laser pulse bandwidth is between 50 nm and 80 nm. In yet another example, the broadband laser pulse bandwidth is about 60 nm. The broadband laser pulse bandwidth may fall within any range bounded by any of these values (e.g., from about 55 nm to about 65 nm).

### Multi-Photon Excitation

The fiber laser based multi-photon imaging systems of the disclosure can be readily applied to systems with different gain media (e.g., synchronized rare-earth doped fiber amplifiers). In an example, the first and/or second fiber systems are fiber amplifier systems comprising at least one of three commonly used dopants: erbium, ytterbium and thulium. The system can be used, for example, for two-photon excitation of a molecular species with a two-photon excitation wavelength range. Molecular species having a two-photon excitation range that overlaps with an effective two-photon excitation in accordance with various implementations described herein may be excited effectively.

For example, a laser system that outputs beams at multiple discrete wavelengths and comprises two or more fiber systems can be used. The beams can comprise synchronized (e.g., temporally synchronized) pulse trains. Individual pulse trains can have wavelengths in a range from, for example, about 500 nm to about 2100 nm. The beams can be provided to a microscope operatively coupled to the laser system. The laser system and the microscope can be provided as part of an imaging system of the disclosure. The beams can excite one or more excitable species (e.g., molecular species) within a wavelength range. The wavelength range can be, for example, between about 500 nm and about 2100 nm.

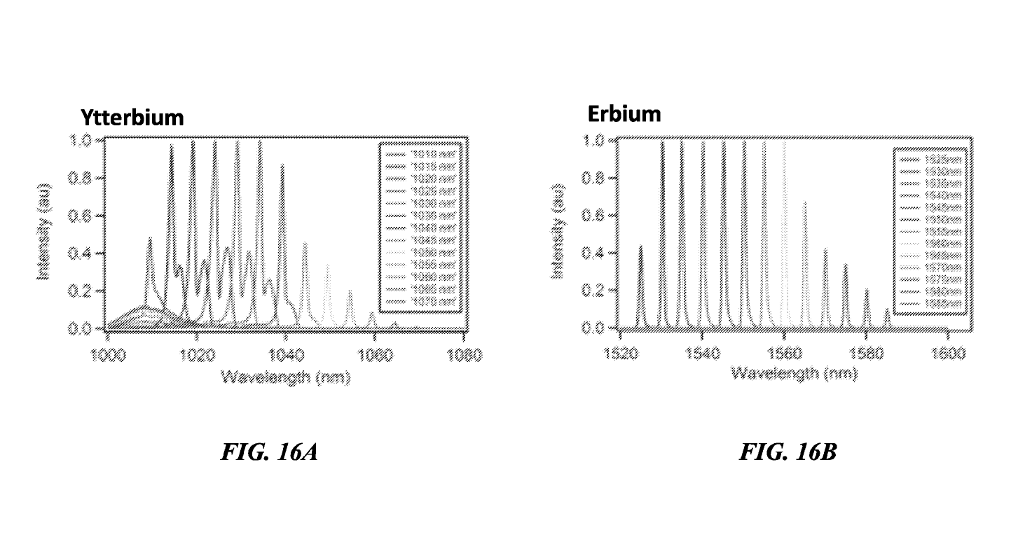

FIG. 16A is an example of a tuning range of fiber gain medium ytterbium of about 1000-1080 nm. FIG. 16B is an example of a tuning range of fiber gain medium erbium of about 1530-1620 nm. In another example, a tuning range for fiber gain medium thulium (not shown) is about 1850-2100 nm. Wavelength ranges for gain media herein are given as examples and may be extended beyond traditional or typical ranges, e.g., by using specialty fibers or by nonlinear amplification accompanied by spectral broadening. In some cases, the tuning range of one or more of the fiber gain media herein can be extended using soliton self-frequency shift (SSFS). For example, the tuning range of erbium can be extended to about 1500-2000 nm. In some cases, the tuning range of one or more transformed (e.g., frequency-doubled) gain media herein can be extended using soliton self-frequency shift (SSFS). For example, the tuning range of the frequency-doubled erbium can be extended to about 750-1000 nm. SSFS can be implemented, for example, within fiber amplifier systems, or elsewhere within the fiber systems or laser systems herein.

FIG. 17A shows examples of fluorescent molecules that can be excited with a synchronized erbium and ytterbium system based on typical tuning ranges of common fiber gain media. Examples of ranges achievable using the systems and methods herein are shown as ranges R1, R2, R3, R4 and R5.

FIG. 17B shows examples of fluorescent molecules that can be excited with a synchronized erbium and thulium system based on typical tuning ranges of common fiber gain media. Examples of ranges achievable using the systems and methods herein are shown as ranges R3, R4, R6, R7 and R8.

FIG. 18A is an example of a system that includes erbium- and ytterbium-doped fiber amplifier systems. The first fiber system can be an erbium-doped fiber amplifier system and the second fiber system can be an ytterbium-doped fiber amplifier system. Given the typical gain bandwidth of erbium- and ytterbium-doped gain fibers, respectively, a first output train of pulses λ₁ can be at a wavelength (e.g., a center wavelength) from about 1530 nm to about 1620 nm (e g, tuning range in FIG. 16B) or from about 1500 nm to about 2000 nm, and a second output train of pulses λ₂ at a wavelength (e.g., a center wavelength) from about 1000 nm to about 1080 nm (e.g., tuning range in FIG. 16A). This system can enable two-color two-photon excitation with an effective two-photon excitation wavelength λ_{eff}=2/(1/λ₁+1/λ₂) in the range from about 1209 nm to about 1296 nm indicated by R1 in FIG. 17A, or in the range from about 1200 nm to about 1403 nm.

FIG. 18B is another example of a system that includes erbium- and ytterbium-doped fiber amplifier systems. The first fiber system is a frequency-doubled erbium-doped fiber amplifier system and the second fiber system is an ytterbium-doped fiber amplifier system. Given the typical gain bandwidth of erbium- and ytterbium-doped gain fibers, respectively, a first output train of pulses λ₁ can be at a wavelength (e.g., a center wavelength) from about 765 nm to about 810 nm (e.g., frequency doubled tuning range in FIG. 16B) or from about 750 nm to about 1000 nm, and a second output train of pulses λ₂ can be at a wavelength (e.g., a center wavelength) from about 1000 nm to about 1080 nm (e.g., tuning range in FIG. 16A). This system can enable two-color two-photon excitation with an effective two-photon excitation wavelength λ_{eff}=2/(1/λ₁+1/λ₂) in the range from about 867 nm to about 926 nm indicated by R2 in FIG. 17A, or in the range from about 857 nm to about 1038 nm.

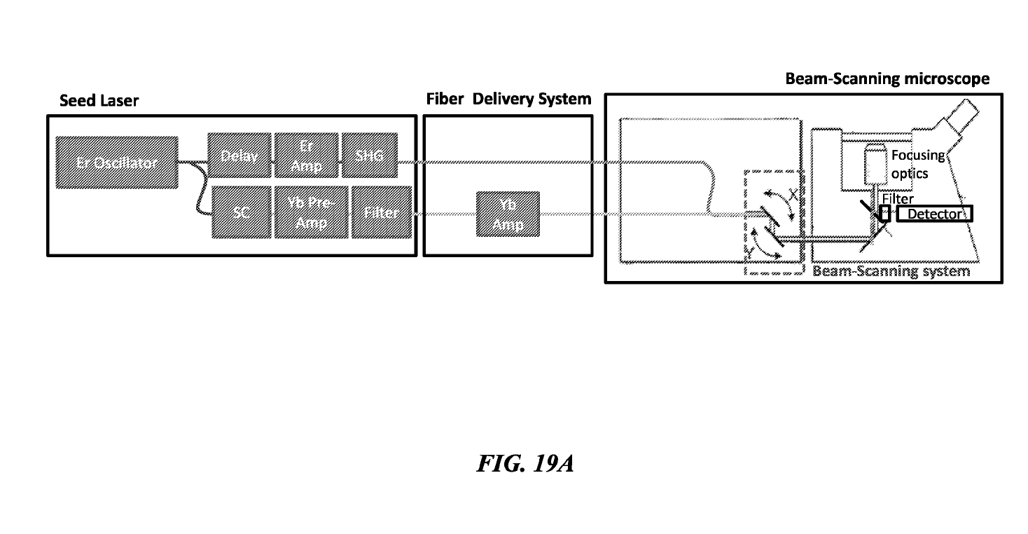

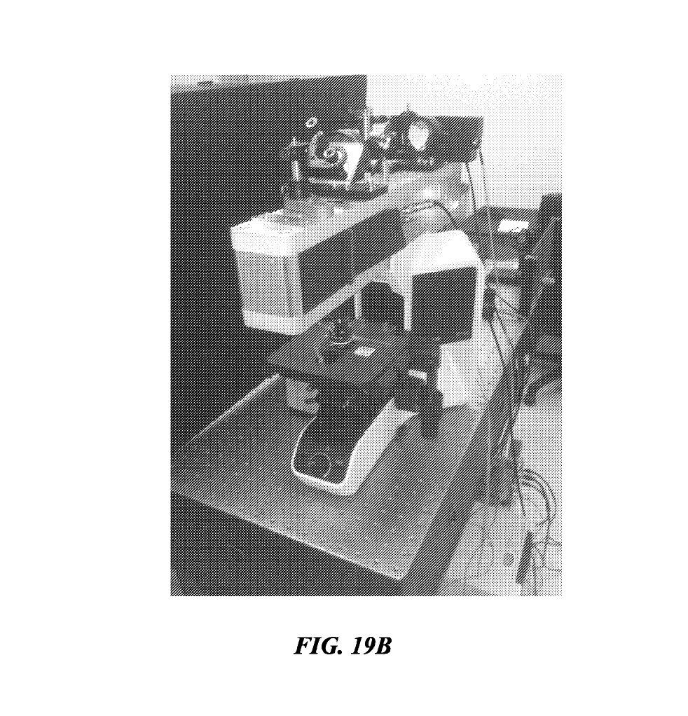

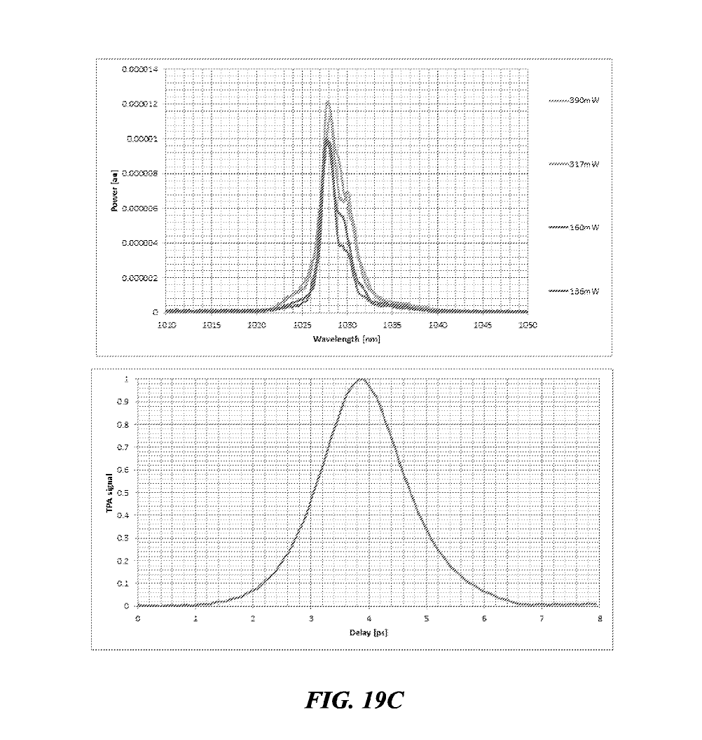

FIGS. 19A-19B show a schematic and photograph of an implementation of a multi-modal multi-photon imaging system by combining elements of FIG. 10A, FIG. 18B and FIG. 11B into a single system. In this example, the fiber amplifier system is located in the fiber delivery system. The system starts with an Er-doped fiber-oscillator with about 40 MHz repetition rate, 400 fs pulse duration at 1560 nm. Its output is split into two arms using a fiber-based 50/50. The first arm provides a first input train of pulses that passes through a computer-controlled fiber delay stage, is amplified in a cladding pumped Er-doped amplifier to produce about 200 mW output power, and then frequency doubled in a 5 mm PPLN crystal to provide a first output train of pulses at 780 nm. The second arm is spectrally broadened in a super-continuum spanning from 950 nm to >1700 nm and amplified with an Yb-doped pre-amplifier to provide a second output train of pulses at a wavelength from 1010 nm to 1050 nm that is synchronized to the oscillator and thus to the 780 nm pulse train. Using a filter that may be tunable before or after the Yb-preamplifier, the center wavelength (e.g., 1030 nm) and bandwidth (e.g. 1.8 nm) can be selected and thus the pulse duration (e.g., assuming close to transform limited operation). After the filter this provides a high-quality second input train of pulses with about 0.5 mW average power. This second input train of pulses is delivered to the scanning system of the microscope in an Yb-doped fiber that is cladding pumped at 976 nm and provides a second output train of pulses to the scan head with a power of up to 390 mW. The first and second output train of pulses are overlapped in the scanning unit using a dichroic mirror and collinear beams are aligned to the 2-axis galvano scan mirrors and relayed onto the objective back-aperture using a scan and tube lens. The-epi fluorescence signal from the focal volume is separated from the excitation light using a dichroic mirror, filtered with a 750 nm short-pass filter and detected with a PMT to provide the intensity of a pixel while scanning the scan mirrors.

FIG. 19C shows a characterization of the second train of pulses at the input of the scan mirrors. Despite the high average power (390 mW) and high duty factor (1/(40 MHz*1.2 ps)=20,833) the spectral and temporal properties are well preserved and result in strong multi-photon signals. The numerical values described may be further optimized for particular implementations of various multi-photon techniques.

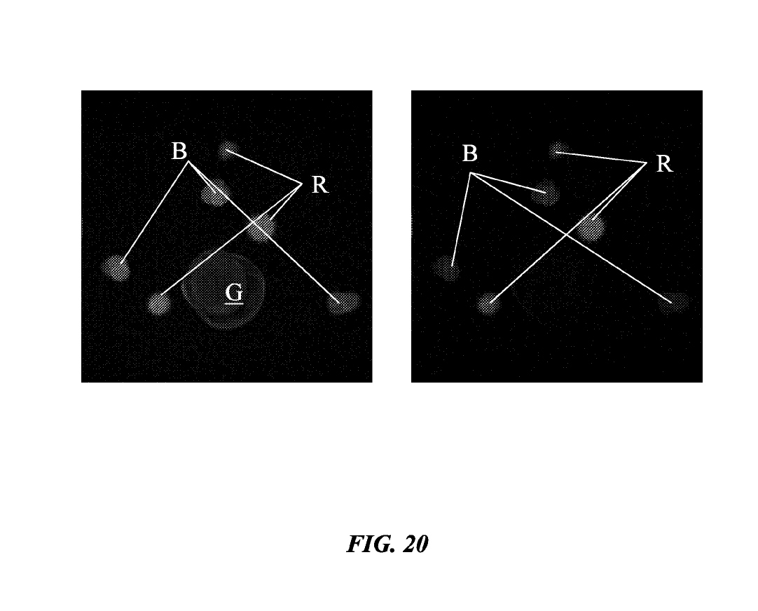

FIG. 20 provides multi-photon fluorescence images of pollen grains, an established test sample, acquired with the system shown in FIGS. 19A-19B configured for TPEF and TCTPEF. A blue image channel corresponds to 790 nm excitation only. A red image channel corresponds to 1030 nm excitation only. A green image channel corresponds to synchronized 790 nm and 1030 nm excitation minus the blue and red image channels. In the images in FIG. 20, different types of pollen have different excitation spectra and appear in different (pseudo) colors. In the image on the left, the time delay between the two output trains of pulses was minimized in the laser focus. Blue features B, red features R and green features G were observed. In the image on the right, the time delay was offset by 20 ps. Blue features B and red features R were observed. The green color channel, which corresponds to two-color two-photon excited fluorescence with 790 nm and 1030 nm, disappeared as expected. The image quality of the green image channel is as good as of the red and blue channels, indicating that the timing jitter between the two output pulse trains is minimal. Images were acquired with a 60× water immersion objective and at 15 fps with 500×500 sampling. Different color channels were acquired consecutively and image post-processing was applied. As detailed elsewhere herein, the imaging may be performed in real-time in some implementations.

FIG. 18C is an example of a system that includes an erbium-doped fiber amplifier system of which a portion of the output is frequency doubled to provide the second output. In this configuration, the first fiber system is an erbium-doped fiber amplifier system and the second fiber system comprises a second harmonic generation unit. Given the typical gain bandwidth of erbium-doped gain fibers, a first output train of pulses λ₁ can be at a wavelength (e.g., a center wavelength) from about 1530 nm to about 1620 nm (e.g., tuning range in FIG. 16B) or from about 1500 nm to about 2000 nm, and a second output train of pulses λ₂ at a wavelength (e.g., a center wavelength) from about 765 nm to about 810 nm (e.g., frequency doubled tuning range in FIG. 16B) or from about 750 nm to about 1000 nm. This system can enable two-color two-photon excitation with an effective two-photon excitation wavelength λeff=2/(1/λ₁+1/λ₂) in the range from about 1020 nm to about 1080 nm indicated by R3 in FIG. 17A, or in the range from about 1000 nm to about 1333 nm.

FIG. 18D is an example of a system that includes an erbium-doped fiber amplifier system of which the output is split into a long- and short-wavelength arm and consequently frequency doubled. This configuration can be implemented, for example, by adding a second harmonic generation unit to the first fiber system of FIG. 18C, e.g., by wavelength splitting the output spectrum of the erbium-doped fiber amplifier system (e.g., into a first arm having a wavelength smaller than about 1550 nm and a second arm having a wavelength larger than about 1550 nm). Given the typical gain bandwidth of erbium-doped gain fibers, a first output train of pulses λ₁ can be at a wavelength (e.g., a center wavelength) from about 765 nm to about 775 nm (e.g., lower end of frequency doubled tuning range in FIG. 16B) or from about 750 nm to about 775 nm, and a second output train of pulses λ₂ at a wavelength (e.g., a center wavelength) from about 775 nm to about 810 nm (e.g., upper end of frequency doubled tuning range in FIG. 16B) or from about 775 nm to about 1000 nm. This system can enable two-color two-photon excitation with an effective two-photon excitation wavelength λ_{eff}=2/(1/λ₁+1/λ₂) in the range from about 770 nm to about 792 nm, or in the range from about 762 nm to about 873 nm. Nonlinear broadening can further be used to extend the excitation ranges.

Further examples of possible configurations include, for example, first and second fiber systems that are both frequency-doubled erbium-doped fiber amplifier systems (indicated, for example, by R4 in FIG. 17A), first and second fiber systems that are both ytterbium-doped fiber amplifier systems (indicated by R5 in FIG. 17A), or first and second fiber systems that are both frequency-doubled ytterbium-doped fiber amplifier systems (having an effective two-photon excitation wavelength λ_{eff}=21(1/λ₁+1/λ₂) in the range from about 500 nm to about 540 nm, not shown). In yet other examples, a frequency-doubled ytterbium-doped fiber amplifier system can be combined with an ytterbium-doped fiber amplifier system (not shown), a frequency-doubled ytterbium-doped fiber amplifier system can be combined with an erbium-doped fiber amplifier system (not shown), a frequency-doubled ytterbium-doped fiber amplifier system can be combined with a frequency-doubled erbium-doped fiber amplifier system (not shown), and so on. Wavelength splitting (e.g., as described in relation to FIG. 18D) can be used to provide further configurations. In some cases, either the first or the second train of pulses can be used by itself.

With continued reference to FIG. 17A, combined with the excitation ranges of either the first or the second train of pulses by itself, the synchronized erbium and ytterbium systems herein can allow specific two-photon excitation in a range from, for example, about 500 nm to about 2000 nm. This capability may provide a flexible platform for multi-photon microscopy, photo-activation, photo-uncaging, and polymerization. Further, such an approach can advantageously enable multi-photon systems that utilize multiple discrete lines rather than broadly tunable input beams.

FIG. 18E is an example of a system that includes erbium- and thulium-doped fiber amplifier systems. The first fiber system is an erbium-doped fiber amplifier system and the second fiber system is a frequency-doubled thulium-doped fiber amplifier system. Given the typical gain bandwidth of erbium- and thulium-doped gain fibers, a first output train of pulses λ₁ can be at a wavelength (e.g., a center wavelength) from about 1530 nm to about 1620 nm (e.g., tuning range in FIG. 16B) or from about 1500 nm to about 2000 nm, and a second output train of pulses λ₂ at a wavelength (e.g., a center wavelength) from about 925 nm to about 1050 nm. This system can enable two-color two-photon excitation with an effective two-photon excitation wavelength λ_{eff}=2/(1/λ₁+1/λ₂) in the range from about 1153 nm to about 1274 nm indicated by R6 in FIG. 17B, or in the range from about 1144 nm to about 1377 nm.

FIG. 18F is another example of a system that includes erbium- and thulium-doped fiber amplifier systems. The first fiber system is a frequency-doubled erbium-doped fiber amplifier system and the second fiber system is a frequency-doubled thulium-doped fiber amplifier system. Given the typical gain bandwidth of erbium- and thulium-doped gain fibers, a first output train of pulses λ₁ can be at a wavelength (e.g., a center wavelength) from about 765 nm to about 810 nm (e.g., frequency doubled tuning range in FIG. 16B) or from about 750 nm to about 1000 nm, and a second output train of pulses λ₂ at a wavelength (e.g., a center wavelength) from about 925 nm to about 1050 nm. This system can enable two-color two-photon excitation with an effective two-photon excitation wavelength λ_{eff}=2/(1/λ₁+1/λ₂) in the range from about 837 nm to about 915 nm indicated by R7 in FIG. 17B, or in the range from about 828 nm to about 1024 nm.

Further examples of possible configurations include, for example, first and second fiber systems that are both frequency-doubled erbium-doped fiber amplifier systems (indicated by R4 in FIG. 17B), or first and second fiber systems that are both frequency-doubled thulium-doped fiber amplifier systems (indicated by R8 in FIG. 17B). Wavelength splitting (e.g., as described in relation to FIG. 18D) can be used in further configurations.

With continued reference to FIG. 17B, combined with the excitation ranges of either the first or the second train of pulses by itself, the synchronized erbium and thulium systems herein can allow specific two-photon excitation in a range from, for example, about 750 nm to about 2100 nm. An advantage of the synchronized erbium and thulium system may be a more even spacing of the excitation lines.

Together, the synchronized erbium and ytterbium systems and the synchronized erbium and thulium systems of the disclosure can provide a wide range of accessible excitation wavelengths. In some examples, an ytterbium and thulium system may be used. Further, other gain media (e.g., praseodymium, holmium, neodymium, etc.) may be combined with the erbium-ytterbium-thulium systems, or systems based exclusively on other gain media may be implemented. In some cases, the laser output pulse trains may be used or customized for other purposes than excitation, such as, for example, in various multi-photon microscopy settings. In some implementations, the fiber systems or fiber amplifier systems comprising such gain media may be fiber oscillator systems. Various configurations of the system herein can provide capability to output two, three or more output pulse trains. Such outputs may be achieved using one, two, three or more fiber systems. The ability to mix and match output pulse train lends further flexibility to the wavelength range accessible by the systems herein.

In some implementations, fiber amplifier systems of the disclosure can employ soliton self-frequency shift (SSFS) to extend gain/amplification ranges of fiber amplifier systems beyond typical emission bands. SSFS can occur as a result of stimulated Raman scattering between the blue and red wavelength edges of the pulse. Typically, SSFS can result in a continuous red-shift of the propagating pulses with a shift-rate that is proportional to the fourth power of the pulse duration. For example, SSFS may extend the amplification range of fiber amplifier systems comprising rare-earth doped gain media, such as, for example, the erbium-doped fiber amplifier system (e.g., extend an upper end of the gain range of the erbium-doped fiber amplifier of about 1530 nm-1620 nm to about 2000 nm or more and/or extend a lower end of the gain range of the erbium-doped fiber amplifier of about 1530 nm-1620 nm to about 1500 nm or less). In some examples, the gain range of amplifiers comprising erbium, ytterbium, holmium, thulium and/or any other dopant may be extended.

In an example, for a ˜100 fs pulse with a pulse energy of 2.5 nJ in a 100 inch Panda1550 fiber, we observed a shift from 1560 nm to about 1680 nm. By controlling the power and length of the fiber amplifier system, the gain range can be extended. In some cases, the fiber amplifier system can comprise several regions of doped and/or un-doped fiber to optimize the output power. In some cases, SSFR may occur during amplification in a single doped gain fiber.

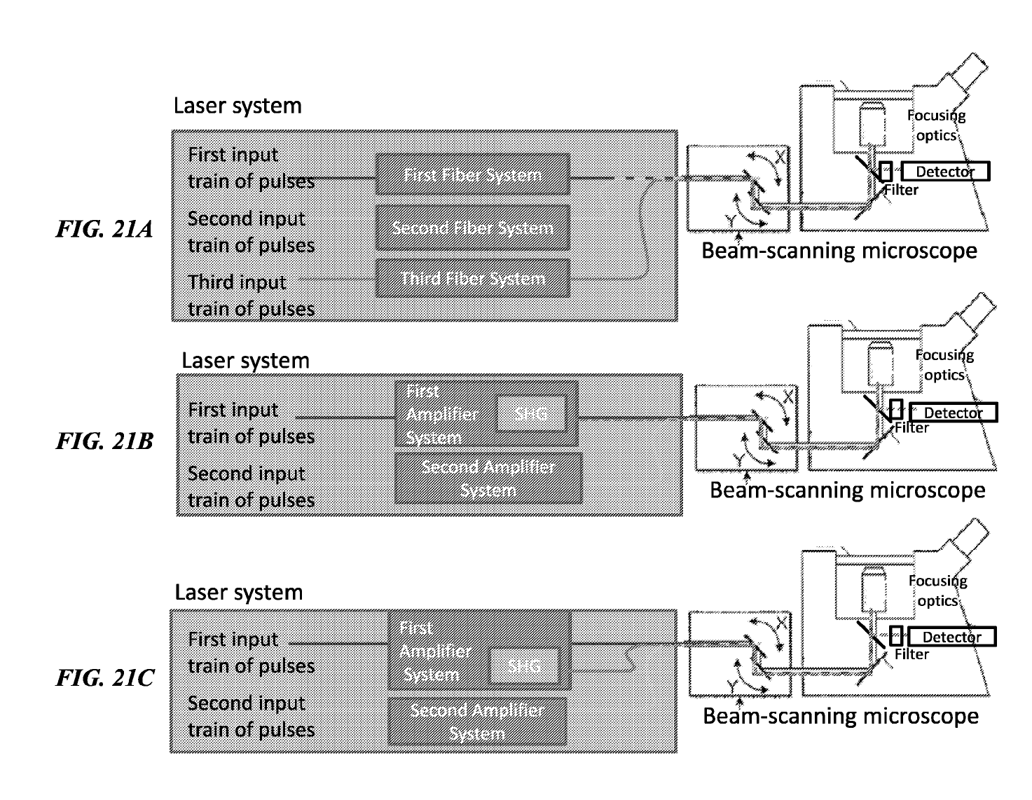

In one implementation, the system has an erbium-doped fiber oscillator to provide a first input train of pulses that is then amplified in an erbium-doped fiber amplifier to provide a first output train of pulses. A portion of either the first input train of pulses or the first output train of pulses is sent to a broadband super-continuum (SC) unit based on a highly nonlinear fiber (HNLF) and broadened to the ytterbium-range to provide a synchronized input train of pulses to a second fiber system based on an ytterbium-doped fiber amplifier system (e.g., as shown in FIG. 18A). The erbium-doped fiber amplifier system seeded by the first input train of pulses may also include a second harmonic unit (e.g., as shown in FIG. 18B). In some cases, the erbium-doped fiber amplifier system may output the erbium fundamental as a first train of pulses, the ytterbium-fundamental as a second output train of pulses, and the erbium second harmonic as a third output train of pulses (e.g., as shown in FIG. 21B and FIG. 21C). In some situations, it may be advantageous to configure either the input pulse trains and/or the fiber amplifier system such that the ytterbium-arm is at the short-wavelength end and the erbium-arm is at the long-wavelength end, such that the Yb-Yb-excitation range is significantly different from the 2Er-Er-excitation range and provides additional coverage. For example, a two-photon excitation spectral range can be from about 765 nm (or 805 nm) to about 1610 nm or in some cases 1700 nm in a single fiber laser system.

Another implementation also provides an erbium-doped fiber laser and generates an amplified first train of pulses. Instead of frequency converting a portion to the ytterbium-range, it can be frequency doubled in an SHG unit to provide a second output train of pulses (e.g., as shown in FIG. 18C), thereby enabling effective excitation from about 1020 nm to 1080 nm. This system can have essentially the same coverage as the previously described system, but may provide no excitation in the region from about 867 nm to 926 nm and 1209 nm to 1296 nm.

Yet another implementation also provides an erbium-doped fiber laser and generates an amplified first train of pulses as well as a broadband SC (e.g., using a broadband super-continuum (SC) unit based on an highly nonlinear fiber (HNLF) for broadening a portion of either a first input train of pulses or the first output train of pulses to the thulium-range) providing a synchronized input train of pulses to a second fiber system based on a thulium-doped fiber amplifier system that is frequency-doubled to provide a second output train of pulses (e.g., as shown in FIG. 18E). The erbium-doped fiber amplifier system seeded by the first input train of pulses may also include a second harmonic unit (e.g., as shown in FIG. 18F). In some cases, the erbium-doped fiber amplifier system may output the erbium fundamental as a first train of pulses, the thulium second harmonic as a second train of pulses, and the erbium second harmonic as a third output train of pulses.

As described in greater detail elsewhere herein, individual output pulse trains can be used by themselves (e.g., in the microscope). The range of wavelengths accessible using individual output pulse trains can depend on system configuration and gain media used. In some examples, individual output pulse trains can span a range of wavelengths with a width of at least about 1 nm, at least about 5 nm, at least about 10 nm, at least about 50 nm, at least about 100 nm, at least about 200 nm, or more. In some examples, individual output pulse trains can have a wavelength of at least about 500 nm, at least about 600 nm, at least about 700 nm, at least about 800 nm, at least about 900 nm, at least about 1000 nm, at least about 1100 nm, at least about 1200 nm, at least about 1300 nm, at least about 1400 nm, at least about 1500 nm, at least about 1600 nm, at least about 1700 nm, at least about 1800 nm, at least about 1900 nm, at least about 2000 nm, at least about 2100 nm, or more.

In other examples, a tunable wavelength range can be achieved. The tunable wavelength range can include wavelengths (e.g., excitation wavelengths) accessible by individual output pulse trains, wavelengths accessible using multi-color multi-photon techniques (e.g., effective excitation wavelength λ_{eff}), or any combination thereof. The range of accessible wavelengths can depend on system configuration and gain media used. In some examples, the tunable wavelength range can have a width of at least about 100 nm, at least about 200 nm, at least about 300 nm, at least about 400 nm, at least about 500 nm, at least about 600 nm, at least about 700 nm, at least about 800 nm, at least about 900 nm, at least about 1000 nm, at least about 1100 nm, at least about 1200 nm, at least about 1300 nm, at least about 1400 nm, at least about 1500 nm, or at least about 1600 nm. In some examples, the tunable wavelength range can be at least about 10%, at least about 20%, at least about 30%, at least about 40%, at least about 50%, at least about 60%, at least about 70%, at least about 80%, at least about 90%, or about 100% continuous (e.g., continuous over the width of the tunable wavelength range). In some examples, the tunable wavelength range can include wavelengths of at least about 500 nm, at least about 600 nm, at least about 700 nm, at least about 800 nm, at least about 900 nm, at least about 1000 nm, at least about 1100 nm, at least about 1200 nm, at least about 1300 nm, at least about 1400 nm, at least about 1500 nm, at least about 1600 nm, at least about 1700 nm, at least about 1800 nm, at least about 1900 nm, at least about 2000 nm, at least about 2100 nm, or more. In some examples, the tunable wavelength range can include wavelengths of less than about 500 nm, less than about 600 nm, less than about 700 nm, less than about 800 nm, less than about 900 nm, less than about 1000 nm, less than about 1100 nm, less than about 1200 nm, less than about 1300 nm, less than about 1400 nm, less than about 1500 nm, less than about 1600 nm, less than about 1700 nm, less than about 1800 nm, less than about 1900 nm, less than about 2000 nm, less than about 2100 nm, or the like. In an example, the tunable wavelength range is between 500 nm and 2100 nm. In another example, the tunable wavelength range is between 500 nm and 1620 nm (or 1700 nm in some cases). In yet another example, the tunable wavelength range is between 765 nm and 2100 nm.

In some examples, an advantage of using fiber amplifier systems (e.g., frequency-doubled fiber amplifier systems) for generating excitation beams for two-photon excitation over other approaches (e.g., fiber shifting) can be straightforward power scaling in amplifier systems with stringent control of properties of the excitation pulses. The described platform may be compatible with a variety of pulse parameters and may be configured, customized or optimized for a given application. In some cases, the repetition rate can be determined by that of the input train of pulses (e.g., by the cavity length of the oscillator(s)). The pulse duration can be determined by the pulse duration of the input train of pulses, the spectral bandwidth of the output train of pulses and/or any chirp in the system. In some cases, spectral filtering can be used to increase the pulse duration or implement means of pulse stretching/compression. Average power can be determined by the average power of the input train of pulses, the amplification ratio of the amplifiers, the conversion efficacy of the harmonic generation units, or any combination thereof. For a given configuration, the pulse energy of a pulse of a train of pulses can be estimated by dividing the average power by the repetition rate and the peak power of a pulse of a train of pulses can be estimated by multiplying the average power by the laser duty factor (inverse product of repetition rate and pulse duration).

Two-photon excited fluorescence microscopy may be performed with Ti:Sa lasers with about 150 fs pulse duration and 80 MHz repetition rate. Because of the high laser duty factor of about 83,000, such systems can provide high signal-to-noise ratio (SNR) images even at low average power (few mW in thin samples). Two-photon excited fluorescence microscopy may also be performed with picosecond lasers with a pulse duration of about 1.2 ps and 80 MHz repetition rate. In some cases, the lower duty factor of about 10,000 necessitates higher average power in focus to achieve the same SNR. In certain situations, it may be advantageous to provide the same laser duty factor of the femtosecond system with a picosecond system by reducing the laser repetition rate. On the other hand, increasing the repetition rate to hundreds of MHz may decrease nonlinear photo-damage for pulses with 150 fs pulse duration at higher average powers. In some situations, deep tissue imaging applications can use up to hundreds of mW of in focus power and/or pulse repetition rates as low as about 200 kHz without causing photo-damage, because the majority of light is scattered/absorbed by the tissue before reaching the laser focus.

A suitable operating parameter range for the systems described herein may be determined by, for example, pulse duration, repetition rate, average power, or any combination thereof. The parameters can be chosen or customized for particular applications.

A multi-wavelength fiber laser system (e.g., individual output pulse trains comprising one or more photons, individual photons, combined pulse trains, etc.) can have a pulse duration of at least about 25 fs, at least about 50 fs, at least about 75 fs, at least about 100 fs, at least about 250 fs, at least about 500 fs, at least about 750 fs, at least about 1 ps, at least about 5 ps, at least about 25 ps, at least about 50 ps, at least about 250 ps, and the like. A multi-wavelength fiber laser system can have a pulse duration of less than about 25 fs, less than about 50 fs, less than about 75 fs, less than about 100 fs, less than about 250 fs, less than about 500 fs, less than about 750 fs, less than about 1 ps, less than about 5 ps, less than about 25 ps, less than about 50 ps, less than about 250 ps, and the like. In some examples, pulse durations from about 25 fs to about 250 ps can be used. In some examples, the pulse duration is about 25 fs, about 50 fs, about 75 fs, about 100 fs, about 200 fs, about 300 fs, about 400 fs, about 500 fs, about 750 fs, about 1 ps, about 5 ps, about 25 ps, about 50 ps, or about 250 ps. Pulse durations of the first and second pulse trains can be the same or different.

A multi-wavelength fiber laser system (e.g., individual output pulse trains comprising one or more photons, individual photons, combined pulse trains, etc.) can have a repetition rate of at least about 100 kHz, at least about 250 kHz, at least about 500 kHz, at least about 750 kHz, at least about 1 MHz, at least about 25 MHz, at least about 50 MHz, at least about 100 MHz, at least about 250 MHz, at least about 500 MHz, and the like. A multi-wavelength fiber laser system can have a repetition rate of less than about 100 kHz, less than about 250 kHz, less than about 500 kHz, less than about 750 kHz, less than about 1 MHz, less than about 25 MHz, less than about 50 MHz, less than about 100 MHz, less than about 250 MHz, less than about 500 MHz, and the like. In some examples, repetition rates from about 100 kHz to about 500 MHz can be used. In some examples, the repetition rates is about 100 kHz, about 250 kHz, about 500 kHz, about 750 kHz, about 1 MHz, about 10 MHz, about 20 MHz, about 30 MHz, about 40 MHz, about 50 MHz, about 60 MHz, about 70 MHz, about 80 MHz, about 90 MHz, about 100 MHz, about 250 MHz, or about 500 MHz.

A multi-wavelength fiber laser system can have an average power of at least about 1 mW, at least about 5 mW, at least about 10 mW, at least about 25 mW, at least about 50 mW, at least about 100 mW, at least about 200 mW, at least about 300 mW, at least about 400 mW, at least about 500 mW, at least about 600 mW, at least about 700 mW, at least about 800 mW, at least about 900 mW, at least about 1 W, and the like. A multi-wavelength fiber laser system can have an average power of less than about 1 mW, less than about 5 mW, less than about 10 mW, less than about 25 mW, less than about 50 mW, less than about 100 mW, less than about 200 mW, less than about 300 mW, less than about 400 mW, less than about 500 mW, less than about 600 mW, less than about 700 mW, less than about 800 mW, less than about 900 mW, less than about 1 W, and the like. In some examples, average powers from about 1 mW to about 1 W can be used. In some examples, the average power is about 1 mW, about 5 mW, about 10 mW, about 20 mW, about 30 mW, about 40 mW, about 50 mW, about 60 mW, about 75 mW, about 100 mW, about 200 mW, about 300 mW, 400 mW, 500 mW, 600 mW, about 700 mW, about 800 mW, about 900 mW, or about 1 W.

In an example, the first and/or second output trains of pulses can have a pulse duration of about 150 fs, a repetition rate of about 80 MHz and an average power of more than about 100 mW in each beam to match the properties of typical Ti:Sa lasers. In other examples, it may be advantageous to provide a pulse duration of about 300 fs and repetition rate of about 40 MHz, pulse duration of about 500 fs and repetition rate of about 24 MHz, pulse duration of about 1 ps and repetition rate of about 12 MHz, pulse duration of about 2 ps and repetition rate of about 6 MHz, and pulse duration of about 5 ps and repetition rate of about 2.4 MHz, respectively, to provide about the same duty factor as typical Ti:Sa lasers. In these examples, it may be sufficient to provide less than about 100 mW in each beam. For example, in medical applications it may be advantageous to limit the maximum exposure to the ANSI safety standard. In yet another example, the first and/or second output trains of pulses can have a pulse duration of about 150 fs, a repetition rate of more than about 200 MHz and, for example, provide less peak power damage. In yet another example, the first and/or second output trains of pulses can have a pulse duration of about 150 fs, a repetition rate of less than about 500 kHz and, for example, provide deeper imaging.

### Multi-Color Multi-Photon Excited Fluorescence

In another example, the synchronized light source above is used for two-photon excited fluorescence microscopy. The first and second output pulse trains are aligned into a beam-scanning microscope and focused into the sample with a focusing lens. The molecular population in the focal volume is excited from the ground state to the excited state by the combined action of the two output pulse trains. The molecular population then relaxes to a lower excited state (or directly the ground state) while emitting a new photon (e.g., as illustrated in FIGS. 2A-2D). This new emission is detected with a high-sensitivity photodetector (e.g., photomultiplier tube or avalanche photodiode) after the excitation beams are blocked with a high optical density (OD) filter and provides the signal for a pixel. By scanning the first and second output pulse trains through the sample (e.g., with resonant and/or non-resonant galvano scan mirror, resonant or non-resonant MEMS scan mirror, a resonant or non-resonant scanning fiber tip, and/or stage scanner), a two and/or three-dimensional image of the distribution of the molecular species is acquired. In some cases, scan and tube lenses are used to image the scan mirror(s) or the plane between two mirrors onto the back-aperture of the focusing lens. Pixel dwell times can be about 100 ns and shorter (e.g., for video rate imaging with 512×512 sampling), several micro-seconds (e.g., for 1 frame/s imaging with 512×512 sampling), or up to milli-second (e.g., for high sensitivity applications).

Multiple images may be recorded for the same sample to generate time-resolved data, including videos. In some examples, imaging can be provided at a rate of at least about 1, 2, 3, 4, 5, 10, 15, 20 or more frames/s. Such rate may be provided for pixel resolutions of, for example, at least about 100, 200, 300, 400, 500, 600, 700, 800, 900, 1000, 1100, 1200, 1300, 1400, 1500, 1600, 1700, 1800, 1900, 2000 or 2100 pixels in x and/or y directions, and the like. In some examples, a resolution of about 512, about 1024, or more pixels in x and/or y directions is used.

The systems and methods disclosed herein may be configured with various levels of spectral data acquisition rates. In some examples, the spectral data acquisition rate is between 10 spectra/second and 1,000,000 spectra/second. In some examples, the spectral data acquisition rate is at least about 10 spectra/second, at least about 25 spectra/second, at least about 50 spectra/second, at least about 75 spectra/second, at least about 100 spectra/second, at least about 150 spectra/second, at least about 200 spectra/second, at least about 300 spectra/second, at least about 500 spectra/second, at least about 750 spectra/second, 1,000 spectra/second, at least about 5,000 spectra/second, at least about 10,000 spectra/second, at least about 25,000 spectra/second, at least about 50,000 spectra/second, at least about 75,000 spectra/second, at least about 100,000 spectra/second, at least about 250,000 spectra/second, at least about 500,000 spectra/second, at least about 750,000 spectra/second, or at least about 1,000,000 spectra/second. In yet other examples, the spectral data acquisition rate is at most about 1,000,000 spectra/second, at most about 750,000 spectra/second, at most about 500,000 spectra/second, at most about 250,000 spectra/second, at most about 100,000 spectra/second, at most about 75,000 spectra/second, at most about 50,000 spectra/second, at most about 25,000 spectra/second, at most about 10,000 spectra/second, at most about 5,000 spectra/second, or at most about 1,000 spectra/second. In an example, the spectral data acquisition rate is about 10,000 spectra/second. In some implementations, wavelengths of one or more laser pulses herein may fall within any range bounded by any of these values (e.g., from about 2,500 spectra/second to about 200,000 spectra/second).

For some fluorophores, the two-photon absorption range may overlap, but the emission spectra may differ. In this case, it is possible to perform simultaneous multi-species imaging at a fixed excitation wavelength by using multiple photo-detectors that are responsive to different regions of the emission spectrum and using spectral deconvolution if needed. Further, a single species comprising multiple (different) fluorophores may be probed. Thus, multiple fluorescent molecules or fluorophores can be excited, either within the same or different species.

The two-photon absorption ranges of two molecular species of interest may be well separated. In the case of Ti:Sa lasers, the laser can be tuned to excite the species sequentially. In this example, we show simultaneous excitation of multiple species with different two-photon absorption ranges using the systems described herein.

Multi-photon microscopy (e.g., two-photon excited fluorescence microscopy) may thus include providing multiple multi-photon laser outputs (e.g., each such output comprising one, two, three or more output trains of pulses) for enabling absorption/excitation/scattering in multiple different absorption/excitation/scattering wavelength ranges, as well as detection of multiple resulting emission/scattering outputs (e.g., outputs at different wavelengths resulting from the same laser output or from different laser outputs).

In an example, a system using an erbium doped amplifier system as the first fiber system and an ytterbium doped amplifier system as the second fiber system (e.g., the system in FIG. 18A) can excite a first molecular species within an absorption range from about 1209 nm to about 1296 nm (or from about 1200 nm to about 1403 nm in some cases). It can also excite a second molecular species within an absorption range from about 1530 nm to about 1620 nm (or from about 1500 nm to about 2000 nm in some cases) or from about 1000 nm to about 1080 nm (e.g., resulting from separate excitation by either the first or the second train of pulses), enabling simultaneous multi-species imaging of two or more species. It can also excite a second molecular species within an absorption range from about 1530 nm to about 1620 nm (or from about 1500 nm to about 2000 nm in some cases) and a third molecular species within an absorption range from about 1000 nm to about 1080 nm (e.g., resulting from separate excitations by both the first and the second train of pulses), enabling simultaneous multi-species imaging of three or more species.

In another example, a system using a frequency-doubled erbium doped amplifier system as the first fiber system and an ytterbium doped amplifier system as the second fiber systems (e.g., the system in FIG. 18B) can excite a first molecular species within an absorption range from about 867 nm to about 926 nm (from about 857 nm to about 1038 nm in some cases). It can also excite a second molecular species within an absorption range from about 765 nm to about 810 nm (or from about 750 nm to about 1000 nm in some cases) or from about 1000 nm to about 1080 nm (e.g., resulting from separate excitation by either the first or the second train of pulses), enabling simultaneous multi-species imaging of two or more species. It can also excite a second molecular species within an absorption range from about 765 nm to about 810 nm (or from about 750 nm to about 1000 nm in some cases) and a third molecular species within an absorption range from about 1000 nm to about 1080 nm (e.g., resulting from separate excitations by both the first and the second train of pulses), enabling simultaneous multi-species imaging of three or more species.

In another example, a system using a erbium doped amplifier system as the first fiber system and a second harmonic generation unit as the second fiber systems (e.g., the system in FIG. 18C) can excite a first molecular species within an absorption range from about 1020 nm to about 1080 nm (or from about 1000 nm to about 1333 nm in some cases). It can also excite a second molecular species within an absorption range from about 765 nm to about 810 nm (or from about 750 nm to about 1000 nm in some cases) or from about 1530 nm to about 1620 nm (or from about 1500 nm to about 2000 nm in some cases) (e.g., resulting from separate excitation by either the first or the second train of pulses), enabling simultaneous multi-species imaging of two or more species. It can also excite a second molecular species within an absorption range from about 765 nm to about 810 nm (or from about 750 nm to about 1000 nm in some cases) and a third molecular species within an absorption range from about 1530 nm to about 1620 nm (or from about 1500 nm to about 2000 nm in some cases) (e.g., resulting from separate excitations by both the first and the second train of pulses), enabling simultaneous multi-species imaging of three or more species.

Further, it may be advantageous to provide excitation with three (or more) output pulse trains. In some implementations, this can be achieved by providing a synchronized third input train of pulses and a third fiber system. FIG. 21A schematically illustrates an example of simultaneous multi-color (e.g., multi-species) multi-photon microscopy with three beams generated from three fiber systems. In other implementations, excitation with three output pulse trains can be achieved by designing the first/second fiber system to include a harmonic generation unit and outputting the harmonic signal as a third output train of pulses while the fundamental provides the first/second output train of pulses. In some cases, the thus generated third output train of pulses and first/second output train of pulses can be intrinsically collinear or combined either in fiber or free-space. FIG. 21B schematically illustrates an example of simultaneous multi-color (e.g., multi-species) multi-photon microscopy with three beams generated from a first amplifier system with a harmonic generation unit for collinear dual-wavelength output and a second fiber amplifier system. In some cases, the thus generated third output train of pulses and first/second output train of pulses can be combined either in fiber or free-space. FIG. 21C schematically illustrates simultaneous multi-color (e.g., multi-species) multi-photon microscopy with three beams generated from a first amplifier system with a harmonic generation unit for non-collinear dual-wavelength output and a second fiber amplifier system.

In some implementations, multi-species systems can be implemented using an erbium doped amplifier system as the first fiber system and an ytterbium doped amplifier system as the second fiber system (e.g., systems having excitation range(s) shown in FIG. 17A). In some examples, such systems can have a capability to excite a first molecular species within an absorption range from about 1209 nm to about 1296 nm (or from about 1200 nm to about 1403 nm in some cases), and/or a second molecular species within an absorption range from about 867 nm to about 926 nm (or from about 857 nm to about 1038 nm in some cases), and/or a third molecular species within an absorption range from about 1020 nm to about 1080 nm, and/or a fourth molecular species within an absorption range from about 1530 nm to about 1620 nm (or from about 1500 nm to about 2000 nm in some cases), and/or a fifth molecular species within an absorption range from about 1000 nm to about 1080 nm, and/or a sixth molecular species within an absorption range from about 765 nm to about 810 nm (or from about 750 nm to about 1000 nm in some cases), enabling simultaneous multi-species imaging of up to six and more molecular species.

In some implementations, multi-species systems can be implemented using a frequency-doubled thulium amplifier system as the second fiber system (e.g., systems for simultaneous multi-species two-photon excited fluoresce microscopy having excitation range(s) shown in FIG. 17B).

In other implementations, other gain media may be used as described in more detail elsewhere herein. In some implementations, each output pulse train may comprise one, two, three, or more photons. For example, multi-photon excitation can be implemented due to simultaneous absorption of at least one photon of the first output train of pulses and at least one photon of the second output train of pulses. In further implementations, more than three output pulse trains can be output. For example, additional harmonic generation units, wavelength splitting, or additional fiber systems can be added to enable additional output pulse trains. In some cases, an individual output pulse train can be combined with one or more other output pulse trains. In other cases, an individual output pulse train can be provided (e.g., absorbed) by itself without combining with other output pulse train(s).

Different schemes for multi-species imaging can be implemented for detection. For example, emission spectroscopy can be performed to simultaneously detect different molecular species. In one example, this can be achieved with multiple photo-detectors that are responsive to distinct regions of the emission spectrum. In some cases, the photo-detectors can use spectral deconvolution if needed.

The systems of the disclosure (e.g., microscope) can comprise a filter for blocking one or more output trains of pulses (e.g., λ₁ and λ₂, λ₁, λ₂ and λ₃, etc.) and for passing a multi-photon excited fluorescence signal generated by one or more molecular species (also “excitable species” herein) in the common focal volume.

In an example, the multi-photon systems herein can comprise at least one pulse picker for picking pulses of at least one of the first input train of pulses, the first output train of pulses, the second input train of pulses, and the second output train of pulses in order to pass trains of pulses having wavelengths λ₁ and λ₂. To enable detection, the systems can comprise a filter for blocking λ₁ and λ₂ and for passing a multi-photon excited fluorescence signal generated by at least one of a first excitable species, a second excitable species and a third excitable species in the common focal volume. The multi-photon excited fluorescence signal can be detected by at least one photodetector. In some cases, processing electronics can analyze the multi-photon excited fluorescence signal detected by the photodetector in synchronization with the at least one pulse picker. In further examples, any number of input and/or output trains of pulses (e.g., 2, 3, 4, 5, 6, 7, 8, 9, 10, 11, 12, 13, 14, 15, 16, 17, 18, 19, 20, or more) can be picked to detect a suitable number of excitable fluorophores (e.g., 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 40, 45, 50, 55, 60, or more) within one or more species.

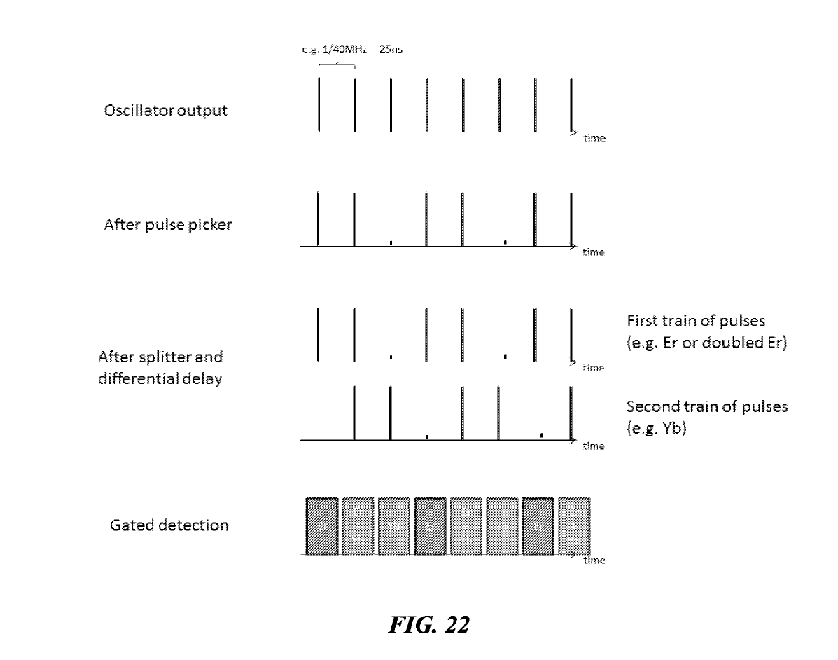

FIG. 22 shows an example excitation scheme for simultaneous multi-species multi-photon microscopy. A pulse picker placed between the fiber oscillator and splitter in FIG. 10A is used to eliminate one out of three pulses. The modulated pulse train is consequently split and shifted to provide the first and second input train of pulses, as described in greater detail elsewhere herein. By delaying (e.g., using differential delay) one of the input pulse trains relative to the other by the inverse of the laser repetition rate, a modulated excitation source for multi-species imaging can be generated. Synchronization of gated detection to the combined pulse trains can enable high-speed multi-photon methods (e.g., excitation spectroscopy), where the first pulse of three measures the excitation by the first train of pulses only, the third pulse of three measures the excitation by the second train of pulses only, and the second pulse of three measures the excitation by both the first and second train of pulses. For example, the first train of pulses can be derived from the output of an Er-doped fiber amplifier or a frequency-doubled Er-doped fiber amplifier, and the second train of pulses can be derived from an Yb-doped fiber amplifier. This scheme can be expanded to other integer ratios of picked pulses, complex excitation patterns, and more than two excitation beams if pulse picking and gated data acquisition are synchronized.

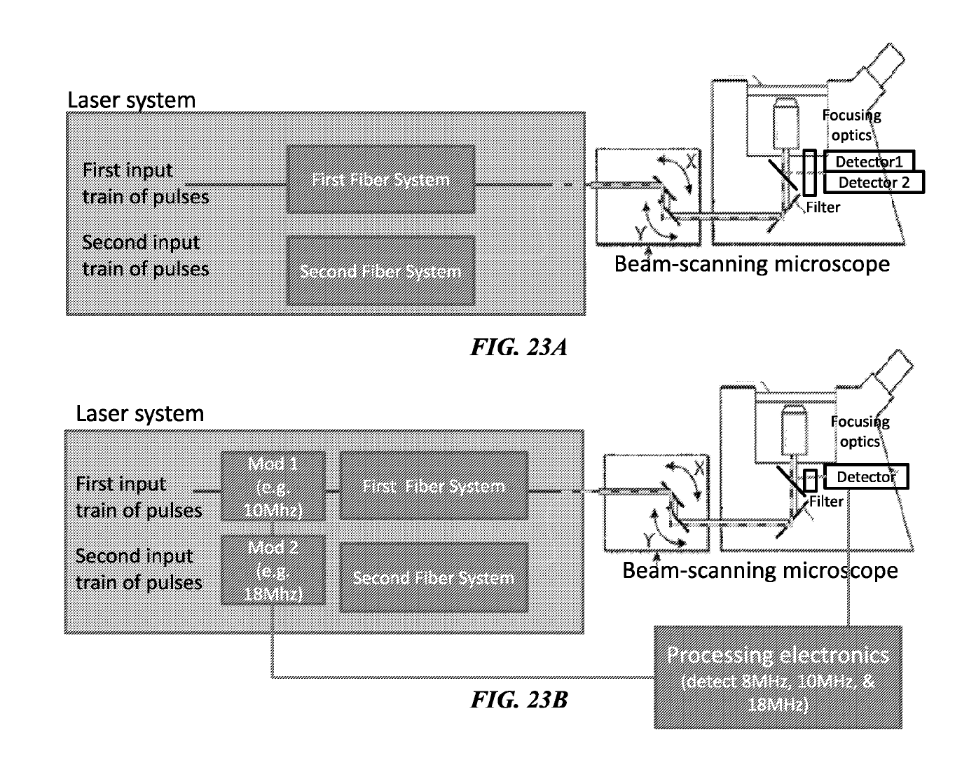

FIG. 23A schematically illustrates simultaneous multi-color (e.g., multi-species) multi-photon microscopy using emission spectroscopy with multiple detectors sensitive to specific spectral regions of fluorescence emission. In this example, two output pulse trains are aligned into a beam-scanning microscope and focused into the sample (e.g., using a focusing lens). The excitation beams can be blocked (e.g., with a high-OD filter) before first and second photo-detectors (e.g., high-sensitivity detectors such as photomultiplier tubes or avalanche photodiodes) are illuminated by light emitted from the sample as a result of excitation. The first photo-detector can be configured for detection of a first range of emission wavelength or set of wavelengths. The second photo-detector can be configured for detection of a second range emission wavelength or set of wavelengths. In some cases, the first wavelength or set of emission wavelengths can be different than the second set of emission wavelengths. In other cases, at least a portion of the first set of emission wavelengths can overlap with at least a portion of the second set of emission wavelengths. In yet other cases, the detectors can be capable of detecting one or more identical emission wavelengths with different sensitivities. Wavelength separation can be achieved with filters, dichroic mirrors, dispersive elements (e.g., grating or prism), or any combination thereof.

In some examples, excitation spectroscopy can be used to distinguish contributions of different molecular species to an overall emission signal. This can be implemented, for example, by mapping one or more optical excitation wavelengths to an RF modulation frequency and analyzing the detected signal in response to the (e.g., two-photon) excited fluorescence emission with detection electronics at a particular RF frequency (e.g., using a lock-in amplifier, square-wave demodulator, resonant circuit, passive filter, rectifier, etc.).

In an example, if a first output train of pulses is modulated at a frequency f₁ and a second output train of pulses is modulated at a frequency f₂, then emission from a first molecular species with a two-photon excitation range including 2/(1/λ₁+1/λ₂) can be modulated at the mixing frequencies |f₁−f₂| and f₁+f₂. Emission from another molecular species with a two-photon excitation range including λ₁ or λ₂ can be modulated at f₁ or f₂, respectively. In some cases, modulation frequencies higher than the inverse of pixel dwell-time can be chosen to enable real-time multi-color imaging. In other cases, modulation can occur on a line-by-line, segment-by-segment basis or frame-by-frame basis.

In some examples, modulation of an output train of pulses can include modulation of an intensity of the output train of pulses. In some cases, modulation of the intensity of the output train of pulses can be achieved with a shutter (e.g., mechanical shutter or chopper wheel) or modulator (e.g., electro- or acousto-optic modulator) placed interacting with an input train of pulses before the fiber system, a shutter (e.g., mechanical shutter or chopper wheel) or modulator (e.g., electro- or acousto-optic modulator) placed interacting with the output train of pulses, or a combination thereof. In other examples, repetition rates of the input trains of pulses and the output trains of pulses can be a fixed fraction of each other, such that the input pulse trains can be synchronized but the signals can be detected at different RF frequencies.

FIG. 23B schematically illustrates simultaneous multi-color (e.g., multi-species) multi-photon microscopy using excitation spectroscopy by modulating first and second output pulse trains at different RF frequencies. The first output pulse train can be modulated, for example, by a first modulator placed interacting with a first input train of pulses and configured for providing a first modulation frequency (e.g., 10 MHz or f₁). The second output pulse train can be modulated, for example, by a second modulator placed interacting with a second input train of pulses and configured for providing a second modulation frequency (e.g., 18 MHz or f₂). Fluorescent response at fundamental and mixed frequencies can be detected with processing electronics for detecting signals at different frequencies (e.g., 8 MHz, 10 MHz, 18 MHz, 28 MHz, etc.). In some cases, photodetector can be used for detecting the multi-photon excited fluorescence signal and processing electronics can be used for analyzing the multi-photon excited fluorescence signal detected by the photodetector at at least one of the frequencies f₁, f₂, |f₁−f₂|, or f₁+f₂.

In some examples, excitation spectroscopy can be implemented with a single photo-detector responsive to the fluorescence emission from at least a portion or all molecular species in the focal volume. In other examples, excitation spectroscopy can be implemented in combination with emission spectroscopy with one or more photo-detectors that are responsive to particular spectral regions of the fluorescence emission. Systems for multi-photon excitation and multi-color multi-photon imaging described herein can be expanded from two-photon excitation to three- or other multi-photon excitation in some implementations. In one example of a three-photon excitation system, the laser system can provide first and second output trains of pulses that are seeded by synchronized first and second input trains of pulses, respectively. The first output train of pulses can contribute two photons to each interaction. The system can have an effective three-photon excitation wavelength range of 3/(2/λ₁+1/λ₂). In another example of a three-photon excitation system, the laser system can provide three output trains of pulses that are seeded by three synchronized input trains of pulses. In such a configuration, the system can have an effective three-photon excitation wavelength range of 3/(1/λ₁+1/λ₂+1/λ₃).

The systems of the disclosure can include a focusing optic for focusing the output trains of pulses into a common focal volume. The focusing optic can be used for focusing one, two, three or more output trains of pulses into the common focal volume. In an example, the common focal volume can be a product of an intensity of a focal volume (point spread function) of a first train of pulses and an intensity of a focal volume of a second train of pulses. In some cases, two-photon excitation can be most effective if there is significant spatial overlap between the focal volumes of the first and second output trains of pulses. This can be achieved, for example, by achromatic correction of the focusing optic at at least λ₁ and λ₂. For example, the focusing optic can be achromatic in a spectral region around about 800 nm and about 1030 nm, about 1030 nm and about 1600 nm, about 800 nm and about 1600 nm, or about 800 nm and about 1030 nm and about 1600 nm. Examples of chromatic corrections include but are not limited to chromatic corrections at around about 800 nm and about 1030 nm, about 1030 nm and about 1600 nm, about 800 nm and about 1600 nm, or about 800 nm and about 1030 nm and about 1600 nm.

In another example, the focusing optic can have known chromatic focal shifts at λ₁ and λ₂, which can be corrected by adjusting divergence of at least one output train of pulses (e.g., at the input of the focusing optic). For example, in a system having two output trains of pulses, the divergence of the first output train of pulses, the divergence of the second output train of pulses, or both can be adjusted. In another example, in systems having three output trains of pulses, the divergence of the first output train of pulses, the divergence of the second output train of pulses, the divergence of the third output train of pulses, or any combination thereof can be adjusted.

Even in the case of an achromatic focusing optic, the sizes of the focal volumes of the first and the second output trains of pulses may be different, as λ₁≠λ₂. This may cause imaging artifacts in multi-color imaging. In some implementations, beam sizes of the first, second and/or any additional output trains of pulse can be adjusted (e.g., at the input of the focusing optic) to provide focal volumes of the same size. For example, the beam sizes of the first output train of pulses, the second output train of pulses and/or the third output train of pulses can be matched to provide a common focal volume of identical size independent of the first, second and/or third center wavelengths.

### Electronics

System integration may require design of consolidated electronics to (1) control and monitor the laser and diagnostic instrumentation, (2) drive beam-scanners and (3) read detectors. Various degrees of device integration can be implemented. While fully custom electronics based on DSPs or FPGAs may provide reduced cost, off-the-shelf DAQ cards such as, for example, a National Instruments card (USB-6356-OEM) and daughter board that interfaces directly through generic 34- and 50-pin connectors, can in some cases provide a more flexible architecture. The National Instruments USB-6356-OEM DAQ provides eight 16-bit analog input (AI) channels with 1.25 MS/s/channel simultaneous sampling to read the various detector channels, two 16-bit 3.33 MS/s analog outputs (AO) to drive galvo scan mirrors, as well as 24 digital I/O lines (of which 8 are hardware-timed up to 1 MHz) for communication with the daughter board.

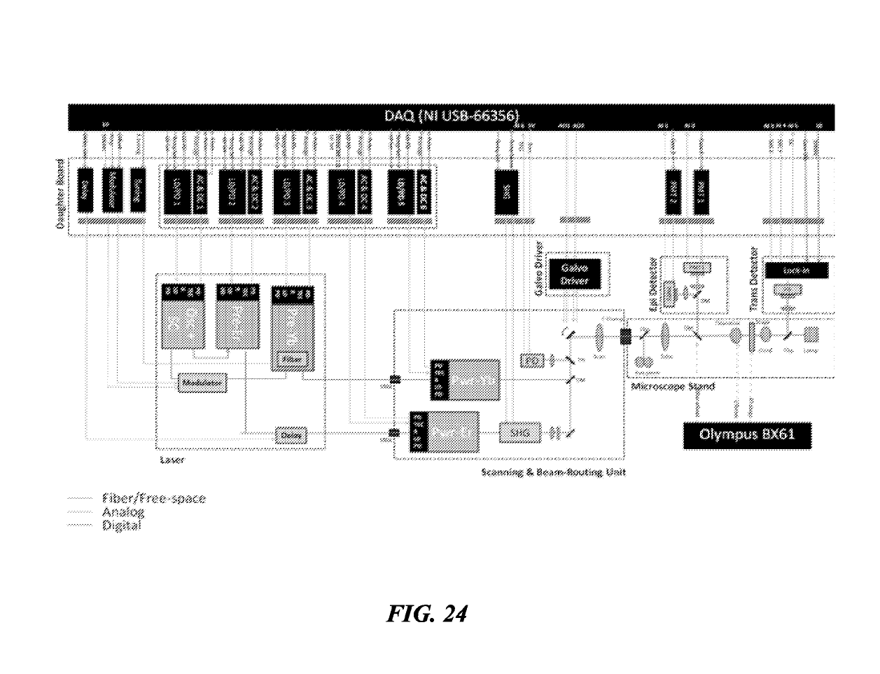

FIG. 24 shows a detailed wiring diagram of an example system having the following features:

(1) Digital control of the drive currents for the pump lasers with 1 mA precision and 1.5 Å maximum (e.g., Wavelength Electronics, WLD3343-2L). Digital readout of the power pump laser power from the integrated PDs. Temperature feedback with digitally adjustable set point (e.g., Wavelength Electronics, WHY5640). The pump lasers are soldered on a separate circuit board inside the laser modules and can be connected to the drivers with cables.

(2) Digital readout of the PD at the input of each laser module for monitoring operations and advanced functions (spectral calibration and modulation). The PD can be mounted on the same circuit board as the pump lasers. Each PD output can be split into AC and DC components with a bias-T (e.g., Minicircuits). The AC signals represent the mode-locked powers and may be measured with RF-power detectors (e.g., Texas Instruments). An option for synchronizing the laser repetition rate with the DAQ clock can be provided.

(3) Digital control of the laser parameters: (a) Stepper motor driver for the delay stage (e.g., OZ Optics, ODL-650); (b) Driver for the electro-optic modulator that is derived from the 10 MHz DAQ clock and provides digitally adjustable offset and amplitude (see SRS section). If the DAQ clock is synchronized to the laser repetition rate, the modulation rate can automatically be synchronized to the laser as well; (c) Driver for the tunable filter optimized for a tuning speed up to 10 kHz (FIG. 8). (d) Temperature controller for the oven for the PPLN crystal (e.g., Covesion).

(4) Digital read-out of the GaAsP diode for measuring the cross-correlation signals.

(5) Feedthroughs for the AOs of the DAQ to the galvo mirror driver (e.g., CamTech, MicroMax 67300).

(6) Digital control of the PMT and lock-in amplifier gain; feed-throughs for the signal to the AIs of the DAQ.

### Computer and Control Systems

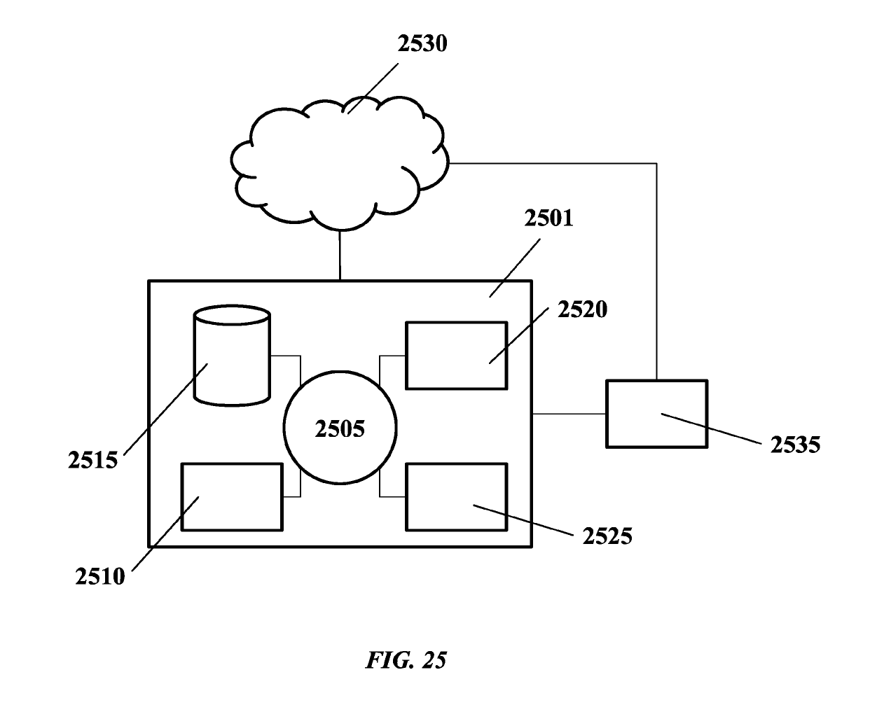

The present disclosure also provides computer control systems (or controllers) that are programmed to implement methods of the disclosure. FIG. 25 shows a computer system 2501 (or controller) that is programmed or otherwise configured to regulate various operational parameters of the systems disclosed herein. Such operational parameters can include control and synchronization of system features such as the laser system, beam scanners, fluid-handling systems, temperature control units, data acquisition systems, and/or data display and analysis processes 2535.

The computer system 2501 includes a central processing unit (CPU, also “processor” and “computer processor” herein) 2505, which can be a single core or multi core processor, or a plurality of processors for parallel processing. The computer system 2501 also includes memory or memory location 2510 (e.g., random-access memory, read-only memory, flash memory), electronic storage unit 2515 (e.g., hard disk), communication interface 2520 (e.g., network adapter) for communicating with one or more other systems, and peripheral devices 2525, such as cache, other memory, data storage and/or electronic display adapters. The memory 2510, storage unit 2515, interface 2520 and peripheral devices 2525 are in communication with the CPU 2505 through a communication bus (solid lines), such as a motherboard. The storage unit 2515 can be a data storage unit (or data repository) for storing data. The computer system 2501 can be operatively coupled to a computer network (“network”) 2530 with the aid of the communication interface 2520. The network 2530 can be the Internet, an internet and/or extranet, or an intranet and/or extranet that is in communication with the Internet. The network 2530 in some cases is a telecommunication and/or data network. The network 2530 can include one or more computer servers, which can enable distributed computing, such as cloud computing. The network 2530, in some cases with the aid of the computer system 2501, can implement a peer-to-peer network, which may enable devices coupled to the computer system 2501 to behave as a client or a server.

The computer system 2501 is coupled to a multi-wavelength fiber laser system configured for use in various multi-photon methods 2535, which can be as described above or elsewhere herein. The computer system 2501 can be coupled to various unit operations of the system 2535, such as the laser system(s), motorized optical mirrors and other components, flow regulators (e.g., valves), temperature sensors and controllers, pressure sensors, electrical switches, and photovoltaic detectors and modules. The system 2501 can be directly coupled to, or be a part of, the system 2535, or be in communication with the system 2535 through the network 2530.

The CPU 2505 can execute a sequence of machine-readable instructions, which can be embodied in a program or software. The instructions may be stored in a memory location, such as the memory 2510. Examples of operations performed by the CPU 2505 can include fetch, decode, execute, and writeback.

With continued reference to FIG. 25, the storage unit 2515 can store files, such as drivers, libraries and saved programs. The storage unit 2515 can store programs generated by users and recorded sessions, as well as output(s) associated with the programs. The storage unit 2515 can store user data (e.g., user preferences and user programs). The computer system 2501 in some cases can include one or more additional data storage units that are external to the computer system 2501, such as located on a remote server that is in communication with the computer system 2501 through an intranet or the Internet.

The computer system 2501 can communicate with one or more remote computer systems through the network 2530. For instance, the computer system 2501 can communicate with a remote computer system of a user (e.g., operator). Examples of remote computer systems include personal computers (e.g., portable PC), slate or tablet PC's (e.g., Apple® iPad, Samsung® Galaxy Tab), telephones, Smart phones (e.g., Apple® iPhone, Android-enabled device, Blackberry®), or personal digital assistants. The user can access the computer system 2501 via the network 2530.

Methods as described herein can be implemented by way of machine (e.g., computer processor) executable code stored on an electronic storage location of the computer system 2501, such as, for example, on the memory 2510 or electronic storage unit 2515. The machine executable or machine readable code can be provided in the form of software. During use, the code can be executed by the processor 2505. In some cases, the code can be retrieved from the storage unit 2515 and stored on the memory 2510 for ready access by the processor 2505. In some situations, the electronic storage unit 2515 can be precluded, and machine-executable instructions are stored on memory 2510. The code can be pre-compiled and configured for use with a machine have a processer adapted to execute the code, or can be compiled during runtime. The code can be supplied in a programming language that can be selected to enable the code to execute in a pre-compiled or as-compiled fashion.

Aspects of the systems and methods provided herein, such as the computer system 2501, can be embodied in programming. Various aspects of the technology may be thought of as “products” or “articles of manufacture” typically in the form of machine (or processor) executable code and/or associated data that is carried on or embodied in a type of machine readable medium. Machine-executable code can be stored on an electronic storage unit, such memory (e.g., read-only memory, random-access memory, flash memory) or a hard disk. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

Various implementations/configurations of the systems and methods herein can be compatible with each other and can be used in a complementary fashion. The systems of the disclosure may be synergistically combined.

It is to be understood that the terminology used herein is used for the purpose of describing specific embodiments, and is not intended to limit the scope of the present invention. It should be noted that as used herein, the singular forms of “a”, “an” and “the” include plural references unless the context clearly dictates otherwise. In addition, unless defined otherwise, all technical and scientific terms used herein have the same meaning as commonly understood by one of ordinary skill in the art to which this invention belongs.

While preferable embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

What is claimed is:

1. A multi-photon excitation system, comprising:
a first fiber system, seeded by a first input train of pulses, generating a first output train of pulses at a first center wavelength λ₁,
a second fiber system, seeded by a second input train of pulses, generating a second output train of pulses at a second center wavelength λ₂, wherein:
(a) the first and the second output trains of pulses are temporally synchronized,
(b) λ₁≠λ₂, and
(c) multi-photon excitation is due to absorption of at least one photon of the first output train of pulses and at least one photon of the second output train of pulses; and
a focusing optic that focuses the first and the second output trains of pulses into a common focal volume.

2. The system of claim 1, wherein the multi-photon excitation system is a two-photon excitation system, and wherein 2/(1/λ₁+1/λ₂) is within a first two-photon excitation wavelength range of a first excitable species.

3. The system of claim 2, wherein at least one of the first fiber system and the second fiber system is a fiber amplifier system, thereby forming at least one of a first fiber amplifier system and a second fiber amplifier system.

4. The system of claim 3, wherein at least one of the first fiber amplifier system and the second fiber amplifier system further comprises a harmonic generation unit.

5.-7. (canceled)

8. The system of claim 4, wherein:
the first fiber amplifier system is an erbium-doped fiber amplifier and the first center wavelength is in a range from 765 nm to 810 nm, and
the second fiber amplifier system is an ytterbium-doped fiber amplifier and the second center wavelength is in a range from 1000 nm to 1080 nm.

9. The system of claim 4, wherein the first two-photon excitation wavelength range includes a two-photon excitation wavelength between 867 nm and 926 nm.

10. The system of claim 4, wherein:
the first fiber amplifier system is an erbium-doped fiber amplifier and the first center wavelength is in a range from 1530 nm to 1620 nm, and
the second fiber system includes a second harmonic unit and the second center wavelength is in a range from 765 nm to 810 nm.

11. The system of claim 3, wherein the first two-photon excitation wavelength range includes a two-photon excitation wavelength between 1020 nm and 1080 nm.

12.-21. (canceled)

22. The system of claim 1, wherein timing jitter of the temporal synchronization is less than 20% of the pulse duration of the longer of the pulses from the first train of pulses and the second train of pulses.

23. The system of claim 22, wherein the pulse duration of the longer of the pulses from the first train of pulses and the second train of pulses is less than 500 fs.

24.-43. (canceled)

44. A multi-photon imaging system comprising:
a pulsed seed laser system;
a beam-scanning system; and
a fiber delivery system for delivering light from the pulsed seed laser system to the beam-scanning system, wherein at least one wavelength of the light from the pulsed seed laser system has a power at an input of the fiber delivery system that is less than a power at an input of the beam-scanning system, and wherein a laser duty factor of the light at the input of the beam-scanning system is larger than 100.

45. The system of claim 44, further comprising at least one fiber amplifier system at an output of the fiber delivery system for amplifying a power of the pulsed seed laser system to provide the power used at the input of the beam-scanning system.

46. The system of claim 44, wherein the fiber delivery system comprises at least one fiber amplifier system.

47. The system of claim 44, further comprising at least one non-linear conversion medium at an output of the fiber delivery system, or as part of the fiber delivery system, for generating a wavelength and the power at the input of the beam-scanning system.

48. The system of claim 45 or 46, further comprising at least one pump source to optically pump the at least one fiber amplifier system.

49. The system of claim 48, wherein light from the at least one pump source is coupled in a core of the same optical fiber of the fiber delivery system as the seed light of the pulsed seed laser system.

50. The system of claim 48, wherein light from the at least one pump source is coupled in an inner cladding of the same optical fiber of the fiber delivery system as the seed light of the pulsed seed laser system, and wherein the at least one fiber amplifier system is a cladding-pumped fiber amplifier system.

51. (canceled)

52. The system of claim 44, wherein the system is configured for imaging using at least one of coherent anti-Stokes Raman scattering (CARS), stimulated Raman scattering (SRS), two-photon excited fluorescence (TPEF), two-color two-photon excited fluorescence (TCTPEF), second harmonic generation (SHG), sum frequency generation (SFG), third harmonic generation (THG), two-color two-photon absorption and transient absorption (TPA).

53.-60. (canceled)

61. The system of claim 44, wherein the power at the input of the fiber delivery system is low enough to generate a nonlinear phase delay Φ_{NL} smaller than 5 over the length of the delivery system.

62. The system of claim 44, wherein at least one wavelength of the light from the seed laser system has a pulse duration between 25 femtoseconds and 250 picoseconds.

63.-70. (canceled)
